(19) United States
(12) Patent Application Publication
(10) Pub. No.: US 2022/0083179 A1
(43) Pub. Date: Mar. 17, 2022

(54) Multi-Lane Graphical User Interface System and Method

(71) Applicant: Pulse-iQ, Inc., Allen, TX (US)

(72) Inventors: Jerry Rassamni, Allen, TX (US); Nathaniel James Rassamni, Dallas, TX (US)

(73) Assignee: Pulse-iQ, Inc., Allen, TX (US)

(21) Appl. No.: 17/399,095

(22) Filed: Aug. 11, 2021

Related U.S. Application Data
(60) Provisional application No. 63/064,732, filed on Aug. 12, 2020.

(51) Int. Cl. G06F 3/0483; G06F 3/0482; G06F 3/0481; G06Q 10/06; G06Q 30/02

(52) U.S. Cl. CPC G06F 3/0483; G06F 3/0482; G06Q 30/0201; G06Q 10/0637; G06F 3/04817

(57) ABSTRACT

A system and method are presented showing an improved computer user interface and a method for constructing that interface.

### BACKGROUND OF THE INVENTION

All organizations who perform marketing activities have a need to monitor the performance of those activities as well as the overall financial performance of the organization. This is the first step in working towards long term operational optimization. Once they accurately understand the current state of their performance then they can begin to plan what to do next in order to improve. If they can accurately monitor these marketing activities that they undertake, then they can understand whether their strategies are working or it they need to pivot and try something new.

This fosters a cycle of continual improvement that cannot be sustained without clear insights into performance. If the data is not accurate or is difficult to comprehend and produce insights from, then this continual improvement cannot be effectively achieved. Therefore, it is imperative for an organization that performs marketing activities to have access to their data in a form that provides quick and easy to comprehend insights with the ability to dive deeper to answer more specific questions. The issue then becomes how to create a solution that organizes, displays, and allows interaction with the data that satisfies these needs of organizations.

Below we have outlined specific problems that we have encountered and our inventions on how to best solve them. Organizations who perform marketing activities need to know how well those activities are performing. This can be difficult when they do not have the resources in order to manipulate their Customer Relationship Management (CRM) data in a database to unveil Key Performance Indicators (KPIs). Even if they do have a database, then they have to know how to manipulate the data with accuracy. Then they would have to know what KPIs to create, this can be difficult for they can easily focus on KPIs that are not important and leave out other very important KPIs.

Let's say they can do everything above, then they must display these KPIs in a manner that is designed around the limitations of computer hardware and software to illuminate what is really happening that is important. Due to the sheer number of metrics they can choose, the story can become muddled with uncertainty. They need a solution where they can quickly understand what is important and then have the ability to dive deeper into the story. Other solutions:
Make the user build their own charts—requiring understanding they may not possess and a lot of time. (The user logs in to our tool and it is already populated with their data in an organization we have spent many hours perfecting, all they have to do is view it)
Are missing important KPIs (We have created many metrics to thoroughly tell the right story of the data, and when we think of something new we can very quickly add a new KPI)
Do not present the data in a way that provides quick understanding of the whole picture with the ability to diagnose problem areas by diving deeper. (We have created frameworks to group data and unique UI to accomplish this)

Our invention has a clear use for all organizations that are performing marketing activities to solicit a purchase, donation, or something of value from an audience. For this explanation we will be using the term Donors for individuals giving money to the organization, however the term donors can be interchanged with many other terms such as, customer, client, or user. Basically, we are tracking a specific entity that is exchanging some sort of currency towards a specific organization and the organization is wishing to track its overall financial performance as well as the performance of its marketing activities.

### BRIEF DESCRIPTION OF THE DRAWINGS

FIG. 1 contains a computerized user interface used by an embodiment of the invention.

FIG. 2 contains a computerized user interface used by an embodiment of the invention.

FIG. 3 contains a computerized user interface used by an embodiment of the invention.

FIG. 4 contains a computerized user interface used by an embodiment of the invention.

FIG. 5 contains a computerized user interface used by an embodiment of the invention.

FIG. 6 contains a computerized user interface used by an embodiment of the invention.

FIG. 7 contains a computerized user interface used by an embodiment of the invention.

FIG. 8 contains a computerized user interface used by an embodiment of the invention.

FIG. 9 contains a computerized user interface used by an embodiment of the invention.

FIG. 10 contains a computerized user interface used by an embodiment of the invention.

FIG. 11 contains a computerized user interface used by an embodiment of the invention.

FIG. 12 contains a computerized user interface used by an embodiment of the invention.

FIG. 13 contains a computerized user interface used by an embodiment of the invention.

FIG. 14 contains a computerized user interface used by an embodiment of the invention.

FIG. 15 contains a computerized user interface used by an embodiment of the invention.

FIG. 16 contains a computerized user interface used by an embodiment of the invention.

FIG. 17 contains a computerized user interface used by an embodiment of the invention.

FIG. 18 contains a computerized user interface used by an embodiment of the invention.

FIG. 19 contains a computerized user interface used by an embodiment of the invention.

FIG. 20 contains a computerized user interface used by an embodiment of the invention.

FIG. 21 contains a computerized user interface used by an embodiment of the invention.

FIG. 22 contains a computerized user interface used by an embodiment of the invention.

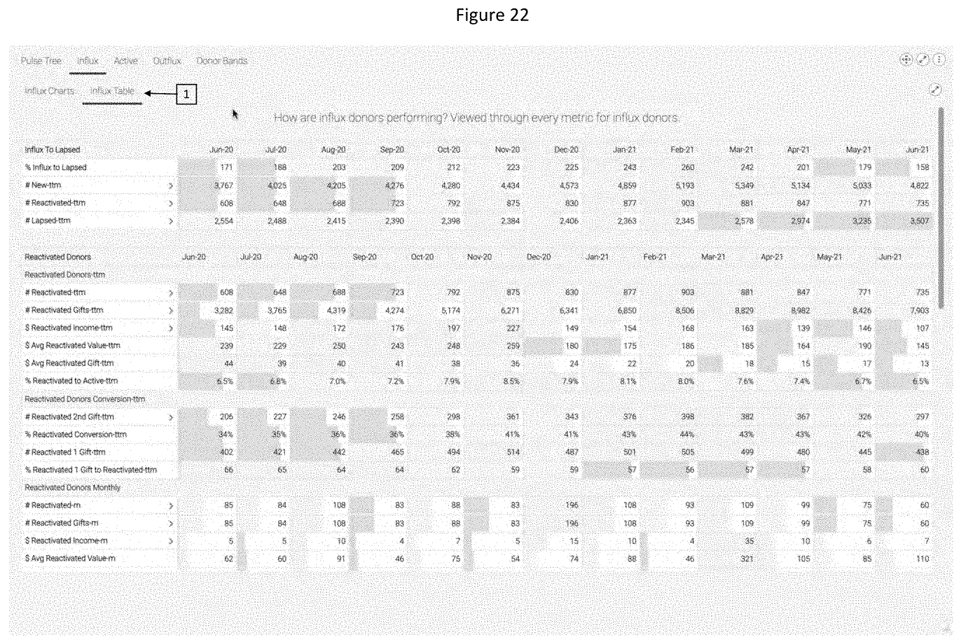

FIG. 23 contains a computerized user interface used by an embodiment of the invention.

FIG. 24 contains a computerized user interface used by an embodiment of the invention.

FIG. 25 contains a computerized user interface used by an embodiment of the invention.

FIG. 26 contains a computerized user interface used by an embodiment of the invention.

FIG. 27 contains a computerized user interface used by an embodiment of the invention.

FIG. 28 contains a computerized user interface used by an embodiment of the invention.

FIG. 29 contains a computerized user interface used by an embodiment of the invention.

FIG. 30 contains a computerized user interface used by an embodiment of the invention.

FIG. 31 contains a computerized user interface used by an embodiment of the invention.

FIG. 32 contains a computerized user interface used by an embodiment of the invention.

FIG. 33 contains a computerized user interface used by an embodiment of the invention.

FIG. 34 contains a computerized user interface used by an embodiment of the invention.

FIG. 35 contains a computerized user interface used by an embodiment of the invention.

FIG. 36 contains a computerized user interface used by an embodiment of the invention.

FIG. 37 contains a computerized user interface used by an embodiment of the invention.

FIG. 38 contains a computerized user interface used by an embodiment of the invention.

FIG. 39 contains a computerized user interface used by an embodiment of the invention.

FIG. 40 contains a computerized user interface used by an embodiment of the invention.

FIG. 41 contains a computerized user interface used by an embodiment of the invention.

FIG. 42 contains a computerized user interface used by an embodiment of the invention.

FIG. 43 contains a computerized user interface used by an embodiment of the invention.

FIG. 44 contains a computerized user interface used by an embodiment of the invention.

FIG. 45 contains a computerized user interface used by an embodiment of the invention.

FIG. 46 contains a computerized user interface used by an embodiment of the invention.

FIG. 47 contains a computerized user interface used by an embodiment of the invention.

FIG. 48 contains a computerized user interface used by an embodiment of the invention.

FIG. 49 contains a computerized user interface used by an embodiment of the invention.

FIG. 50 contains a computerized user interface used by an embodiment of the invention.

FIG. 51 contains a computerized user interface used by an embodiment of the invention.

FIG. 52 contains a computerized user interface used by an embodiment of the invention.

FIG. 53 contains a computerized user interface used by an embodiment of the invention.

FIG. 54 contains a computerized user interface used by an embodiment of the invention.

FIG. 55 contains a computerized user interface used by an embodiment of the invention.

FIG. 56 contains a computerized user interface used by an embodiment of the invention.

FIG. 57 contains a computerized user interface used by an embodiment of the invention.

FIG. 58 contains a computerized user interface used by an embodiment of the invention.

FIG. 59 contains a computerized user interface used by an embodiment of the invention.

FIG. 60 contains a computerized user interface used by an embodiment of the invention.

FIG. 61 contains a computerized user interface used by an embodiment of the invention.

FIG. 62 contains a computerized user interface used by an embodiment of the invention.

FIG. 63 contains a computerized user interface used by an embodiment of the invention.

FIG. 64 contains a computerized user interface used by an embodiment of the invention.

FIG. 65 contains a computerized user interface used by an embodiment of the invention.

FIG. 66 contains a computerized user interface used by an embodiment of the invention.

FIG. 67 contains a computerized user interface used by an embodiment of the invention.

FIG. 68 contains a computerized user interface used by an embodiment of the invention.

FIG. 69 contains a computerized user interface used by an embodiment of the invention.

FIG. 70 contains a computerized user interface used by an embodiment of the invention.

FIG. 71 contains a computerized user interface used by an embodiment of the invention.

FIG. 72 contains a computerized user interface used by an embodiment of the invention.

FIG. 73 contains a computerized user interface used by an embodiment of the invention.

FIG. 74 contains a computerized user interface used by an embodiment of the invention.

FIG. 75 contains a computerized user interface used by an embodiment of the invention.

### DETAILED DESCRIPTION

### Pulse Analytics

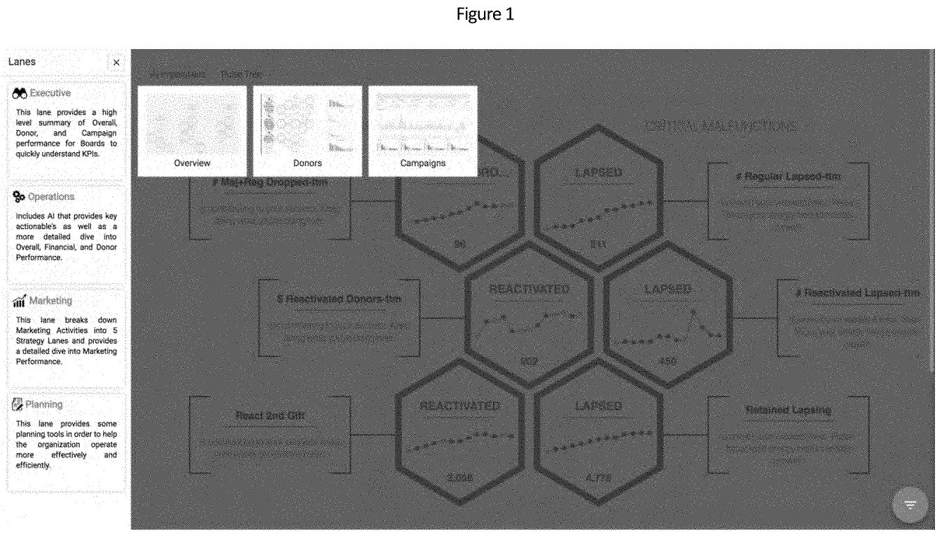

We remove all work from the customers side and provide an online dashboard where they can login and immediately understand what is important, and then have the ability to dive deeper to see the full picture. We have spent thousands of hours working with the data to design unique methods of framing the organizations performance around the limitations of the computer device screen. See FIG. 1.

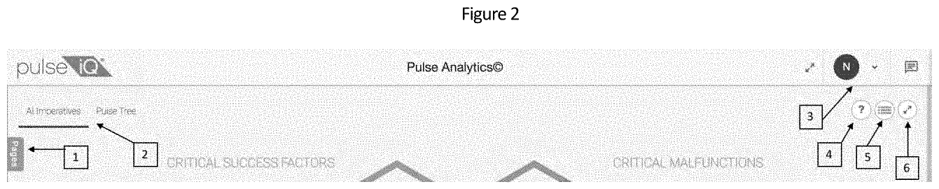

We have divided the Dashboard into three lanes. Each lane has three pages and within each page can be multiple tabs. The Executive Lane provides a high-level summary of Overall, Donor, and Campaign performance for Boards to quickly understand KPIs. The Operations Lane showcases our AI that tells organizations which KPIs are improving and which KPIs are worsening the financial performance the most. This lane also provides a more detailed analysis into overall, financial, and donor performance. The marketing lane showcases our Strategy Lanes which breaks down marketing into five segments which can be easily understood and tracked for performance. This lane also provides a detailed dive into marketing performance through channels and campaigns. We have a fourth lane that houses different business tools to help organizations operate more effectively and efficiently. See FIG. 2. In FIG. 2,
1) This button opens the menu shown on FIG. 1 where the user can select which page to view.
2) These are the titles of the tabs available for display on this page. The tab that is currently being viewed is underlined. When a title is selected the page will update with the content from that tab.
3) This is the main dashboard menu. When clicked this provides menu items such as user profile and links to other dashboards.
4) This is the icon that brings up the help section. This is on every tab and provides information about the tab such as: Why the data being displayed is important, how to view and interact with the data, and the definitions of metrics used.
5) This is the icon that brings up an actionable list of donors that are reported on that tab. This is extremely useful because unless the organization acts on the insights provided by the tool, then their performance will not improve. These actionable lists allow the user to find a trouble area and quickly receive a list of the specific donors to target in order to improve those metrics.
6) This is the full screen icon. When it is clicked the page view goes to full screen and it can be clicked to return the view to how it was before.

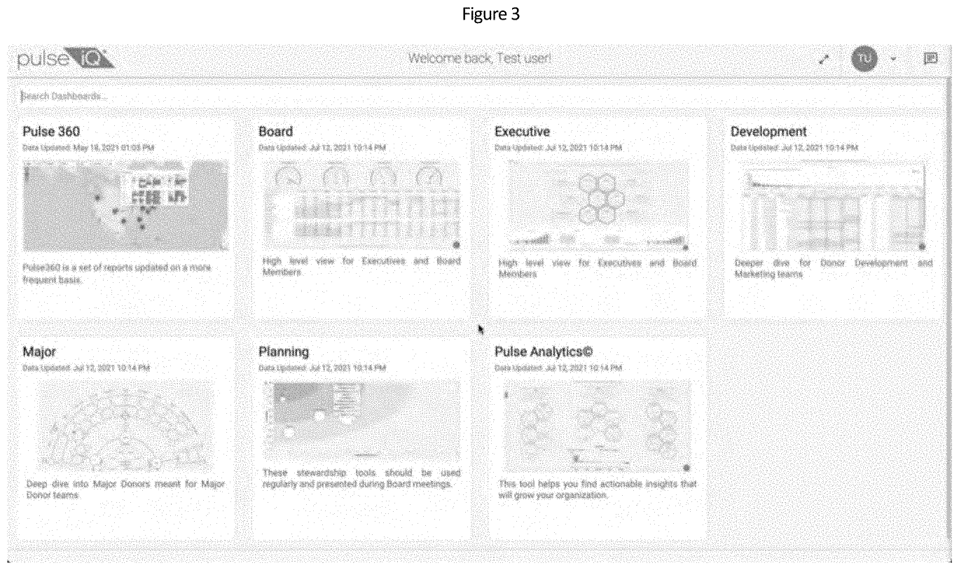

FIG. 3 shows an alternate way to organize the dashboards. Instead of having one dashboard for all audiences, we have created multiple dashboards that better suit the needs of the varying audiences within the organization. Now each role can view a dashboard that only houses relevant content for them and in an order to help them understand powerful pertinent insights quickly without being overwhelmed with a deluge of data.

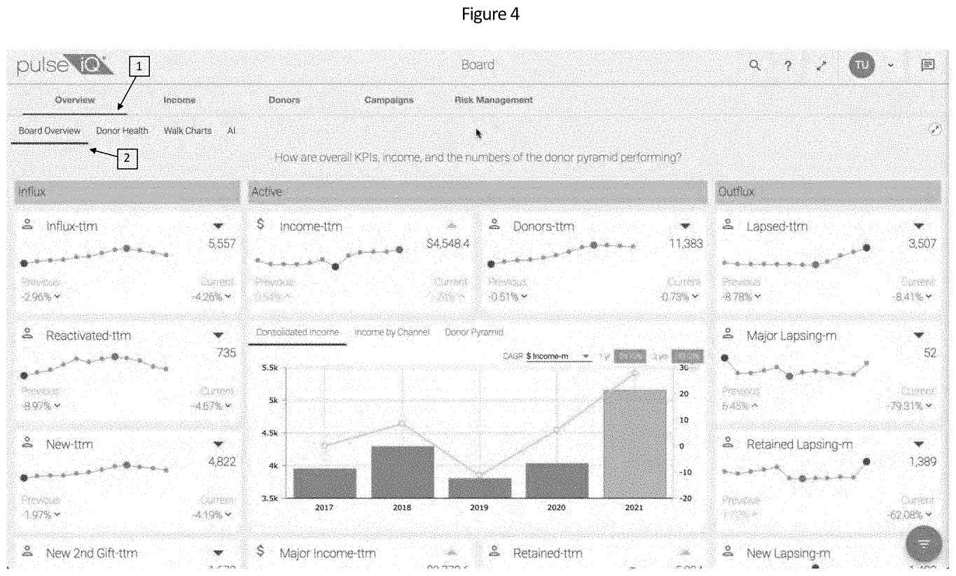

When the user logs in they are shown the screens shown in FIGS. 4, 5, and 6 that enables them to choose which dashboard they would like to view by selecting it. In FIG. 4:
1) This is the first page of the Board Report. It is currently selected, and this is shown by the underline. The user can select the other page titles on this row and the view will update to show the selection as well as an underline under the selected page title. The tabs below this row will then update to display which tabs are available for the page selected.
2) This is the first tab on the Board Report. It is currently selected, and this is shown by the underline. The user can select the other tabs on this row and the view will update to show the selection as well as an underline under the selected tab title.

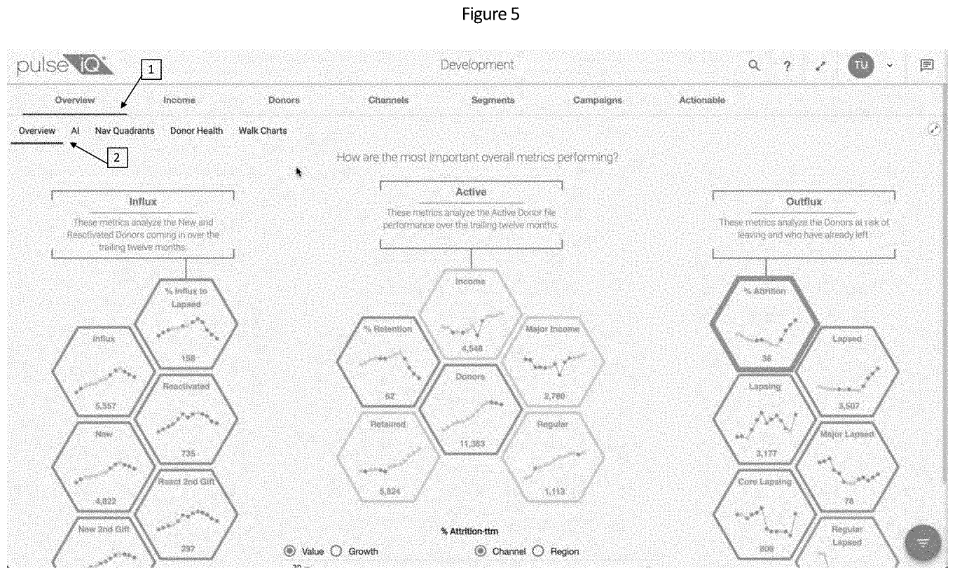

### In FIG. 5:

1) This is the first page of the Development Report. It is currently selected, and this is shown by the underline. The user can select the other page titles on this row and the view will update to show the selection as well as an underline under the selected page title. The tabs below this row will then update to display which tabs are available for the page selected.
2) This is the first tab on the Development Report. It is currently selected, and this is shown by the underline. The user can select the other tabs on this row and the view will update to show the selection as well as an underline under the selected tab title.

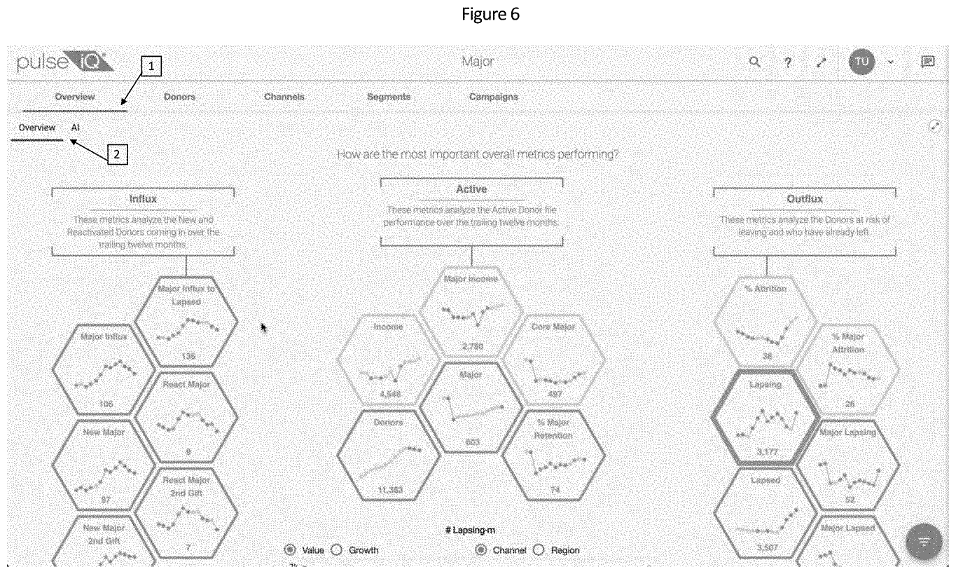

### In FIG. 6:

1) This is the first page of the Major Report. It is currently selected, and this is shown by the underline. The user can select the other page titles on this row and the view will update to show the selection as well as an underline under the selected page title. The tabs below this row will then update to display which tabs are available for the page selected.
2) This is the first tab on the Major Report. It is currently selected, and this is shown by the underline. The user can select the other tabs on this row and the view will update to show the selection as well as an underline under the selected tab title.

### Influx Active Outflux—Donor Health Framework and UI Improvements

The problem is that there are a large number of donor health metrics that are important, and to effectively keep track of all of them can be difficult. If they are all placed on the computer device without some sort of organization the user can become quickly overwhelmed, not know where to focus their attention, and not be able to retain most of the information.

Our solution to this problem was to create new user interfaces that utilize a framework which enables the vast amount of donor health data to be displayed on the computer device in a way that the user can quickly and easily gain insights. At the core of this new UI is a unique data organization framework. We utilize this framework in varying degrees of detail throughout multiple pages with unique user interfaces. Each page has a specific goal that the level of detail used from the framework and the specific UI work together to achieve.

We have concluded that there are three categories of metrics an organization needs to properly manage in order to create and sustain growth and ensure future viability. If they always keep track of their performance in these three categories and adjust their strategy accordingly then they can become more effective and efficient in focusing on what truly matters, and in doing so they will optimize their growth and performance. This UI helps the user focus their attention on three distinct categories: Influx, Active, and Outflux.

Influx includes metrics that report on Donors who are starting to give to the organization. This includes New Donors (The number of Donors who have given their first gift in the past twelve months) and Reactivated Donors (The number of Donors who gave again after having Lapsed from giving for at least a 12 month period) From there we have many metrics for each of those donor types to report on their performance, such as amount of income, number of donors, avg gift size, and avg donor size.

Active contains the metrics that report on all Donors who are currently a part of the organization. For this framework we have defined a donor that has given at least one gift in the trailing twelve months as a current donor. This category starts with Active Donors (has given at least one gift in the trailing twelve months) at the highest level. From there we break down into many segments to give further insight such as: Donor Pyramid which includes:
Major—Have given above a certain amount within a certain time frame.
Regular—Have given more than a certain number of times within a certain time frame.
Multi—Have given more than one time but less than would make them a regular donor within a certain time frame.
Single—Have only given once within a certain time frame.
   Also, two very important groups:
Retained—Have given in two subsequent time periods. For example, they gave last year and again this year. These time periods can be anything.
Core—Have given in three subsequent time periods. For example, they gave two years ago, last year, and again this year. These time periods can be anything.
   We have performance metrics on all of these segments included in the Active category.

Outflux contains the metrics that report on Donors who are at risk of stopping their giving or have already stopped. This includes:
Lapsing Donors—Donors whose last gift was on a date that is nearing the time which we would consider a Lapsed Donor.
Lapsed Donors—Donors who gave their last gift beyond the point in time which we would consider an Active Donor.
   From there we break down into all of our previous segments in order to see how each are individually doing in regard to Lapsing and Lapsed. So, we have a category for Major Lapsing, Major Lapsed, Regular Lapsing, and so on.

To be noted: This framework is categorizing the metrics and not the individual donors. For example, metrics associated with New Donors are in the Influx category, but the specific Donors being reported on by New Donor metrics (because they have just given their first gift) are also considered Active Donors (because they have given at least once in the trailing twelve months). Metrics associated with Active Donors are in the Active Category. Furthermore, if the time a New Donor gave their last gift puts them in the Lapsing Donor segment, then they are at the same time considered a New Donor, Active Donor, and Lapsing Donor. This means there would be metrics associated with that donor in all three categories: Influx, Active, and Outflux. This framework is not tracking specific Donor progression through a life cycle, instead it is tracking the performance of metrics that are associated with three types of donors: Metrics associated with the performance of people coming in, people who are here, and people who are leaving or have left. Once the data is divided into these categories on the computer device through the UI, then organizations can quickly understand where they are doing well and where they need to improve. When the metrics are grouped together through the UI it forces the user to hyper-focus on what matters.

### Influx Active Outflux Framework—Executive Overview

At the highest level of the Influx Active Outflux framework is the Executive Overview. The goal of this page is to utilize the framework through a sleek and simple UI that results in showing the busy executive only the most important metrics. The busy executive is able to very quickly glance at the page and have a deep understanding of the overall performance of the organization. This is accomplished by separating the data into Influx Active and Outflux and only showing the most important overall metrics for each category.

Each metric is shown through the title, a sparkline of the metrics value for the last thirteen months, and the numerical value of the latest period. The user can hover over the sparkline to see the values of the past periods. The metrics are calculated on a trailing twelve-month basis which is the cumulative value of that metric for the last twelve months. This ensures that the peaks and valleys of busier times of the year do not distract from the true performance narrative. This way the organization is always comparing one full year cycle to another full year cycle, instead of comparing a December to a January.

The color of the hexagon is either red, yellow, or green. This is based on the performance of the metric. If the metric is trending downwards it is red, if it is only slightly down, remaining constant, or slightly up it is yellow, and if it is trending upwards it is green. The ability to see how many shapes are red, yellow, and green provides the user with a very quick understanding of performance and allows them the ability to only hone in on problem areas instead of the user having to digest the numerical values of every metric on the screen before they can choose where to focus on. The conditional formatting colors improve this page because without them it would be harder to quickly gain an understanding of the data.

There is a question mark at the top of the page that when clicked on shows helpful information about the page. On this page it shows information on how the page works and the definitions of all of the metrics used. There is also a filter icon on the page, this allows the user to filter the data shown on the entire dashboard through a number of predefined options.

If the organization has multiple channels or regions that they perform marketing activities through, then they can choose which to view the page data for. They can select as many or as few as they would like, for instance they can view for all the channels from only one region, three of the channels for two of the regions and so on. Regions and channels are examples here, as these options can be almost anything we have the data on.

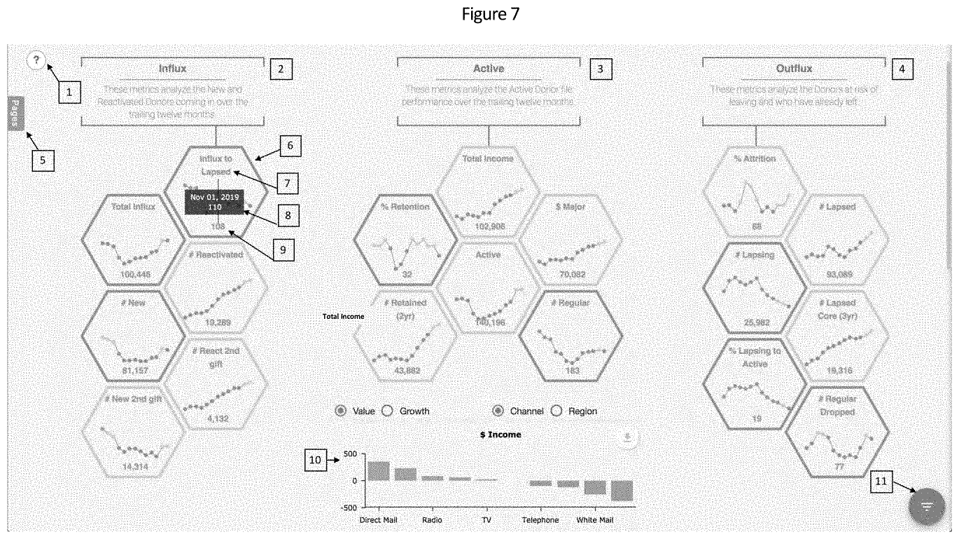

See FIG. 7. In this Figure:
1) When clicked, this button opens a window with instructions on how to use the page, why the data being shown is important, and the definitions of the metrics used.
2) This section of the page is devoted to Influx metrics. These metrics analyze the performance of the donors coming in to the organization, in other words both New and Reactivated Donors.
3) This section of the page is devoted to Active metrics. These metrics analyze the performance of the Active Donor file over the last 12 months.
4) This section of the page is devoted to Outflux metrics. These metrics analyze the performance of the Donors at risk of leaving or have already left.
5) This button opens the menu shown on FIG. 1 where the user can select which page to view.
6) The border color of the hexagon is conditional formatted based on the performance of the metric inside. It will range from red: negative growth, yellow: relatively little positive or negative growth, green: positive growth.
7) This is the title of the metric shown in this hexagon.
8) There is a spark line showing the last thirteen values for the metrics on a trailing twelve-month value. This means that the Nov. 1, 2019 period is the cumulative value of that metric from Dec. 1, 2018-Nov. 1, 2019. The period name and value appear based on which specific period is being hovered over by a cursor from the computer device.
9) The value of the latest period is shown here.
10) When the user clicks on a hexagon, this chart will show the data for the associated metric. The user is able to select whether the chart should show the metric value or growth rate. Furthermore, user is able to select whether to show the data by channel or by region.
11) When the user clicks on this button a window appears with options to filter all the data shown in the dashboard.

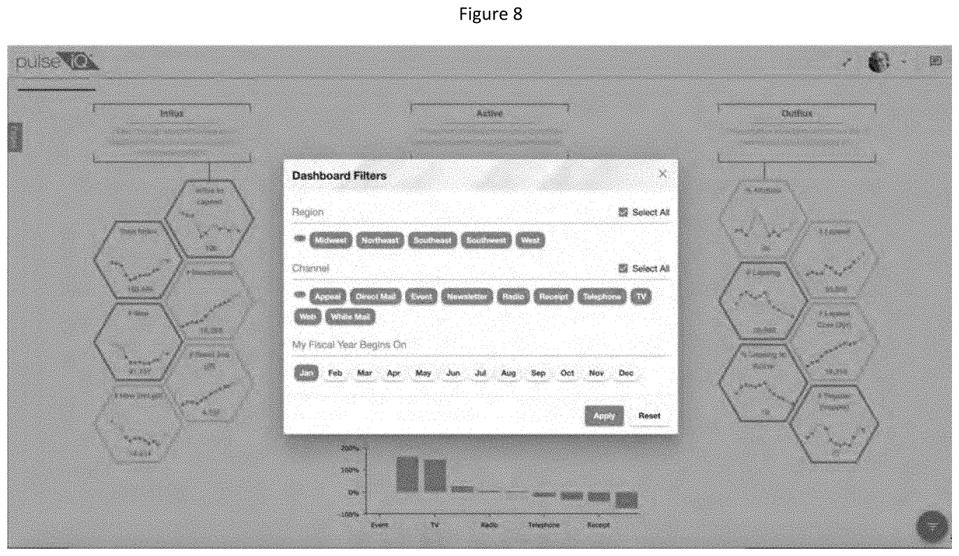

In FIG. 8, when the filter button (orange circle located to the bottom right of the screen) is clicked, this window pops up. Here the user has the ability to filter what the entire dashboard is reporting on. The filters can be customized depending on the organizations preference for any category we have data on. Here the filtering options are for specific regions and channels. The user can click as many or as few of these options at a time. There is also an option to specify when the organizations fiscal year begins on for reporting sake.

### Influx Active Outflux Framework—Executive Drill

The Executive Drill is the next embodiment of utilizing the Influx Active Outflux framework in a unique User Interface. This page is for the user that wants to dive deeper into the data shown on the Executive Overview. Where the Executive Overview is meant for busy Executives to understand overall performance very quickly and without superfluous distractions, the Executive Drill is when the Executive has more time and more detailed questions that they would like to answer.

The metrics are organized at the top of the screen in their respective Influx, Active, and Outflux categories. The metrics are shown with their name and a thirteen-month sparkline with their respective trailing twelve-month values (ttm). Each bullet is either red, yellow, or green based on conditional formatting on the performance of the metric. The user can hover over the bullets on the sparkline to view the value and name of each period shown.

In the data tile above the metrics there are the numbers −2, −1, M, and +1. Next to the numbers there is either a red arrow pointing down, a yellow horizontal line, or a green arrow pointing up. These represent the cumulative values of each metric in that data tile and whether they are trending up, relatively the same, or down from those time periods. The −2 represents their value 2 months ago, the −1 represents their value 1 month ago, the M represents their value this month, and the +1 is a projection on their value next month.

Below the data tiles with the lists of metrics are charts that enable the user to drill down into the metrics and find specific answers about performance. The user can choose any of the Hexagons on the page and the drill will update with that data. Then the user can click a specific bar in the first graph, and the rest of the drill will update accordingly for that data. These drill charts are meant to uncover more of the story for a metric. They segment the chosen metric into the different channels and regions associated with the organization, so if a metric is performing poorly the user can diagnose which channel or region is causing the decline. Furthermore, they can diagnose when that decline started for that specific channel or region.

Without the ability to interact with the data through this drilling feature, we could not place this same amount of data on the screen in a manner that the user can quickly and easily understand. We had to create this drilling feature in order to improve the capability of what the computer device can show at one time and make it so much easier for the user to find answers to a vast amount of questions.

The first chart from the left has a toggle feature, the options dictate how the drill works. Here is an example option: KPI>Channel>Month. This means that the first chart shows the historical performance over different periods for the KPI that has been selected from the data tiles at the top of the screen. The user can then click any one of the bars on that KPI chart and the next chart which is the Channel chart shows that KPI from that specific period chosen broken down between all the Channels. Then the user can click any one of the bars from the Channel chart and the next chart which is the Month chart will show how the chosen KPI has performed from that specific channel over time.

There are different toggle options, so the charts can either drill from the KPI to a category and then to another category and then to the historical performance over different periods for that chosen slice of data, or the drill can go from the KPI to one category and then show the historical performance over different periods for that chosen slice of data. Basically, it can drill the KPI into one or two categories and theoretically as many as we would like. Breaking down the KPI into the different channels is only an example and it can be anything we have data on.

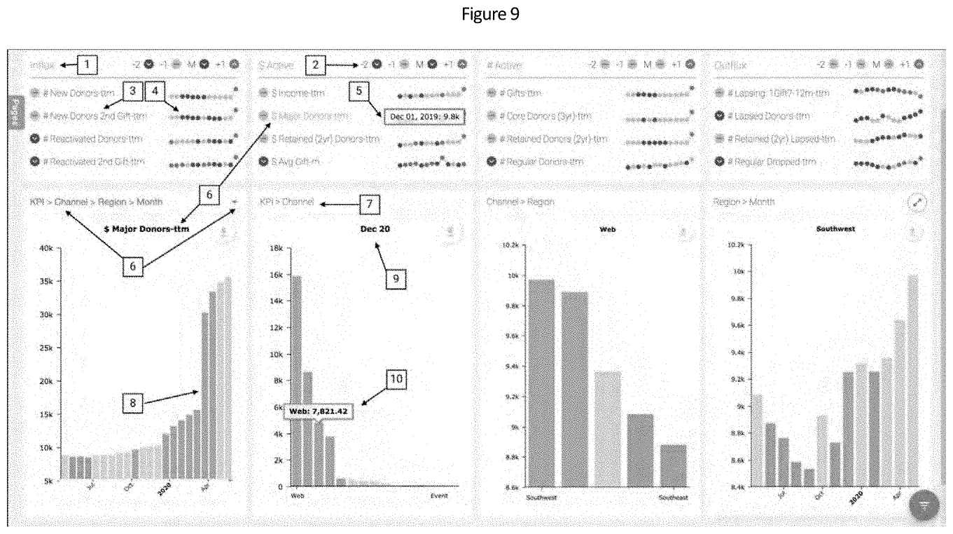

This drill is featured on different views throughout the dashboard. The drill will show data for whichever KPI is selected on each of these views. This is seen in FIG. 9. In this figure, the top data tiles contain metrics separated into Influx, Active, and Outflux categories. The user can quickly understand how metrics are trending in each category due to the conditional formatting on the spark lines associated with each metric.

The bottom shows drill down charts. There is a toggle option on the first chart where the user can select the order to drill the selected KPI's. The options present in this example are (KPI>Channel>Region>Month), (KPI>Channel>Month), (KPI>Region>Channel>Month), (KPI>Region>Month). These options can be virtually anything there is data on. These options enable the user to further segment KPI's in different categories. For instance, if (KPI>Channel>Month) is selected, then the user can see how that specific KPI has performed over time, then if there was a downward trend that started in a specific period the user can select that period and it will separate into all of the channels associated with that KPI on the second chart. The user will then see which channels had negative growth in that period based on the conditional formatting of the bars (red, yellow, green). Then the user can select a red (problem) channel which contributed to the overall negative growth of the KPI and it will be shown in the next chart (Month). This chart will show the historical performance of the specific KPI chosen in the specific channel chosen over a period of a few years. Ultimately the user can spot a positive or negative change in KPI performance and then drill down to isolate which channel or region caused the change, and then see when the change started and occurred from that channel or region. When they have the specific time frame of specific changes, then the user can begin to consider factors that also occurred during the same time frame, so they can isolate what caused the change in performance. This enables the user to have data driven decision making in order to constantly optimize their performance in a way that is not possible without this UI.

The elements in FIG. 9 are:
1) This title shows whether the metrics in the tile are concerning Influx, Active, or Outflux.
2) These four icons report on the cumulative performance of all the metrics in that tile during specific periods of time. The periods are −2: two periods ago, −1: last period, M: this period, +1: projection for next period. Each period is conditional formatted for performance. It will range from red: negative growth, yellow: relatively little positive or negative growth, green: positive growth.
3) This is the title of the metric that is being reported on in the sparkline to the right.
4) These sparklines contain the previous 13 periods of that metric.
5) When the cursor hovers over a bullet then the name of that period and value will appear.
6) The user can click on any of the metrics and then it becomes highlighted and appears in the drill down chart below. These style drill down charts appear in numerous pages throughout the dashboard. These are designed in a way to provide the user a way to quickly answer a large number of very important questions relating to specific metric performance. These drill down charts enable the user to find specific answers to their questions in a way not possible without this UI. The user is able to select which KPI will be drilled down by clicking the KPI title in any tile above. Then that KPI's historical performance over a few years period is shown in the first chart. The user can then select any of the periods in the first chart and that period will be segmented into the different components of the category that is listed on the title of the chart.
7) This is the breakdown of how the data is drilled in this chart. For instance, first the user selected a KPI (with the name being shown on the first chart), then one time period was selected on the first chart and the second chart shows all Channels associated with that KPI from that time period.
8) The user can click on any bar on the first three charts and that will filter the next chart based on the data from that specific bar. For instance, this first chart contains time periods on the x axis so when the user selects a specific bar then the next chart which contains channels on the x-axis contains that specific time period segmented by all the channels.
9) This is the name of the bar that was selected in the previous chart which describes the data being shown.
10) When the user hovers over the bars the name of the data and the value is shown.

### Influx Active Outflux Framework—Donor DNA

This view is for the Executive to quickly understand how the number of Donors is fluctuating and gives answers to several important questions for each group. We use the Influx Active Outflux Framework here to visually display which Donor Segments are included in each category. This gives a comprehensive view of the Donor File while being grouped into distinct categories to help understanding. The Executive Overview included metrics such as Influx to Lapsed and Net Income that speak to performance but are not in themselves a Donor type. We have limited the hexagons on Donor DNA to only include Donor Types to give a picture of the Donor File in our framework.

There is a DNA Strand on the left side of the screen that is divided into the three groups: Influx, Active, and Outflux. There is a strand of hexagons that contain the important Donor types attached to each of the groups. If the user clicks on either the Influx, Active, or Outflux group on the DNA strand then the page will update with four charts that answer important questions about performance that pertain to that group.

There is a drill on the right side of the screen that enables the user to drill down into the metrics and find specific answers about performance. The user can choose any of the hexagons on the page and the drill will update with that data. Then the user can click a specific bar in the first graph, and the rest of the drill will update accordingly for that data. These drill charts are meant to uncover more of the story for a metric. They segment the chosen metric into the different channels and regions associated with the organization, so if a metric is performing poorly the user can diagnose which channel or region is causing the decline. Furthermore, they can diagnose when that decline started for that specific channel or region.

Without the ability to interact with the data through this drilling feature, we could not place this same amount of data on the screen in a manner that the user can quickly and easily understand. We had to create this drilling feature in order to improve the capability of what the computer device can show at one time and make it so much easier for the user to find answers to a vast amount of questions.

The top chart has a toggle feature, the options dictate how the drill works. Here is an example option: KPI>Channel>Month. This means that the first chart shows the historical performance over different periods for the KPI that has been selected from the data tiles at the top of the screen. Next the user can click any one of the bars on that KPI chart and the next chart which is the Channel chart shows that KPI from that specific period chosen broken down between all the Channels. Then the user can click any one of the bars from the Channel chart and the next chart which is the Month chart will show how the KPI chosen has performed from that specific channel over time.

There are different toggle options, so the charts can either drill from the KPI to a category and then to another category and then to the historical performance over different periods for that chosen slice of data, or the drill can go from the KPI to one category and then show the historical performance over different periods for that chosen slice of data. Basically, it can drill the KPI into one or two categories and theoretically as many as we would like. Breaking down the KPI into the different channels is only an example and it can be anything we have data on.

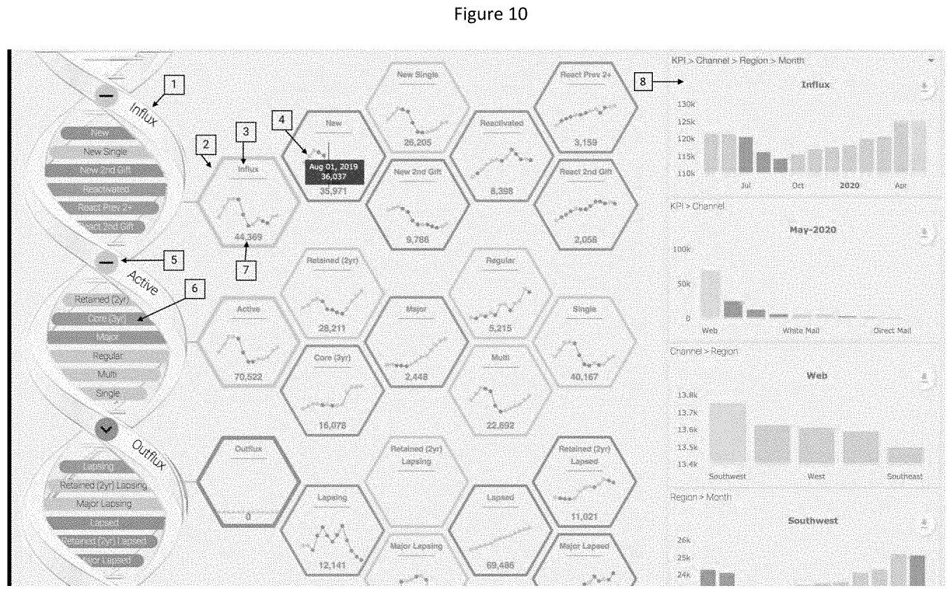

This drill is featured on different views throughout the dashboard. The drill will show data for whichever KPI is selected on each of these views. In FIG. 10:
1) This is the title of the category of metrics shown in this part of the strand. There are sections for Influx, Active, and Outflux.
2) The border color of the hexagon is conditional formatted based on the performance of the metric inside. It will range from red: negative growth, yellow: relatively little positive or negative growth, green: positive growth.
3) This is the title of the metric shown in this hexagon.
4) There is a spark line showing the last thirteen values for the metrics on a trailing twelve-month value. This means that the Nov. 1, 2019 period is the cumulative value of that metric from Dec. 1, 2018-Nov. 1, 2019. The period name and value appear based on which specific period is being hovered over by a cursor from the computer device.
5) This icon represents the cumulative performance of all the metrics in that section below. They are conditional formatted for performance. It will range from red: negative growth, yellow: relatively little positive or negative growth, green: positive growth.
6) The color of the rung is conditional formatted for performance. It will range from red: negative growth, yellow: relatively little positive or negative growth, green: positive growth.
7) The value of the latest period is shown here. The color of the text is conditional formatted based on the performance of the metric inside. It will range from red: negative growth, yellow: relatively little positive or negative growth, green: positive growth.
8) The user can click on any of the hexagons and the metric inside will appear in the drill down chart on the right. These style drill down charts appear in numerous pages throughout the dashboard. These are designed in a way to provide the user a way to quickly answer a large number of very important questions relating to specific metric performance. These drill down charts enable the user to find specific answers to their questions in a way not possible without this UI. The user is able to select which KPI will be drilled down by clicking the KPI title on any hexagon. Then that KPI's historical performance over a few years period is shown in the first chart. The user can then select any of the periods in the first chart and that period will be segmented into the different categories on the second chart. Then the user can select any of the bars from the second chart and that data is further segmented into the categories on the third chart.

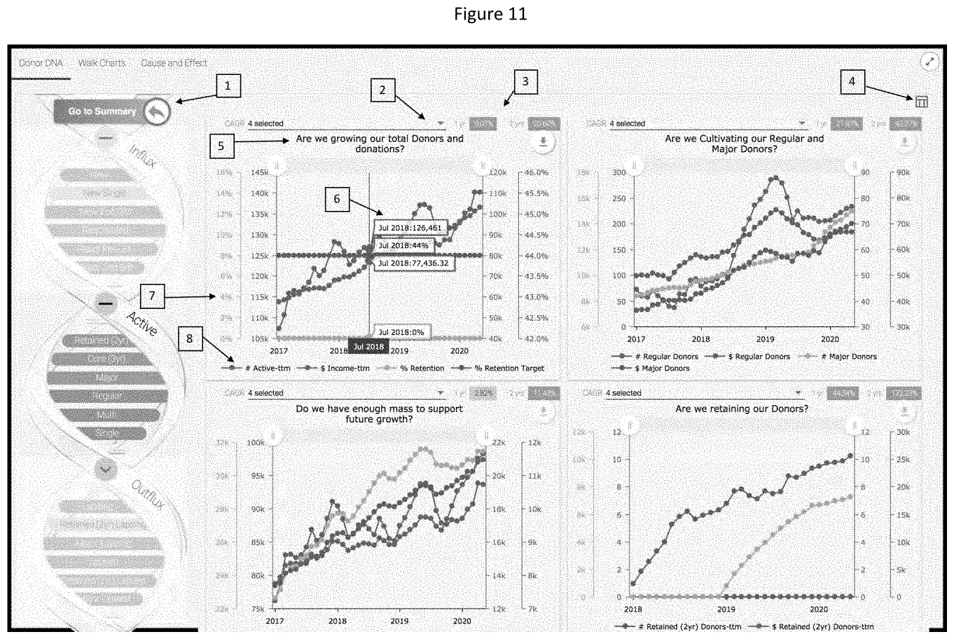

The page in FIG. 10 updates to these four charts shown in FIG. 11 when any of the groups are clicked on in the DNA strand. The charts shown have to do with which group was selected. The selected group is shown in full color, while the other two groups are shown faded. If a different group is selected, then that group will be shown in full color and the charts will update with metrics associated with that group. In FIG. 11:
1) The user can click on this button to return to the view with strands of hexagons.
2) This is a dropdown menu to select which of the KPI's from the chart to view the compounded annual growth rate (CAGR) for, by default all KPI's from the chart are selected.
3) This is showing the CAGR for whichever KPIs are selected from the toggle to the left. It shows values for the last one-year and two-year periods with a conditional formatting color that ranges from red: negative growth, yellow: relatively little positive or negative growth, green: positive growth.
4) This table icon brings up smart tables with all the metrics currently on the page.
5) This is the important question that the metrics in each chart are answering.
6) When the cursor is hovered over bullets the time period and value will appear.
7) These are separate y-axis for each of the metrics being represented based on the key at the bottom of the chart (#8)
8) Each metric has its own color line on the graph, and that color is represented to the left of the metric name, and also with its own y-axis. The user can select any metric on the bottom of the screen to remove it from the chart, it will then become greyed out on the bottom, and its corresponding y-axis will also disappear. The user can click on the metric name if they would like to see it appear on the chart again.

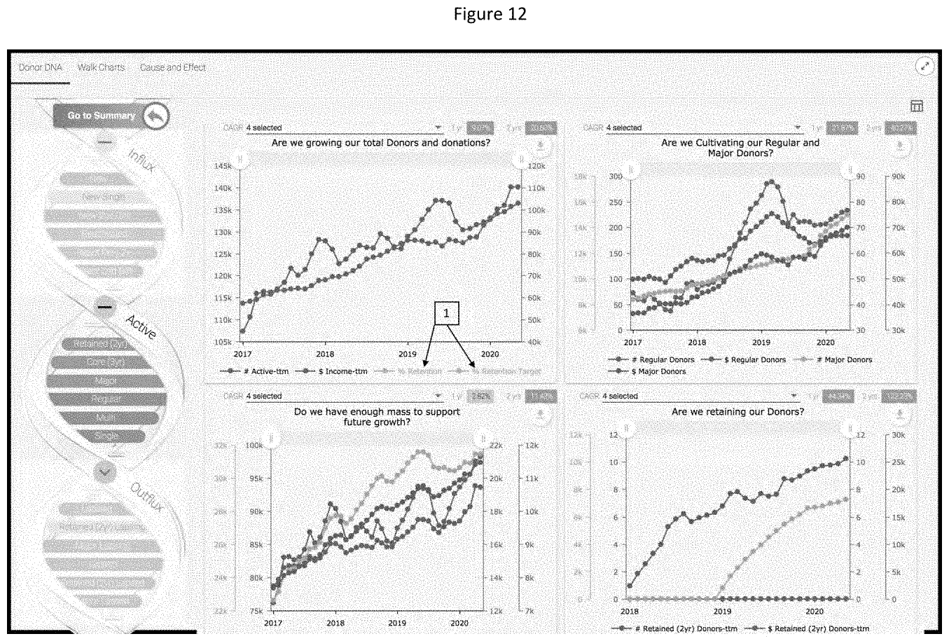

In FIG. 12, at 1), these two metrics have been clicked Notice how they are greyed out, their lines have disappeared from the graph, and their respective y-axis have also been removed.

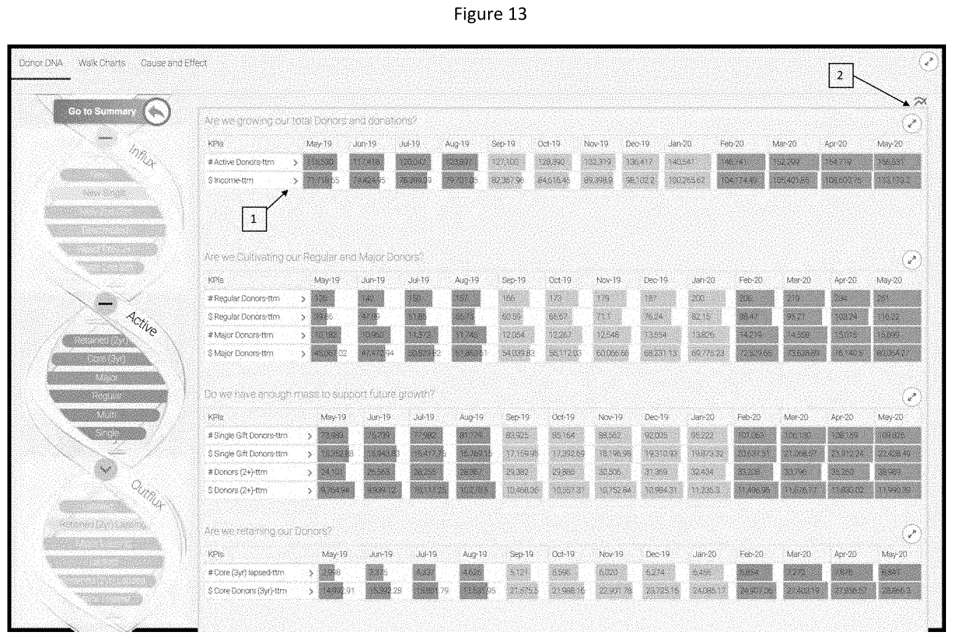

The view in FIG. 13 is when the user has clicked #4 from FIG. 11. There is a corresponding table with the question asked and metrics presented for each of the four charts that were presented on FIG. 11. In this FIG. 13:
1) This is a drill capability in the smart table. If the user clicks this arrow, then the table extends down, and the metric is further segmented in a category. In this example it segments the metric into all the different channels associated with that metric. Furthermore, each channel has an arrow that the user can click to segment it into the different regions.
2) If the user would like to go back to the view on FIG. 11, they can click this button.

### Influx Active Outflux Framework—Pulse Tree

Because traditional dashboard UI can only effectively show performance for a handful of metrics, executives are forced to go to multiple dashboards in order to view and understand their overall performance. This can be very time consuming and lead to confusion on what the full story is. This leads to a need for organizations to have a dashboard view on one page that summarizes the performance of many different metrics.

Faster and greater understanding of performance—Traditional dashboards are only able to show a handful of metrics effectively due to the space limitations of the computer device screen. The invention however shows the landscape of meaningful metrics in a single view without the need to browse multiple dashboards. This type of view can be used for many more metrics than are shown in FIG. 7, depending on the organization's needs. As the number of metrics increase so does the value of this unique way of displaying the data. This enables busy executives and operational staff to quickly and effectively grasp operational performance in order to make smarter data-driven decisions.

Multidimensional view of Performance—By presenting the storyboard in a multidimensional view of performance the invention helps to provide greater insights into the whys of performance. Pulse Tree strategically places an alphabet soup of metrics into a meaningful and intuitive vertical and horizontal framework that illustrates the interdependencies and relationships between the various metrics. KPIs are organized in multiple rows using the Influx, Active and Outflux framework as well as in meaningful columns.

We use the Influx Active Outflux Framework here but expand it much more than the Executive Overview. While the Executive Overview was meant to have only the most important metrics in each category, the Pulse Tree shows a much more comprehensive view reporting on many performance metrics for each Donor Type in each category. This is meant to be a detailed picture of KPIs for all the important Donor Types laid out in an organized Framework. The outer three rungs show similar metrics for each donor type on the Influx and Active sections. From the most outer rung to the most inner it goes: $ Income, # Gifts, # Donors, there is a label that says which donor type it is reporting on these metrics for. The Outflux metrics do not abide by the same convention due to having different metrics. The Outflux organization structure has the donor type name on a rung connecting two circles, the left circle shows the Lapsing Donors of that type and the right circle shows the Lapsed Donors of that type.

There is a drill on the bottom of the screen that enables the user to drill down into the metrics and find specific answers about performance. The user can choose any of the circles on the page and the drill will update with that data. Then the user can click a specific bar in the first graph, and the rest of the drill will update accordingly for that data. These drill charts are meant to uncover more of the story for a metric. They segment the chosen metric into the different channels and regions associated with the organization, so if a metric is performing poorly the user can diagnose which channel or region is causing the decline.

Without the ability to interact with the data through this drilling feature, we could not place this same amount of data on the screen in a manner that the user can quickly and easily understand. We had to create this drilling feature in order to improve the capability of what the computer device can show at one time and make it so much easier for the user to find answers to a vast amount of questions.

The first chart from the left has a toggle feature, the options dictate how the drill works. Here is an example option: KPI>Channel>Month. This means that the first chart shows the historical performance over different periods for the KPI that has been selected from the data tiles at the top of the screen. Next the user can click any one of the bars on that KPI chart and the next chart which is the Channel chart shows that KPI from that specific period chosen broken down between all the Channels. Then the user can click any one of the bars from the Channel chart and the next chart which is the Month chart will show how the KPI chosen has performed from that specific channel over time.

There are different toggle options, so the charts can either drill from the KPI to a category and then to another category and then to the historical performance over different periods for that chosen slice of data, or the drill can go from the KPI to one category and then show the historical performance over different periods for that chosen slice of data. Basically, it can drill the KPI into one or two categories and theoretically as many as we would like. Breaking down the KPI into the different channels is only an example and it can be anything we have data on. This drill is featured on different views throughout the dashboard. The drill will show data for whichever KPI is selected on each of these views.

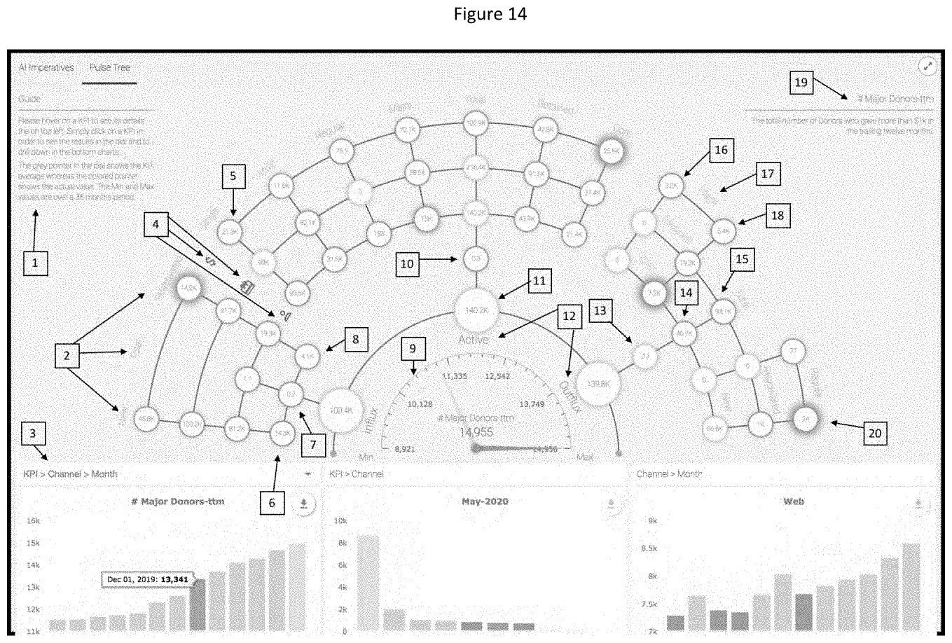

In FIG. 14:
1) This is the guide for how to use the page
2) These are the titles that represent which donor type is being reported on for the circles that are on that straight line going to the center for the Influx and Active sections.
3) This is the drill that starts with whichever KPI is selected from any circle on the page.
4) These icons represent the type of metric that is associated with that rung of the circle for the Influx and Active sections. The outer rung is for $ Income, the middle rung is for # Gifts, and the most inner rung is for # Donors. The donor type that is being reported on for those metrics depends on which vertical line the circle is on.
5) These circles represent the latest period's value and they are conditional formatted for performance. It will range from red: negative growth, yellow: relatively little positive or negative growth, green: positive growth. This specific circle reports on the amount of income from Single Donors, because it is on the line for Single Donors and the outer rung which is for $ Income.
6) This inner rung does not have an icon representing the type of metric because it is not the same for all circles on the rung. This metric still has to do with the “New” donor type because it is on that line. This metric is # New Donors 2nd Gift-ttm: The total number of New Donors who were converted to give again in the trailing twelve months.
7) This inner rung does not have an icon representing the type of metric because it is not the same for all circles on the rung. This metric still has to do with the “Total Influx” donor type because it is on that line. This metric is % Influx Conversion: The percent of Influx Donors (New+Reactivated) who were converted to give again compared to the total number of Influx Donors in the trailing twelve months.
8) This inner rung does not have an icon representing the type of metric because it is not the same for all circles on the rung. This metric still has to do with the “Reactivated” donor type because it is on that line. This metric is # Reactivated 2nd Gift-ttm: The total number of Reactivated Donors who were converted to give again in the trailing twelve months.
9) This dial shows the performance of the metric selected. The min and max from the previous 36 months are the smallest and largest values on the dial. The grey pointer shows the avg value of the metric over the 36 months, and the colored dial shows the current value. The color of the current value pointer is conditional formatted for performance. It will range from red: negative growth, yellow: relatively little positive or negative growth, green: positive growth.
10) This inner rung does not have an icon representing the type of metric because it is not the same for all circles on the rung. This metric still has to do with the “Total Active” donor type because it is on that line. This metric is % Retention: Percent of Donors who gave last year (13 to 24 months ago) and gave again this year (0 to 12 months ago) compared to the total number of donors last year.
11) The circles on this inner rung represent the total number of donors represented in each section. For Influx it represents the total number of New and Reactivated Donors in the trailing twelve months. For Active it represents the total number of Active Donors in the trailing twelve months. For Outflux it represents the total number of Lapsing and Lapsed Donors in the trailing twelve months.
12) These titles as well as the Influx title to the left represent the category of metrics that are stemming out of that location. There are three segments on the page: Influx, Active, and Outflux.
13) The icons that represent the type of metric on the rung do not apply to the outflux section. This metric still has to do with the “Total Outflux” donor type because it is on that line. This metric is % Attrition: Percent of Donors who gave last year (13 to 24 months ago) and did not give again this year (0 to 12 months ago) compared to the total number of donors last year.
14) The icons that represent the type of metric on the rung do not apply to the outflux section. This metric still has to do with the “Total Outflux” donor type because it is on that line. This metric is Lapsing Donors-m: The number of Donors who last gave 7 to 12 months ago.
15) The icons that represent the type of metric on the rung do not apply to the outflux section. This metric still has to do with the “Total Outflux” donor type because it is on that line. This metric is # Lapsed Donors-ttm: In the trailing twelve months the total number of Donors who last gave 13 to 24 months ago.
16) The icons that represent the type of metric on the rung do not apply to the outflux section. This left circle represents Lapsing metrics.
17) This is the donor type that is being reported on in the circles to the left and right. For instance, this title is Major, so the left circle is Major Lapsing and the right circle is Major Lapsed. This is how Outflux section is organized.
18) The icons that represent the type of metric on the rung do not apply to the outflux section. This right circle represents Lapsed metrics.
19) This shows the name and description of the metric that has been clicked on and therefore that metrics performance is being displayed on the dial and that metric is able to be drilled down through the drill charts on the bottom.
20) This circle is glowing because it is one of the metrics included in the AI Imperatives. The circles with the red glow represent metrics the organization is performing the worst in, and the circles with the green glow represent metrics the organization is performing the best in.

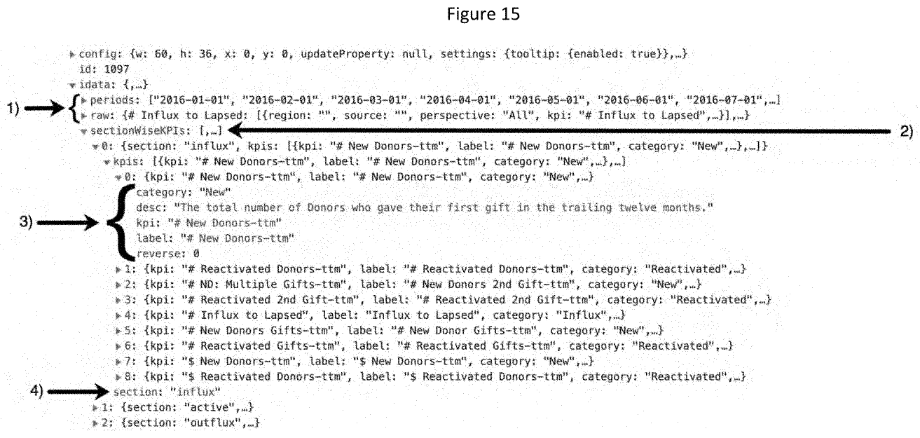

FIG. 15 shows how the invention improves the functioning of the computer by utilizing the following methods. We send the Periods/dates and raw data from the backend (API) to frontend as this data is required for the drill down charts. We need to display the last month's data for every KPI. In order to ensure the data is lightweight and to get it quickly, we prepare and send the data without the keys (such as all available dates) in each data set. On the frontend, we prepare the data by array of periods/dates and compute color formatting for all KPIs and drill down charts. Regarding drill down charts (bottom of FIG. 14), we generate the output very quickly by using multiple processing threads to process the data. In FIG. 15:
1) We prepare three different sections (“influx”, “active” & “outflux”) whereby each section includes multiple KPIs. Pulse Tree is organized at the highest level by section (Influx, Active, Outflux). In the Influx and Outflux sections KPIs are organized vertically by KPI grouping, and horizontally by Customers/Donors, Orders/gifts, and then $ Amount.
2) We are using static content to get the KPI details by category, label, description and reversed flag (when KPI is reversed, a higher value is bad). Regarding KPI title, description and category, we retrieve those when the website loads and store them as global variables. Whenever the cursor hovers over a given KPI, we display information regarding KPI at the top right corner in FIG. 14.
3) Section name is static and only displays the section title in widget, therefore, compute is not required to render these sections.

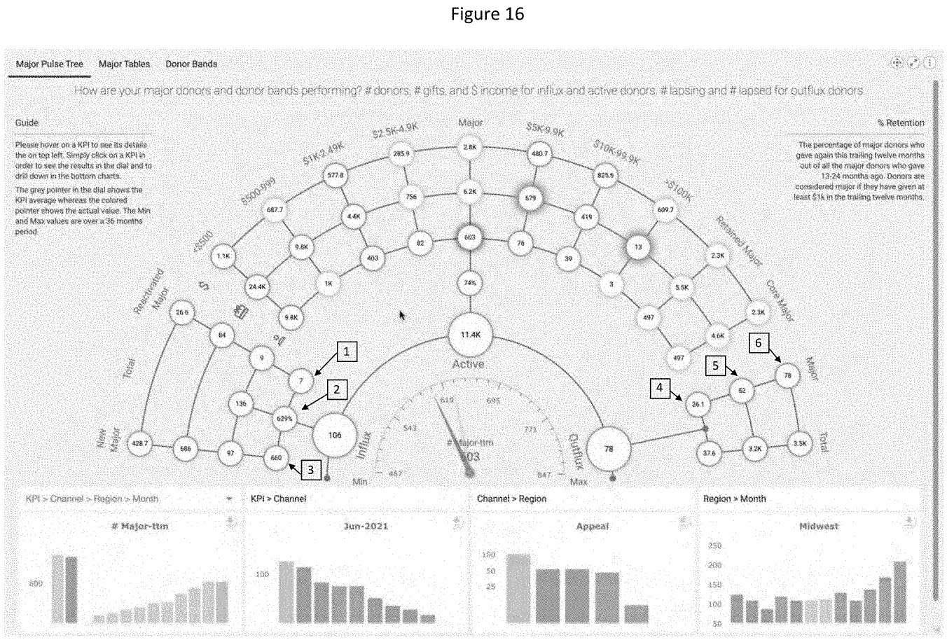

FIG. 16 is an alternate application for the pulse tree. This is applying the concept of the pulse tree to a different set of metrics. The layout has changed slightly due to the difference in optimal organization for this set of metrics. However, the spirit and functionality of the pulse tree is maintained. This version is focused on major donor types and donor bands. In FIG. 16:
1) This inner rung does not have an icon representing the type of metric because it is not the same for all circles on the rung. This metric still has to do with the “Reactivated Major” donor type because it is on that line.
This metric is # Reactivated Major 2nd Gift-ttm: The total number of reactivated major donors who were converted to give again in the trailing twelve months. Donors are considered reactivated if they gave again after having lapsed from giving for at least a 12 month period. Donors are considered major if they have given at least $1k in the trailing twelve months.
2) This inner rung does not have an icon representing the type of metric because it is not the same for all circles on the rung. This metric still has to do with the “Total Influx” donor type because it is on that line. This metric is % Major Conversion-ttm: The percent of influx major donors (new major+reactivated major) who were converted to give again compared to the total number of influx major donors in the trailing twelve months.
3) This inner rung does not have an icon representing the type of metric because it is not the same for all circles on the rung. This metric still has to do with the “New Major” donor type because it is on that line. This metric is # New Major 2nd Gift-ttm: The total number of new major donors who were converted to give again in the trailing twelve months. Donors are considered new major if they have given their first gift and at least $1k in the trailing twelve months.
4) The icons that represent the type of metric on the influx and active rungs do not apply to the outflux section. This metric still has to do with the “Major” donor type because it is on that line. This metric is % Major Attrition-ttm: The percent of major donors who gave 13 to 24 months ago and then did not give again in the trailing twelve months. Donors are considered major if they have given at least $1k in the trailing twelve months. The circle on this same rung, but on the “Total Outflux” line reports on % Total Attrition.
5) The icons that represent the type of metric on the influx and active rungs do not apply to the outflux section. This metric still has to do with the “Major” donor type because it is on that line. This metric is # Major Lapsing-m: The number of major donors who last gave 7 to 12 months ago. Donors are considered major if they have given at least $1k in the trailing twelve months. The circle on this same rung, but on the “Total Outflux” line reports on # Total Lapsing-m.
6) The icons that represent the type of metric on the influx and active rungs do not apply to the outflux section. This metric still has to do with the “Major” donor type because it is on that line. This metric is # Major Lapsed-ttm: In the trailing twelve months the total number of previously major donors who last gave 13 to 24 months ago. Donors are considered major if they have given at least $1k in the trailing twelve months. The circle on this same rung, but on the “Total Outflux” line reports on # Total Lapsed-ttm.

### Influx Active Outflux Framework—Donor Tables

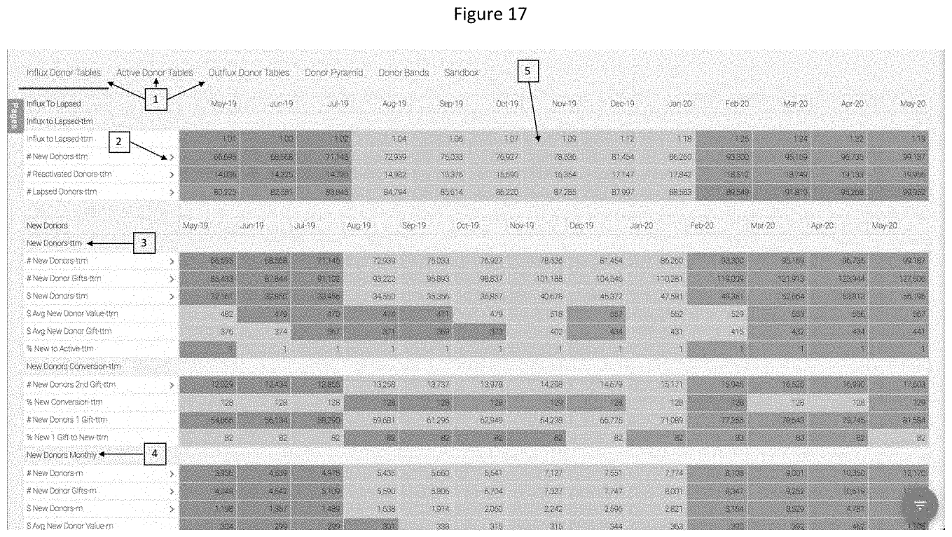

As shown in FIG. 17, there are three tabs of tables: Influx, Active, and Outflux. This is the most exhaustive list of metrics organized in each Influx Active or Outflux category. This view is important when the organization finds out about a problem area in another view such as the AI Imperatives or the Pulse Tree and they want to hone in on corresponding metrics. So much digging into the data can be done in this view because every metric available is shown. The metrics are grouped in their respective Influx, Active, or Outflux category, and then are further grouped by Donor type. So, every metric on New Donors are grouped together, and they are close by to every metric on Reactivated Donors (these two types make up the Influx category). Basically, this is the most comprehensive embodiment of the Influx Active and Outflux categories, and they are displayed in a smart table form. In FIG. 17:
1) These are different tabs on this page. The user can select any of these and the page will update with that view. These three tabs are specifically all of the metrics organized by donor type in a table form for each of the Influx, Active, and Outflux categories.
2) If this arrow is selected the table will expand down and this metric will be further segmented into smaller categories that make up this metric.
3) The metrics are organized by the different donor types that make up each category (Influx, Active, Outflux)—the trailing twelve-month (ttm) metrics are grouped together first and then the monthly values of the metrics are grouped together underneath. After the ttm and monthly metrics are shown for a donor type then the same order is used to display metrics for the next donor type. Not all metrics have a ttm and monthly value.
4) Here is the start of the monthly metrics.
   The background color of the cell is conditional formatted based on the performance of that period compared to the rest of the periods of that same metric. It will range from red: worst performing, yellow: middle performing, green: best performing.

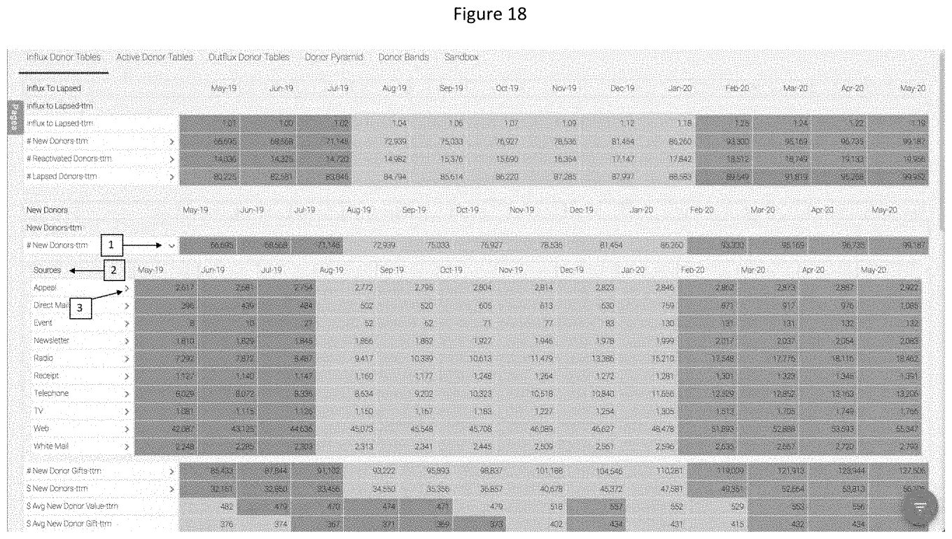

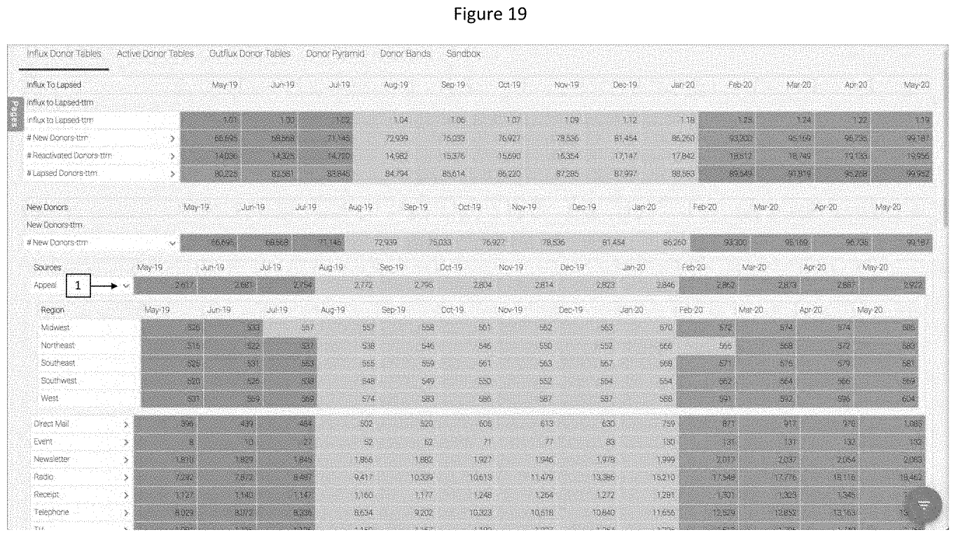

Similarly, in FIG. 18:
1) This drill toggle has been selected so the table has expanded down with the metric from this row segmented into all of its sources (channels).
2) This is the title of the category the metric has been segmented into.
3) Any of these arrows can be selected in order to drill that metric that has already been segmented into a further segment.
   FIG. 19 is also similar, in which:
1) This drill toggle has been selected and the table was expanded again to segment that metric into a category. This screenshot shows how the page looks when the table has been expanded two times. All of the period values of the original metric are visible, as well as the metric types it was drilled into, as well as the types it was even further drilled into.

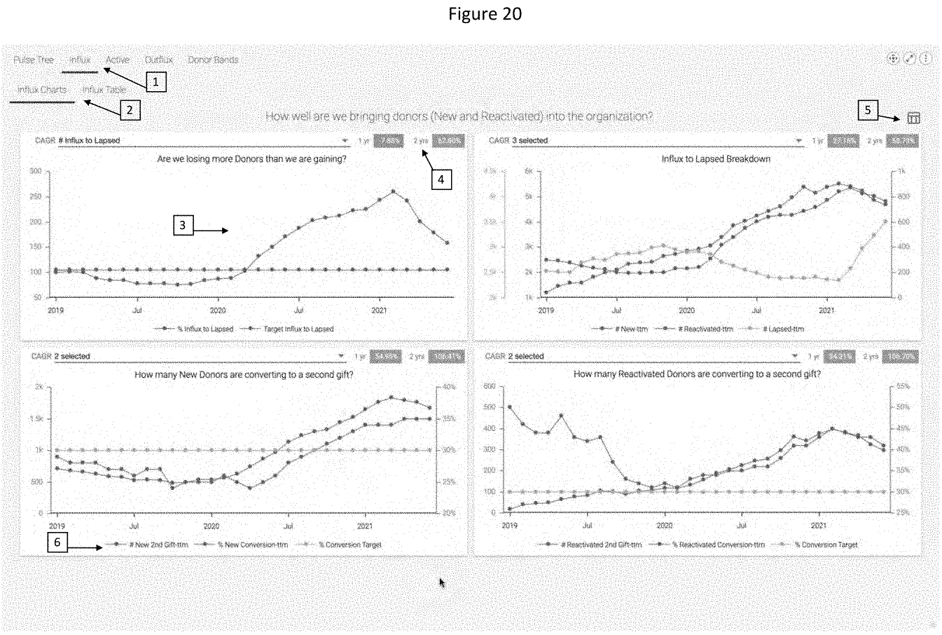

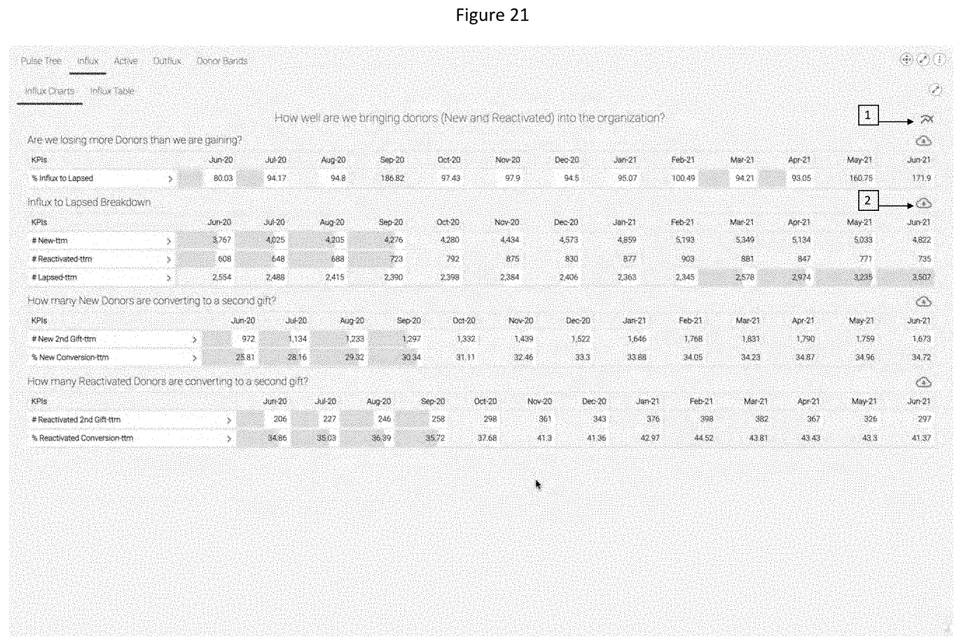

FIG. 20 is an alternate method of displaying the influx, active, and outflux metrics. Now there are three pages: influx, active, and outflux. Each page has a tab for charts and tables. Also, on the chart tab there is a table icon on the right that enables the user to see the metrics from the charts in table form. This method chooses the most important metrics to display first in the charts, without a lot of extra metrics that muddle the story. Then the user has the option of going to the table tab to see every metric available. We have brought these charts over from the Donor DNA out into the open on this tab. Previously in the Donor DNA, the user would have to select one of the Influx, Active, or Outflux sections to see these charts. These charts do such an excellent job in summarizing the performance that they should be more immediately accessible. In FIG. 20:
1) The line under “Influx Charts” indicated this is the tab currently selected.
2) If the user selects any place on the chart and then drags the cursor the chart will update to only show that time period. A button will then appear on the top right of the chart to return to the default full period when selected.
3) The number to the right of “1 yr” is displaying the 1 year cagr, and the number to the right of “2 yr” is displaying the 2 year cagr for the metrics selected in the toggle to the left. The color of the box around the number is color conditional formatted for performance. Red if the value went down from the prior period, yellow if the value stayed the same or slightly increase, and green if the value increased more than slightly.
4) If the user selects this table icon, then the view will update to show all these same metrics in table form. Shown in FIG. 21.
5) If the user selects a title, then it will become greyed out and the corresponding line on the chart will disappear. The user can then reselect the greyed-out title for the metric to appear again on the chart.

FIG. 21 is the view that appears when the user has selected the icon from FIG. 20 #5. In this Figure:
1) If the user selects this chart icon, then the view will update back to show FIG. 20.
2) If the user selects this icon, they will have an option to download the data in this table.

### Strategy Lanes—Marketing Health Framework and UI Improvements

In order to manage their operations, marketing and operational executives typically look at fragmented tactics rather than taking a holistic view of their customer lifecycle. For instance, if the organization is performing well with Acquisitions but are failing to convert acquired donors into a second donation, then they are taking a fragmented view of their operations, not properly managing their risk, and not proactively organizing for growth. This siloed approach of not looking at the customer/donor as a continuous loop or a lifecycle produces many organizational blind spots and increases risk.

There are many parts to a comprehensive marketing strategy including many segments of people to target. Some organizations do not have a clear understanding of all of these segments while others do but they do not keep track of their performance. Even if an organization knows who the key segments are and keep track of their performance, the way their data is reported on can make it difficult to quickly and easily gain insights that fuel good business decisions.

Our solution was to create a new user interface that utilizes a framework which enables the vast amount of marketing health data to be displayed on the computer device in a way that the user can quickly and easily gain insights. This is different than the Influx Active Outflux framework in the sense that the Influx Active Outflux is looking at the health of the donor file that leads to the overall health of the organization, whereas the strategy lane framework is analyzing the how well the organization is doing with marketing towards the donor file. When the organization improves each strategy lane the improvement in performance is reflected in the Influx Active Outflux framework as well. In order to optimize the understanding of the user we have separated all the donors into five groups that the organization needs to track its marketing performance from.

Holistic understanding and management of the performance system: if a phenomenon is to be accurately understood, all of its dimensions and the various synergies from those dimensions will need to be evaluated. In order to understand the performance system, it is imperative to see and understand the patterns from the various dimensions and react to those patterns. The Strategy Lanes identify five foundational pillars that when evaluated in concert constitute a holistic lifecycle approach or a performance system to help organizations effectively manage their risk and efficiently optimize both current and future growth.

Organizations may evaluate Acquisition, Reactivation, Conversion, Retention and Cultivation separately as siloed tactics, but looking at these as a continuum or a customer lifecycle provides indispensable and unprecedented insights into the overall health, growth and sustainability of the organization. The invention organizes the data as a continuum with the intention of highlighting the weakest links in the performance system.

The Strategy Lanes provide a scorecard of how organizations are doing on each of the foundational customer pillars so that overall performance is understood in its proper context and organizations are able to manage the whole and the parts well. If performance is to be properly grasped, then all five strategy lanes and their synergy need to be considered. This is due to the fact that there is a symbiotic connection between the parts as a customer/donor may transition from one strategy to another.

We have created a new UI that enables the user to very quickly and easily:
Understand which Donors are important to keep track of.
Understand how these Donors are performing.
Understand for which of these key Donors their strategies are working.
Understand for which of these Donors they need to adjust their strategies on in order to improve performance.

If the organization maintains this cycle of understanding what to keep track of and always adjusting their strategies based on what the data is telling them, then they will optimize their performance in the short and long term. We created this framework by first looking at the entire donor file and then we divided it into five key groups of donors. The invention ensures that each of the following foundational marketing pillars are growing and being proactively managed.

Acquisition—how well are you doing acquiring donors? This covers New Donors. We have metrics in here that report on New Donor acquisition and performance.

Reactivation—how well are you doing reactivating lapsed donors? This covers Reactivated Donors. We have metrics in here that report on Reactivating previously Lapsed Donors and their performance.

Conversion—how well are you doing with getting the donors you bring in to give a second gift? This covers how well the organization is doing with converting Donors to give a second gift.

Retention—how well are you doing keeping your donors active? This covers how well the organization is doing with keeping their Active Donors. From there we further segment into Retained (Have given two years in a row) and Core Donors (Have given three years in a row) to track their performance.

Cultivation—how well are you doing with key donor segments, major and regular? This covers how well the organization is doing with Major (Have given more than a certain amount in the trailing twelve months) and Regular Donors (Have given more than a certain number of gifts and less than the major donor amount threshold in the trailing twelve months).

### Strategy Lanes Framework—Strategy Lanes

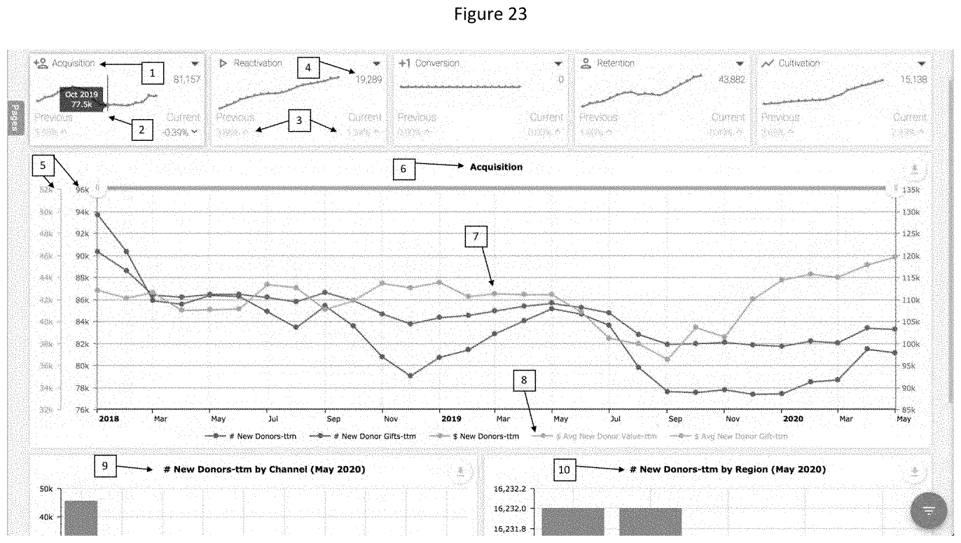

The page of FIG. 23 is the embodiment of the Strategy Lanes framework which divides marketing activities into five groups. Once you segment the file into these groups then you can track how well you are doing with each group and adjust marketing strategies accordingly. Organizations cannot treat all donors the same, so in order to elicit the best response there must be a rational grouping. Once this grouping is created then the organization can track if their specific strategies for each group are working and continuously fine tune their approach. We have this Framework in our Marketing Lane.

There are five tiles at the top of the screen that each cover one of the five strategy lanes: Acquisition, Reactivation, Conversion, Retention, Cultivation. Each tile has a spark line with the number of those donors over time. Once the user clicks on a tile they will see the charts below populate with data for that lane. Then the user can select a specific bullet point for the middle chart and the breakdown of that metric by channel and region will appear in the two charts below. Channel and Region are just two examples, we can choose to break down the bullets through any categories we have data on.

Improves the function of the computer device by:
showing the holistic framework on a single screen instead of having to go to countless dashboards.
Even within in the single screen, the less important KPIs are unchecked (hidden) by default on the chart until they are selected.
Enabling users to instantly drill into any metric simply by clicking on the metric in chart, instead of having to go to different screens. This will show the metric by marketing channel and by region already sorted from best to worst.

In FIG. 23:
1) This is the title of the strategy reported on in each data tile.
2) This sparkline shows how well the organization is doing with this strategy by reporting on the number of donors that result in performing the strategy well. For instance, Acquisition reports on the number of New Donors in the trailing twelve months, instead of the number of Non-Donors who could potentially become a New Donor. Further, Reactivation reports on the number of Reactivated Donors in the trailing twelve months, not the number of Lapsed Donors who can be reactivated. Conversion reports on the number of Donors converted from a single gift to a second gift in the trailing twelve months, not the number of Single Gift Donors who could potentially be converted. Retention reports on the number of Active Donors in the trailing twelve months. Cultivation reports on the number of Major and Regular donors in the trailing twelve months. When the user hovers over the sparkline the value and date of that period shows up.
3) This shows the change the previous period had over the period prior to it on the left, and on the right it shows the change from the previous period to the current period.
4) This shows the value of the current period. There is an icon above the value that is conditional formatted for performance. It will range from red: negative growth, yellow: relatively little positive or negative growth, green: positive growth.
5) These different axis values are color coordinated with each metric in the key below.
6) This is the title of the strategy that is being reported on in the chart, this corresponds with which data tile has been selected. The selected data tile also has a highlighted border color.
7) Each of these bullets represent a specific period for that specific metric, represented by the corresponding color of the line in the chart and color of the line next to the metric in the key. When a bullet is clicked on the specific period value for the specific metric is drilled down in the two charts below. The left chart shows that metric period segmented into each available channel. The right chart shows that metric period segmented into each available region.
8) Here this metric is greyed out, this means its corresponding line is not shown in the chart above. If the metric is clicked, then it will show in the chart above and can be clicked again to remove from the chart.
9) This left chart shows the value from the bullet selected on the chart above segmented into each available channel.
10) This right chart shows the value from the bullet selected on the chart above segmented into each available region.

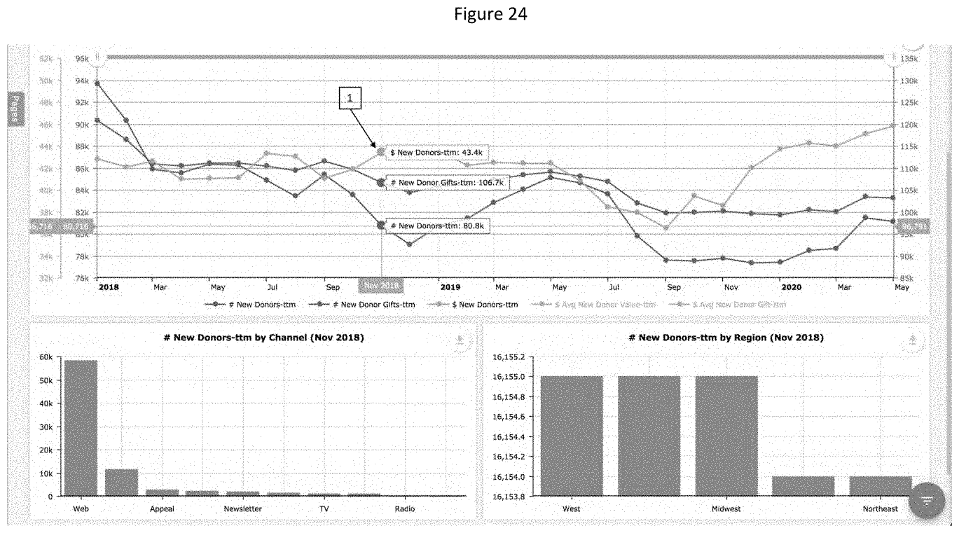

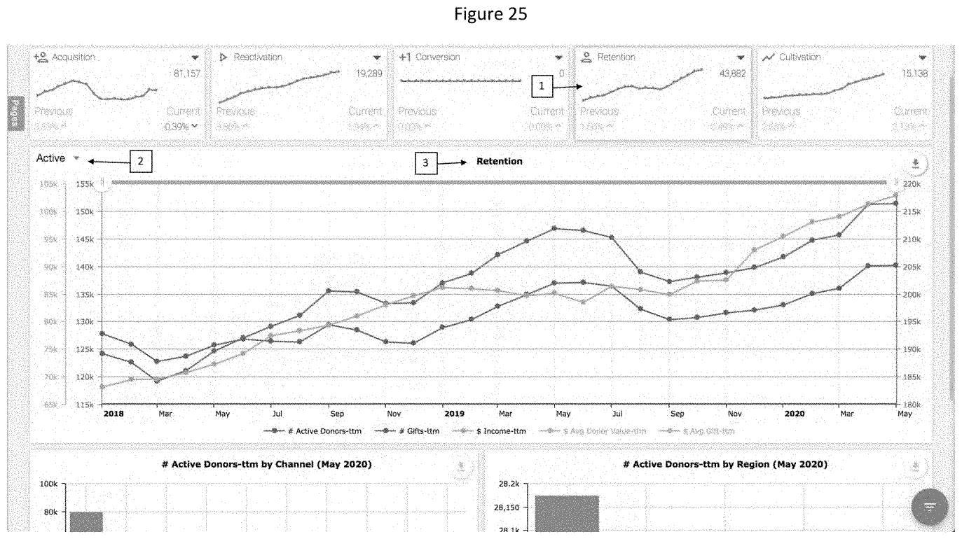

The screenshot of FIG. 24 shows the bottom charts that drill the selected bullet into further segments. In this FIG. 24, 1) when the top chart is hovered the respective values for the x and y axis are shown. In FIG. 25:
1) This tile has been selected so its border is highlighted, and it is then reported on the charts below.
2) This strategy lane has a few types of donors that it can be further segmented into. This toggle button gives the user the ability to select which segment of donors are reported on in the chart. Whichever segment has been selected and thereby is being reported on in the chart will be written here.
3) This is the title that shows which data tile (strategy lane) has been selected and thereby is being reported on in the charts.

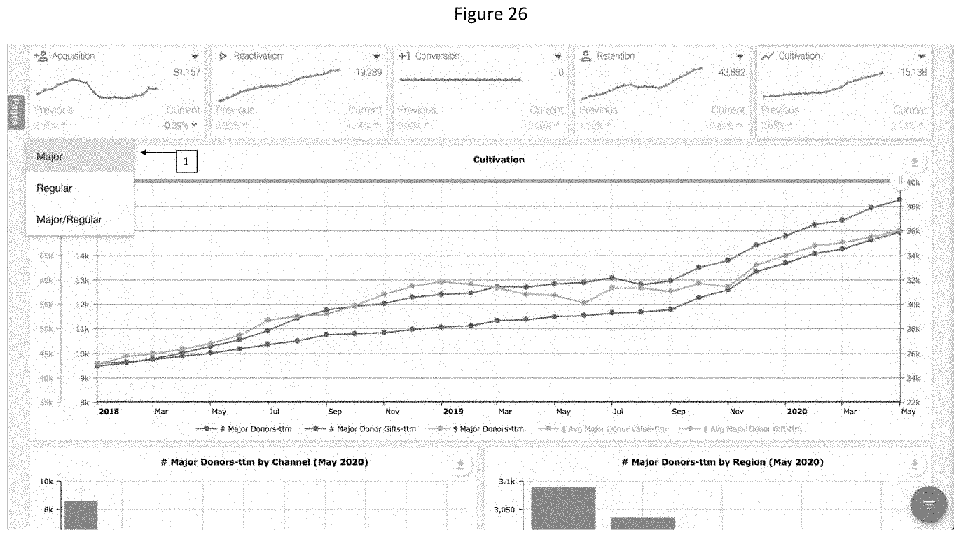

FIG. 26 is similar. In this Figure: 1) This is the list of the donor types that this chart could report on. Each type can be clicked and then that is what is reported on in the charts.

As an alternative view, we use a slightly different categorization of the donor types in two of the lanes. Previously the Retention Lane was tracking active, retained, and core donors. We have updated this to track retained, core, and a new donor type that tracks lapsing donors who gave again. The goal of the retention lane is for your organization to retain donors i.e., prevent active from lapsing and prevent lapsing donors from becoming lapsed. This new metric evaluates how the organization is doing with convincing lapsing donors to give again, which is a key concept in the retention strategy. Previously the cultivation lane was tracking major donors, regular donors, and major/regular donors. We have updated this to track active, major, and regular donors. We have moved the active donors from the retention to cultivation because the goal should be to cultivate the active donors that the organization has created in the previous four lanes. Each of the four beginning lanes are about bringing donors into the organization (acquisition and reactivation), getting them to give a second gift (conversion), and then preventing them from leaving (retention). This final lane is the culmination of creating this strong donor file, it is the last step—to cultivate the strong donor file you have created. We also removed major/regular as it was already included through having major and regular represented.

### Marketing Analytics—Marketing Campaign and Channel Performance UI Improvements

Problem: When organizations perform different marketing activities in order to get their donors to keep donating, they have a need to analyze the performance of these different activities. Here we can separate three aspects to keep track of:
How are marketing campaigns performing?
How are the different channels that marketing campaigns happen through performing?
How are the different segments of donors performing specifically through these different campaigns and channels?

These are important questions that successful organizations need the answers to. There are many reasons why organizations do not have this information at their fingertips. Here are a few:
Organizations do not have the resources compile all their data and report on it.
Organizations do not know what data to pay attention to.
Organizations may have the resources to process the data and know what to pay attention to, but the way their reporting is set up makes it very difficult and time consuming to gain important insights. Instead of quickly understanding the insights and then having plenty of time to adjust their strategy based on the insights, they are spending the majority if their time just trying to figure out what the insights are.

Traditional reporting either does not answer the important questions, is designed in a way that can easily overwhelm, lead to confusion on what is important, or does not make it clear on what actions to take. Organizations need to slice large quantities of data in a way that fits on a computer device and still provides the ability to interact with the data in order to quickly and easily find specific answers.

Solution: We created new user interfaces that enable the vast amount of marketing campaign, channel, and segment health data to be displayed on the computer device in a way that the user can quickly and easily gain insights. Through these User Interfaces we have answered three important questions:
How have my campaigns performed?
How have my marketing channels performed?
How have the different segments of Donors performed through our marketing campaigns and channels?
   We have designed each page so that charts can interact with each other, this enables the limited space on the screen to be able to hold more data than was possible before and deliver it in a way that is quick and easy for the user to understand.

### Marketing Analytics—Campaign Performance

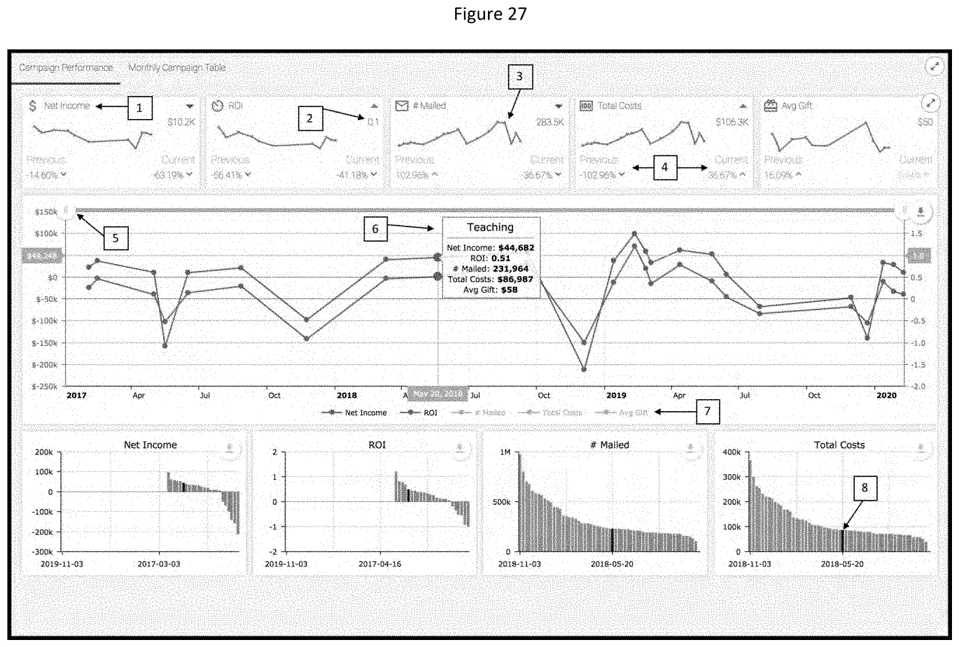

The interface of FIG. 27 is meant for the Executive to quickly understand how marketing campaigns have performed. The amount of data that this view is able to effectively provide insights on from this one page would not be possible without this new UI.

At the top of the page we have five data tiles with the overall trailing twelve-month values for the Net Income, ROI, # Mailed, Total Cost, and Avg Gift size. Then we put every campaign on a line chart for the last three years with their Net Income, ROI, # Mailed, Total Cost, and Avg Gift size. Below that we have 4 charts that have every campaign ranked in order of Net Income, ROI, # Mailed, and Total Cost. When the user hovers over a campaign on the line chart above, the corresponding bar for that campaign on the charts below becomes highlighted. This is a benchmarking feature provides organizations with the insight of how that campaign performed compared to every other campaign on very important metrics.

FIG. 27 contains these elements:
1) This is the title of the metric shown in the data tile.
2) This is the value for the metric for the current period, with a conditional formatted icon. It will range from red: negative growth, yellow: relatively little positive or negative growth, green: positive growth.
3) This is a sparkline with the past 18 period values.
4) This is the growth percentage for the previous period and the current period.
5) This slider can be dragged to change the number of periods shown in this chart.
6) This is a quick description of all the metrics and their values pertaining to that campaign that is shown when the cursor hovers over that x axis value area.
7) The user can click these greyed-out metrics for them to be shown on the chart as well.
8) When the user hovers over the middle chart on the page then its description is shown like outlined on #6, and its ranking from greatest to least among all the campaigns is shown by highlighting its respective bar on the bottom four charts.

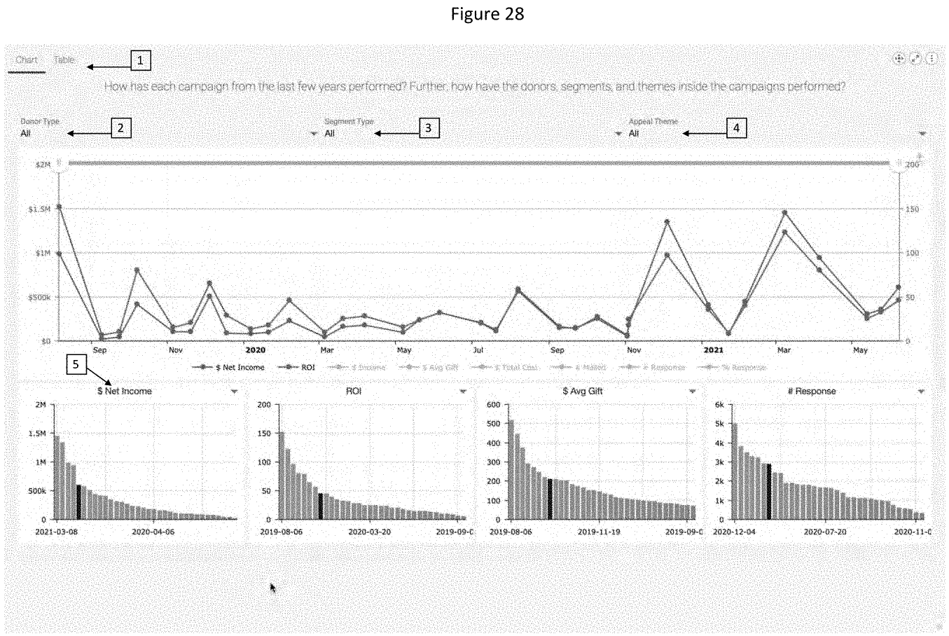

FIG. 28 is an alternative updated view. As an alternate view, we removed the tiles at the top as they were covering information like what is already included in the middle line graph. We replaced the tiles with three toggles that allows the user to filter the middle line graph by three different categories. This enables users to track how one group of donors is performing over time across various campaigns and strategies. One of the toggles also allows the user to track how one campaign theme has performed overtime across the various campaigns. In both instances these filter options allow the user to gain instant insights not previously available on performance across type, segment, or theme. Consequently, users can optimize their strategies based on these insights. We have also improved the four bottom charts by adding a toggle in which the user can select which metric they want to view. This gives the user more freedom and flexibility in their search for information. In this view:
1) Currently the chart is selected, as per the line underneath the “Chart” tab. If the user wishes to view this same data in table form, then they can select the text “Table”, then the line will move underneath “Table” and the view will update.
2) If the user selects this area, then a dropdown will appear for the user to select something from the list that the results on the line graph below will be filtered through. In this case the category is donor type, so the line graph below will only show campaign results from the specific donor type that was selected from the dropdown.
3) Here is another filter option, similar as #2 & #4. This gives the user an option to filter the line graph below by a different category. If the user had selected something on a different dropdown (#2 or #4) and then selects an item from this dropdown then the latest item selected will override the previous selection.
4) Here is another filter option, similar as #2 & #3. This gives the user an option to filter the line graph below by a different category. If the user had selected something on a different dropdown (#2 or #3) and then selects an item from this dropdown then the latest item selected will override the previous selection.
5) If the user selects this area, then a dropdown will appear for the user to select which metric will be displayed in this chart. All the charts on this row have this feature.

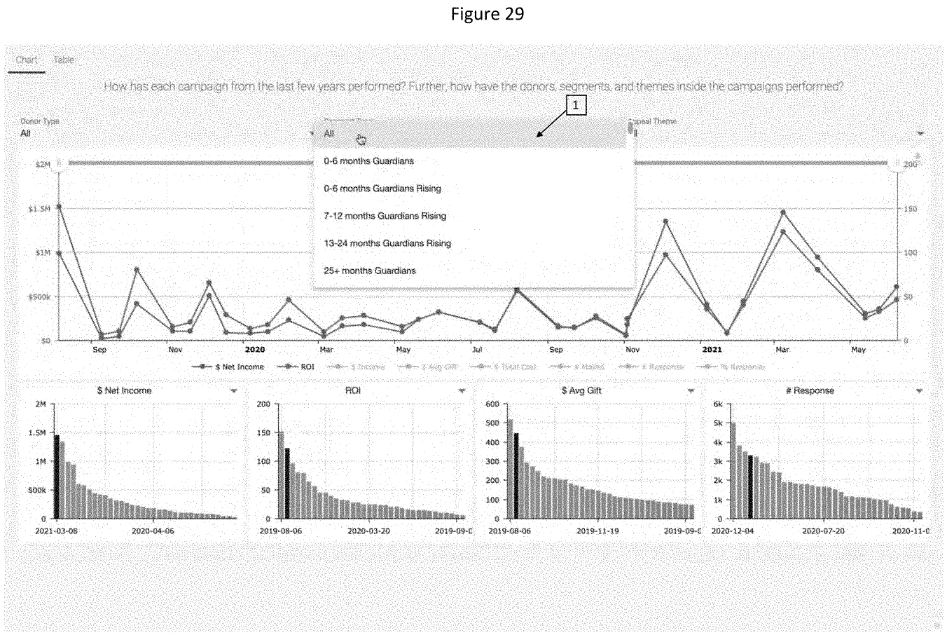

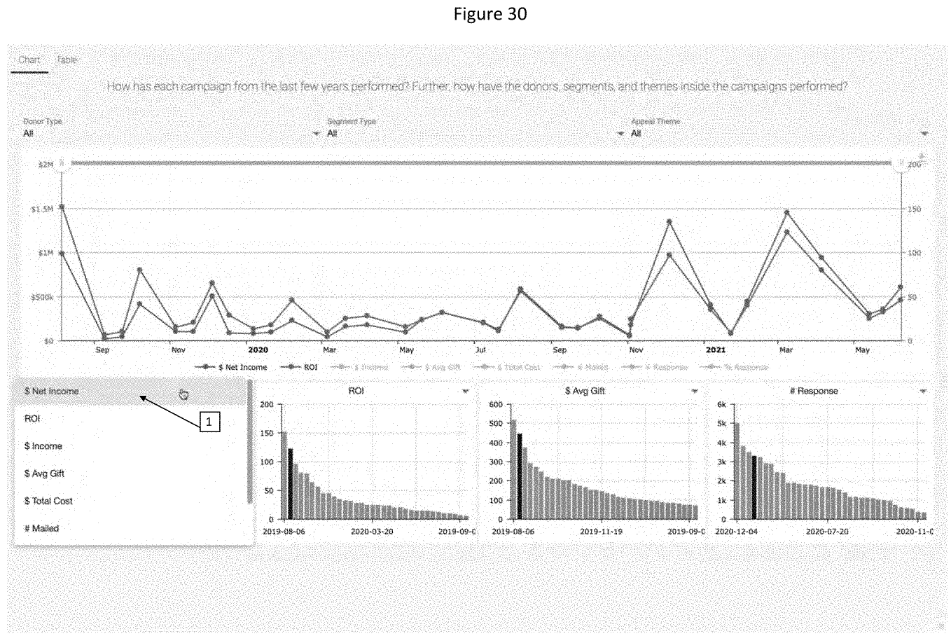

In FIG. 29 is an example 1) of a dropdown that appears when the user selects the area shown on FIG. 28 #2, #3, or #4. In FIG. 30, 1) shows the dropdown that appears when the user selects the area shown in FIG. 28 #5.

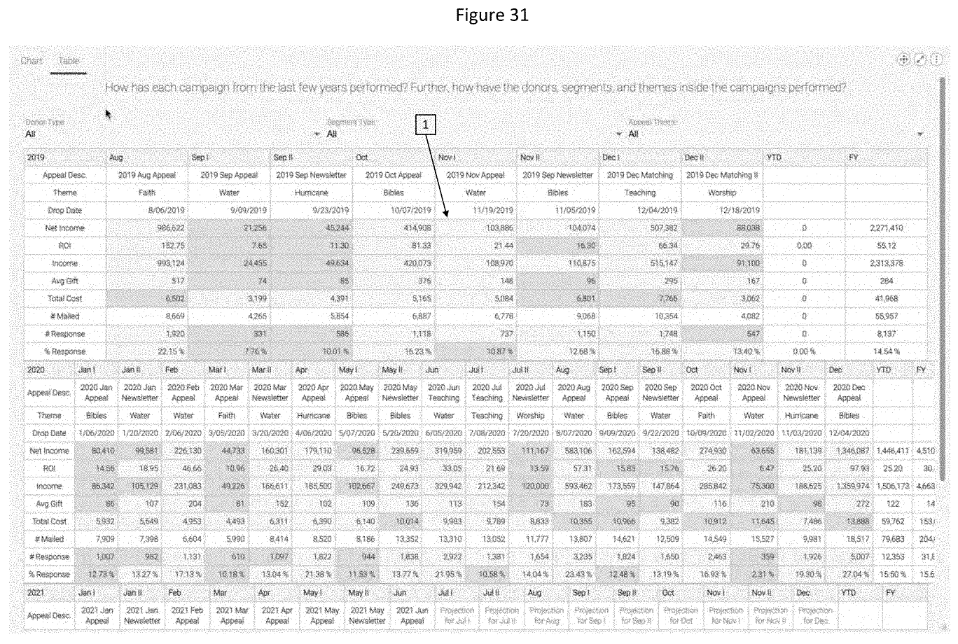

FIG. 31 is the table that is shown when the user selects the text “Table” on the top left of the screen. This table shows the same data from the “Chart” tab, and it has the same filter options showcased on FIG. 28 #2, #3, or #4. At 1), some rows are color conditional formatted. Red for the worst values, yellow for the values in the middle, and green for the best values.

### Marketing Analytics—Channel Performance

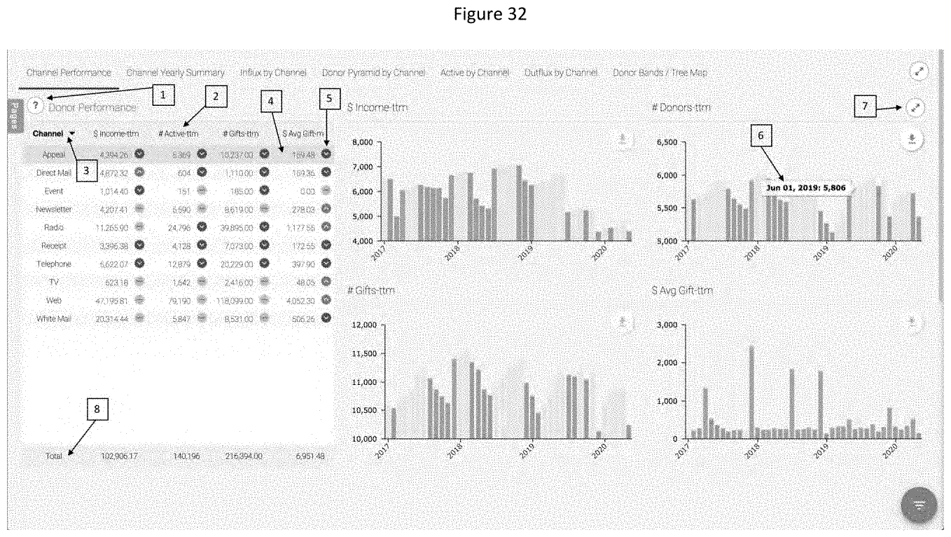

The view in FIG. 32 gives trailing twelve-month totals of Income, # Active Donors, # Gifts, and Avg Gift for each marketing channel, region, and overall. Then the user can choose a single channel or region to view the metric values for each month over the last four years. The amount of data that this view is able to effectively provide insights on from this one page would not be possible without this new UI. This Figure contains these elements:
1) Once this help icon is clicked a popup will appear with a guide on why the view is important, how to use the page, and the definitions of the metrics used.
2) This column is the number of Active Donors in the trailing twelve months from each channel. If a different item is selected in the toggle to the left this will remain the number of Active Donors in the trailing twelve months from whatever is selected. If this or any other column is selected then the rows will filter from greatest to least based on values in that column, if clicked again it will filter from least to greatest from the values in that column, and if it is clicked again it will go back to the standard order.
3) This is a toggle menu with different options on how the metrics in the table are segmented. The name of the option selected shows there. In this case the list below contains all the different channels and each column is that metric applied to each channel.
4) This row is highlighted because it is the row the data is being pulled from for the four charts on the right. If any other row is selected, then that will be the data from that row will update in the four right charts. Each chart shows the historical value of that metric throughout different periods of time. While the table on the left shows the value of the current period.
5) These icons are conditional formatted for performance. It will range from red: negative growth, yellow: relatively little positive or negative growth, green: positive growth.
6) When a bar is hovered over the period name and value will appear.
7) Each chart can be shown on full screen when this icon is selected. If the icon is selected again the screen will return to this view.
8) This row shows the total value for each of the rows, and if it is clicked then the four charts on the right will update with the total amounts.

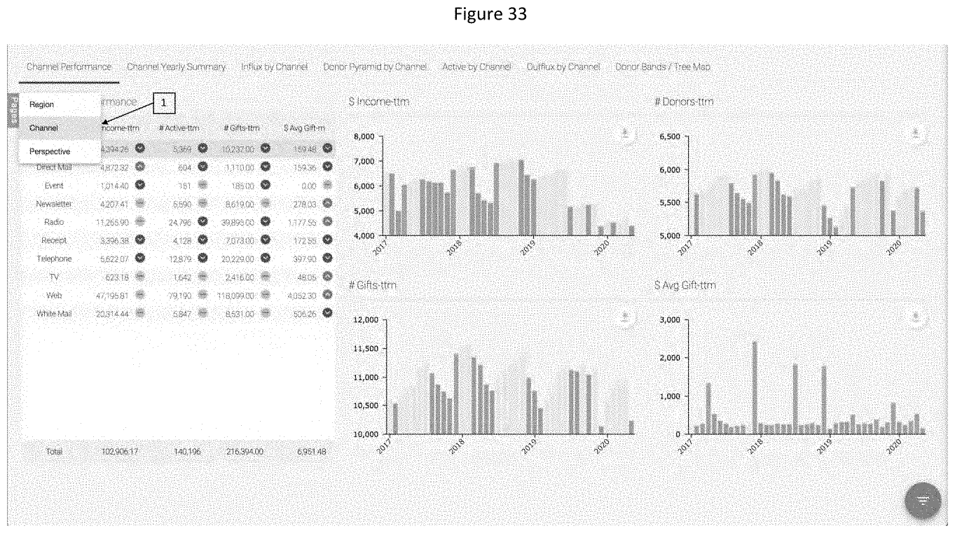

FIG. 33 shows at 1) that when the toggle is clicked a list of available ways to segment the metrics are shown. When one is clicked the page will update with data from that type, and it will be listed next to the toggle.

### Marketing Analytics—Campaign Drill

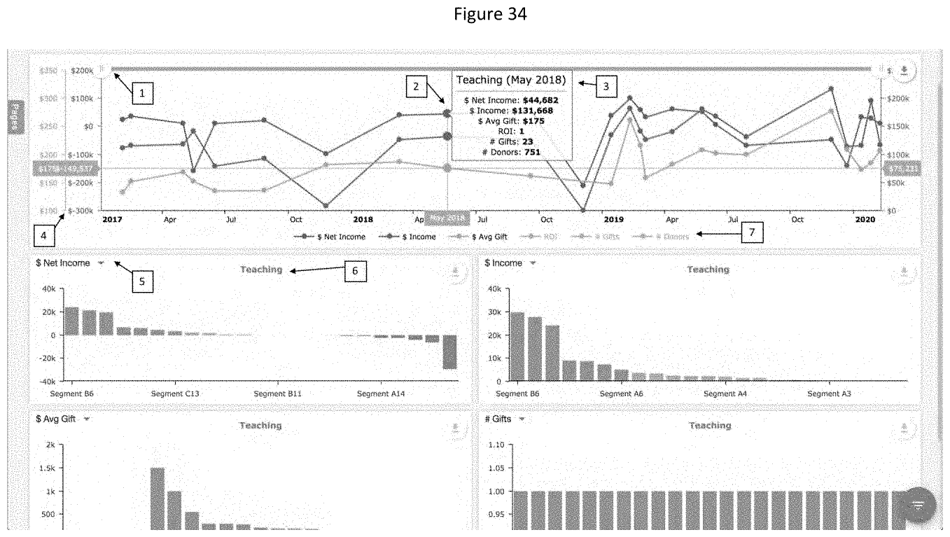

The view in FIG. 34 shows how different segments responded to the campaigns. This view has a line graph at the top that has campaign performance metrics (Net Income, Income, Avg Gift, ROI, # Gifts, # Donors) for every campaign over the last few years. Then if the user clicks on a specific bullet point on the main chart, the four below show a breakdown of the different segments mailed for key metrics. There is a toggle option on the four bottom charts for which metric to show. The amount of data that this view is able to effectively provide insights on from this one page would not be possible without this new UI. The Figure contains these elements:
1) This circle can be dragged, and the time period of data shown in the chart will be updated accordingly. There are circles on both sides of the chart that can both be dragged to arrive at a specific time period to be displayed.
2) This bullet is larger than the others because the cursor is hovering over it currently. The x-axis represents every campaign in chronological order. Each bullet in a vertical line represents different metrics reporting on a single campaign. When a bullet is clicked the four charts below populate with data associated with that campaign. The data shown in each chart depend on which metric is chosen in the toggle menu at the top left of each chart.
3) When a bullet is hovered over this box appears with the values of the different metrics for that campaign. The value for each metric is listed even when all metrics are not chosen in the key below to appear in the chart.
4) These different axis values are color coordinated with each metric in the key below.
5) This is a toggle menu where the user can select which metric they would like to view for the campaign (represented by the bullets from one vertical plane in the line graph) that has been selected in the line chart above.
6) This title will update with the name of the campaign that has been selected in the chart above.

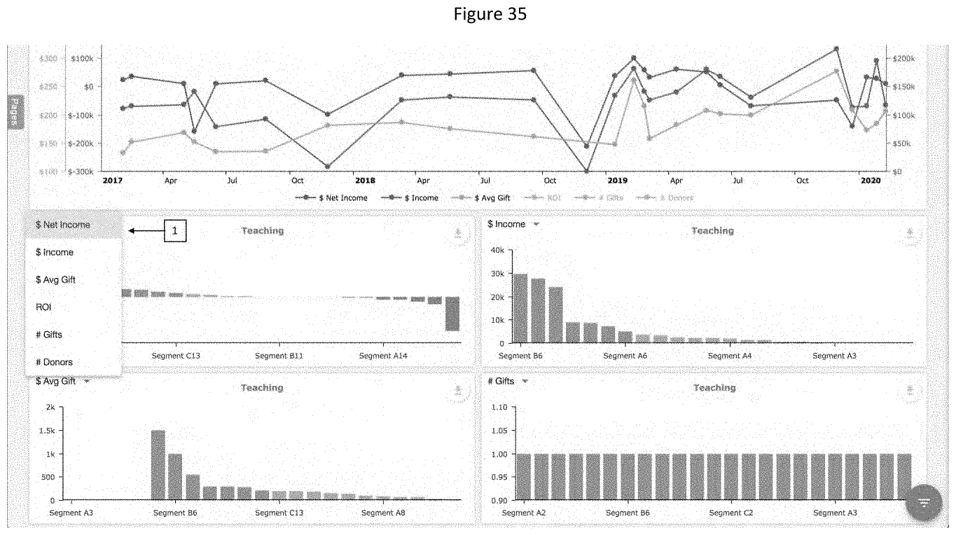

FIG. 35 shows at 1) that when the toggle menu is clicked the options to filter the chart through will be listed here. Whichever one selected is what data the chart will show.

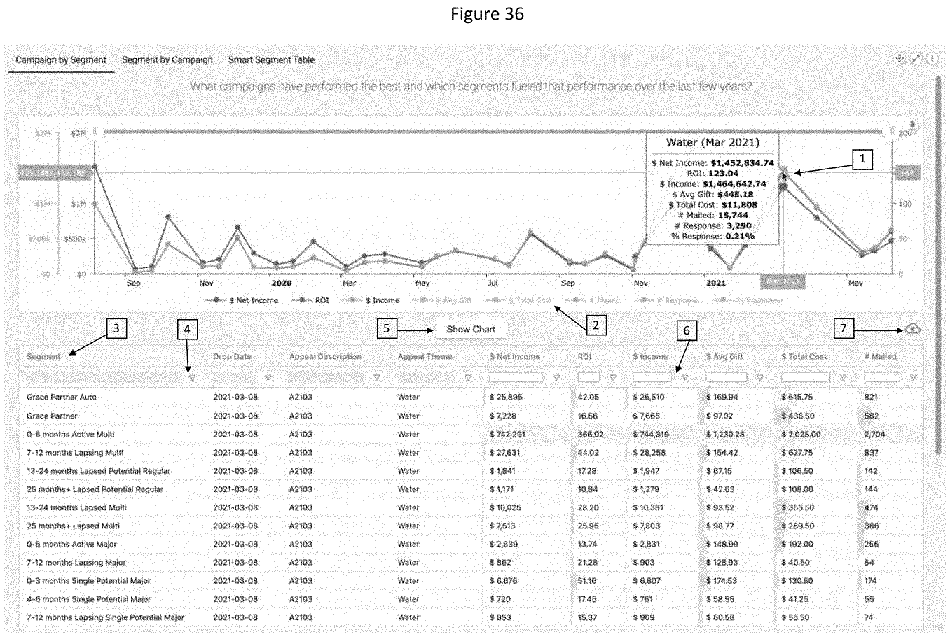

FIG. 36 shows an alternate, updated view. This updated view adds an option to view the campaign segment data in a smart table. Now, users can visually see the name of every segment who gave to that campaign, and then see all the performance metrics associated on the same row. The user can either view the four charts or see this table instead. On the chart view we have added toggles for each chart that enables the user to select the specific metric to report on. In this Figure:
1) If the user hovers over a vertical plane that represents a campaign, then a popup with the values for all the metrics will appear.
2) Some of the metrics for the line chart are greyed out so they are not displaying on the chart, the user can select them and reselect them to have the corresponding line appear and disappear on the line chart.
3) This row contains the titles for the metrics being displayed in each column. If the user selects the area around a title, then the table will sort for that title in either ascending or descending order. The user can change the sorting by selecting again.
4) If the user selects this filter icon, then they will have options to filter the data in the chart by the items in that column.
5) If the user selects this button, then the data in the table will then be shown in four charts.
6) If there is a white rectangle here, then the user has the option to write custom filter rules, such as only show values greater than 100, or in between 300 and 500. The user can string rules together and has the option to use “and” and “or” combinations. “And” would mean both custom filters must be true for that data to show. “Or” would mean either one of the custom filters could be true for data to show.
7) The user can select this icon to download the data in the table.

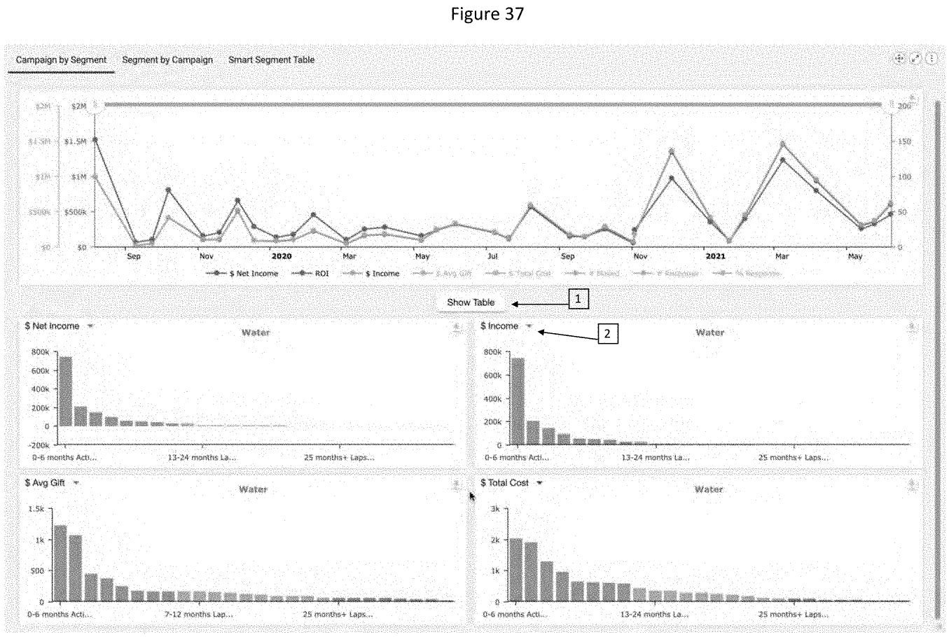

FIG. 37 shows how the view updates when the user selects the button on FIG. 36 #5. These two elements are called out in this Figure:
1) If the user selects this “show table” button, then the view will update back to FIG. 36.
2) Each of the four charts has a toggle here. When selected a dropdown will appear for the user to select an option to display the data for in the chart.

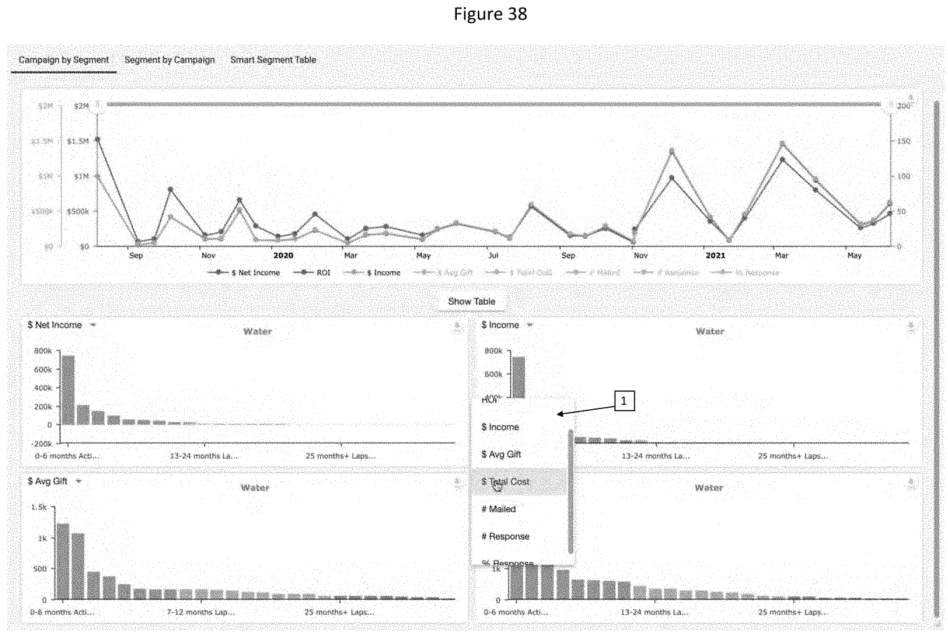

Element 1) in FIG. 38 shows the dropdown that appeared after the toggle was selected in the bottom right chart.

### Marketing Analytics—Segment by Campaign

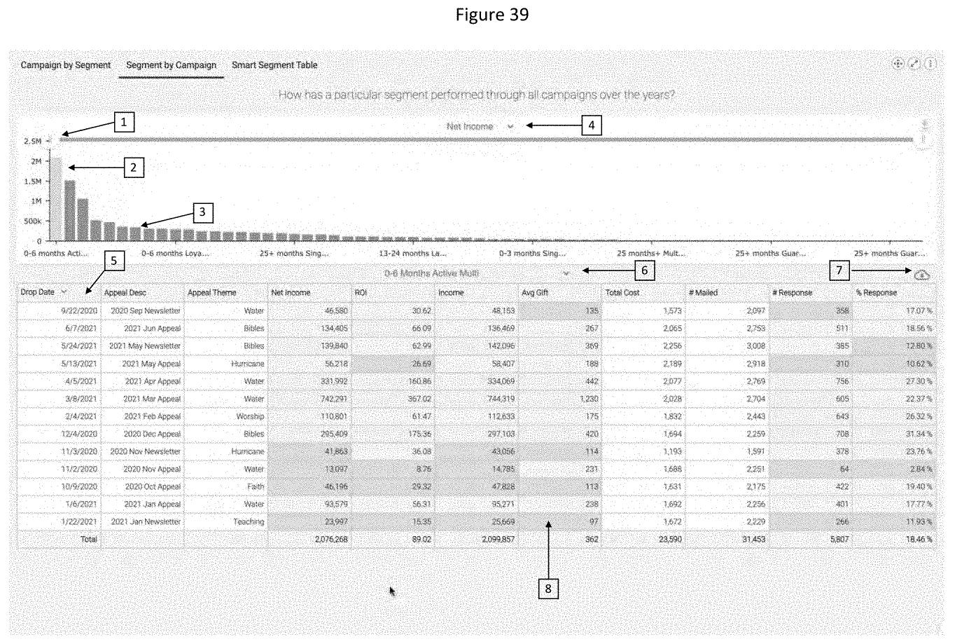

The goal of the view in FIG. 39 is for the user to be able to track how one segment is performing through every campaign over time. The top bar chart has all the segments and is displaying them in best performing to worst for whichever metric is selected from the toggle at the top of the chart. If the user hovers over any of the bars, then the name of the segment and value for the metric will appear in a popup. If the user selects the bar, then that segment will appear in the table below with all history for that segment's performance in all the campaigns. There is also an option to select the segment from a toggle above the table to view the segments historical campaign performance in the table. The user can use this view to track how one segment is responding to campaigns, which campaigns they responded the best to, and further understand which strategies are working. This Figure shows:
1) If this circle is selected and dragged, then the chart will update to only display the bars within the two circles on either side of the chart.
2) This bar is lighter because it is the segment that is currently selected and being viewed in the table below.
3) Each of these bars represent the trailing twelve month (ttm) value of a specific segment for the metric that is chosen on #4.
4) If the user selects this text/toggle, then a dropdown will appear to select different metrics to display in this chart.
5) If the user selects any title from this row the table will sort for the values in that column by greatest to least or least to greatest. The arrow pointing up or down shows which sorting it is currently using.
6) If the user selects this text/toggle, then a dropdown will appear to select which segment to display in the table below. The user can either select the segment in the bar chart above or through this toggle. Either one will trump the previous selection.
7) If selected, this icon will provide an option to download the table data.
8) Cells in certain columns are color conditional formatted for the best to worst (Green to yellow to red) performing within the column.

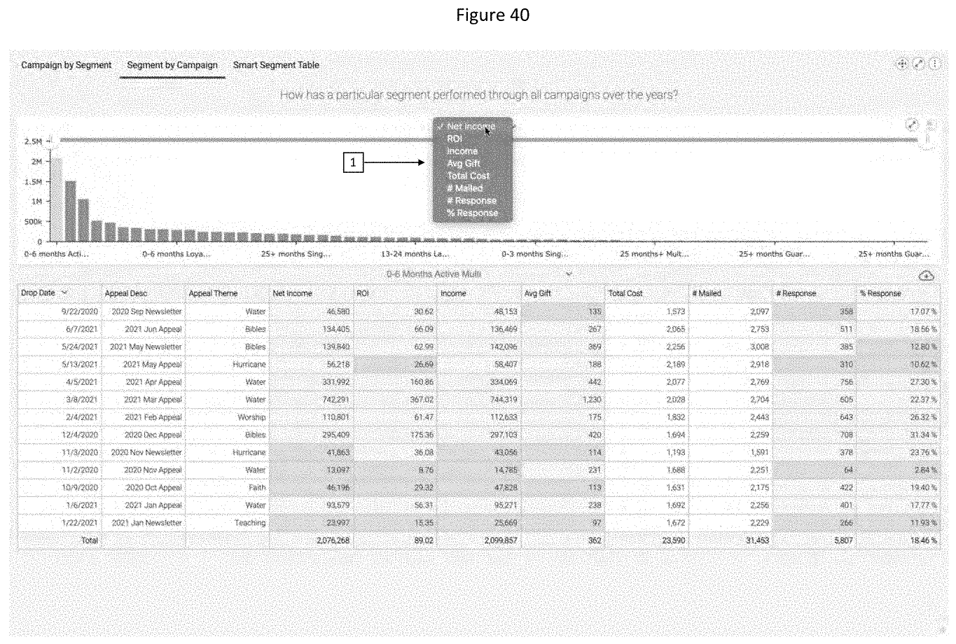

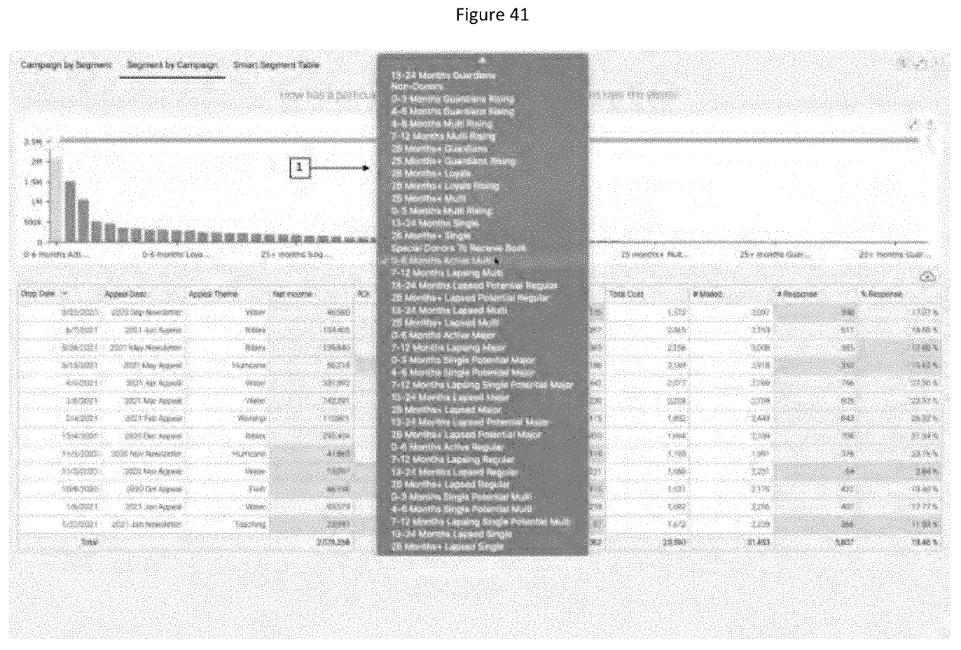

Element 1) in FIG. 40 shows the dropdown that appears for the user to select a metric to rank the segment in the bar chart when they click the text/toggle shown in FIG. 39 #4. Element 1) in FIG. 41 shows the dropdown that appears for the user to select a segment when the click the text/toggle shown in FIG. 39 #6

### Marketing Analytics—Channel Report/Major Donor Channel Report

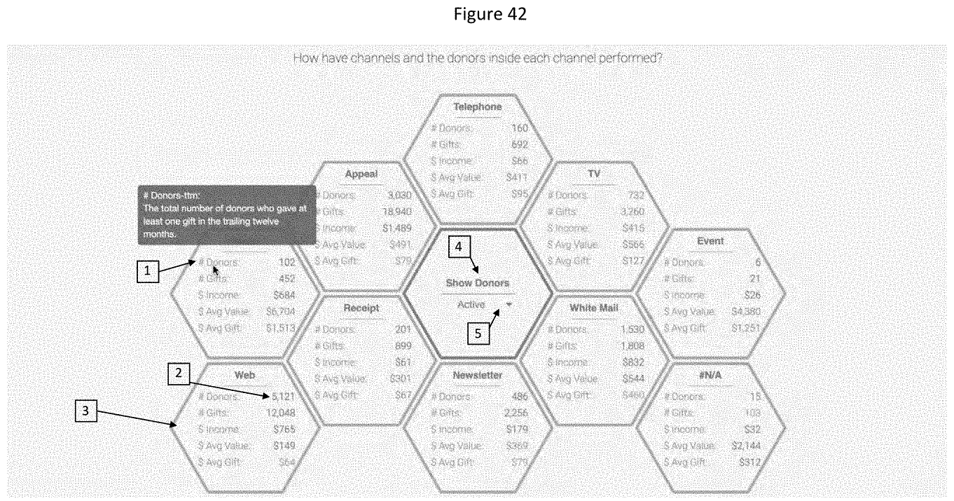

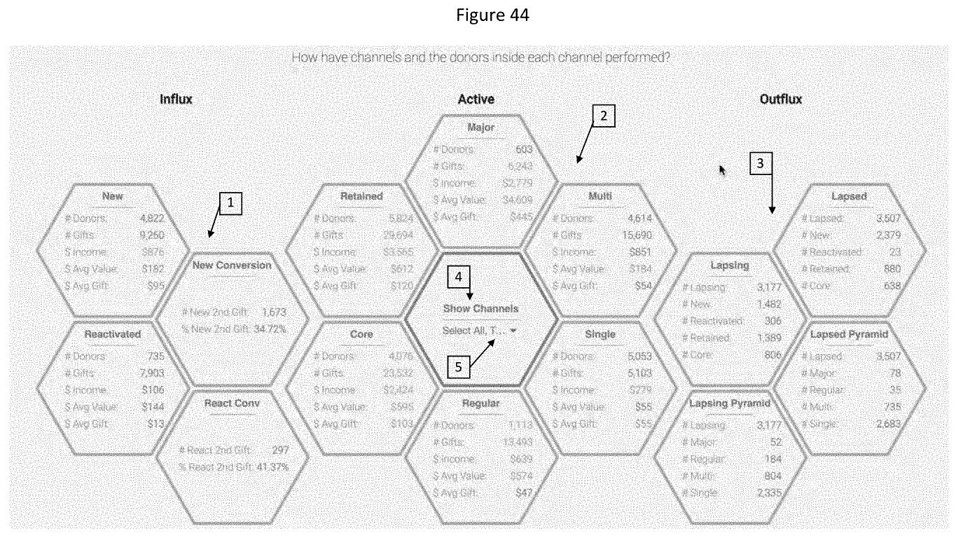

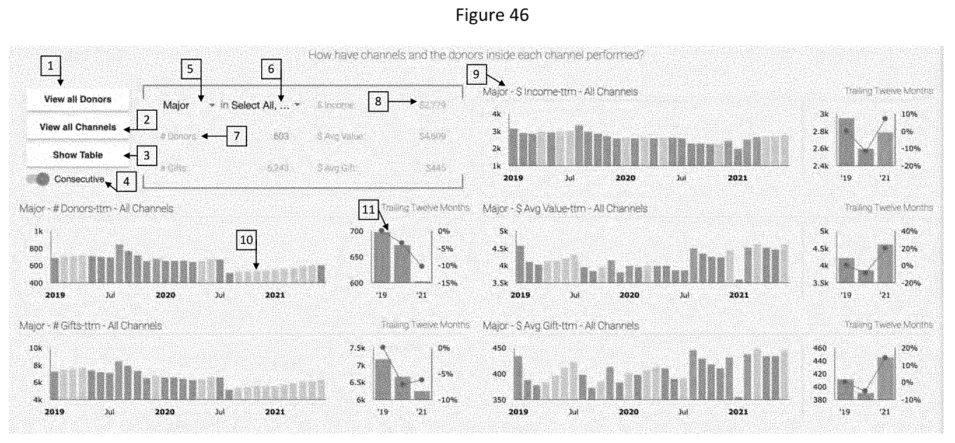

The goal of this view shown in FIG. 42 is to provide a sandbox where the user can learn about how all their marketing channels are performing and how all the donor types are impacting channel performance. This view enables the user to quickly see how one donor type is performing in all channels, or how every donor type is performing in one channel. The user can see the latest performance and how it compares to the period prior on the screens with the hexagons, then the user can select any hexagon to see a detailed history for the metrics. On that detailed page they can toggle between any combination of donor type and channel type to find exactly what they are looking for. The user can stay on that one detail page and answer hundreds of questions simply by selecting different combinations of donors and channels from the toggles. Thus, we went beyond conventional story-telling and enabled the same UI to access and tell multiple stories on demand. By only loading the stream of data the user is after, the computer is able to take cues from the UI and present the required data instantly. The idea is to revolutionize the UI by creating a centralized view that can answer countless questions regarding channel performance. The UI works in concert with the database by only showing a single narrative at a time. However, users can change the narrative with a single click in the same view and pivot into a different story or set of questions. FIG. 42 contains the following elements:
1) If the user hovers over any metric name, then a popup will appear with the title and definition of the metric.
2) To the right of each metric is the value for the latest period. The color will change to red, yellow, or green based on conditional formatting—Red if the value went down from the prior period, yellow if the value stayed the same or slightly increase, and green if the value increased more than slightly.
3) If the user selects a hexagon, then the view will update to a detail page for the data shown in that hexagon. (See FIG. 46)
4) If the user selects the top half of this hexagon (above the horizontal line where the text “show donors” is) then the page will update to a view where the data in each hexagon (other than the middle hexagon) is representative of a donor type (see FIG. 44). For this current view the data in each hexagon is representative of channels.
5) If the user selects the bottom half of this hexagon (below the horizontal line where the text “Active” and the toggle icon are) then a dropdown menu will appear with the ability to select different donor types. When the user selects a donor type then the name will appear where the text “Active” currently is, and each hexagon other than the middle will begin to only show data from the donor type selected within the channel type that is written at the top of the hexagon. Currently “Active Donors” is selected, so each hexagon representing a different channel is reporting on the latest period values for all “Active Donors”.

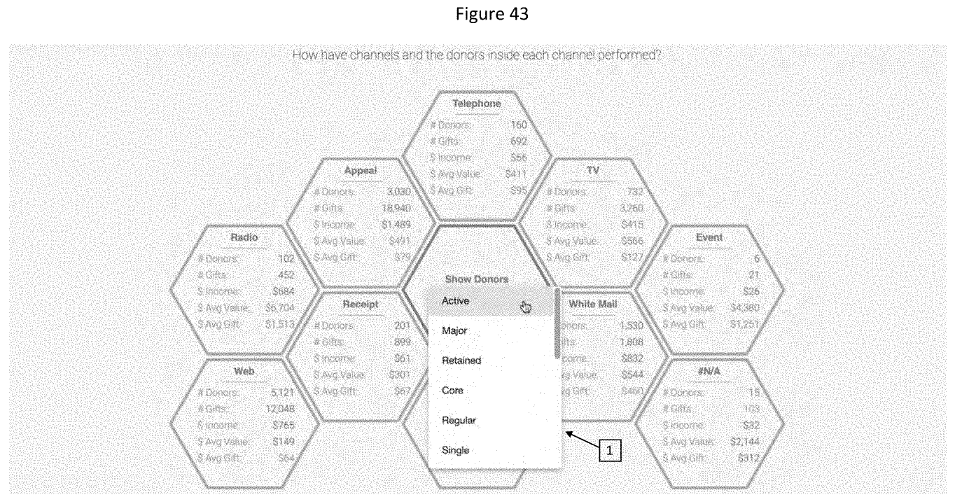

In FIG. 43, element 1) shows the dropdown list that will appear for the user to select which donor type they wish to be reported on within each of the hexagons with channel titles. Once the user selects a donor type then each hexagon with a channel title will begin to only show data for that specific donor type activity within that channel.

FIG. 44 shows the view when the user selects the top half of the middle hexagon (FIG. 42 #4). This Figure contains the following elements:
1) These four hexagons contain data from donor types in the Influx category.
2) These six hexagons contain data from donor types in the Active category (excluding the middle hexagon that is used for selections)
3) These four hexagons contain data from donor types in the Outflux category.
4) If the user selects the top half of this hexagon (above the horizontal line where the text “show channels” is) then the view will update to show the hexagons from FIG. 42.
5) If the user selects the bottom half of this hexagon (below the horizontal line where the text “Select All, T . . . ” and the toggle are) then a dropdown menu will appear with the ability to select different channel types. When the user selects a channel type then the name will appear where the text “Select All, T . . . ” currently is, and each hexagon other than the middle will begin to only show data from the channel type selected within the donor type that is written at the top of the hexagon. Currently all the channels are selected, so each hexagon representing a different donor type is reporting on the latest period values for that donor in all channels.

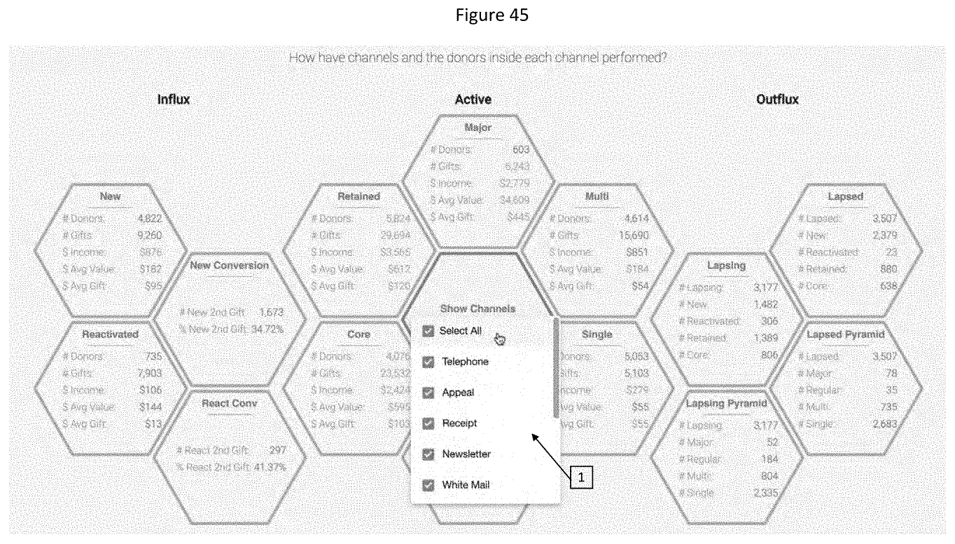

In FIG. 45, element 1) shows the dropdown list that will appear for the user to select the channel type they wish to report on within each of the hexagons with donor titles (middle hexagon is only for settings). Once the user selects a channel type then each hexagon with a donor title will begin to only show data for that specific donor type activity within that channel. The user has the ability to select any combination of the channels, or just one.

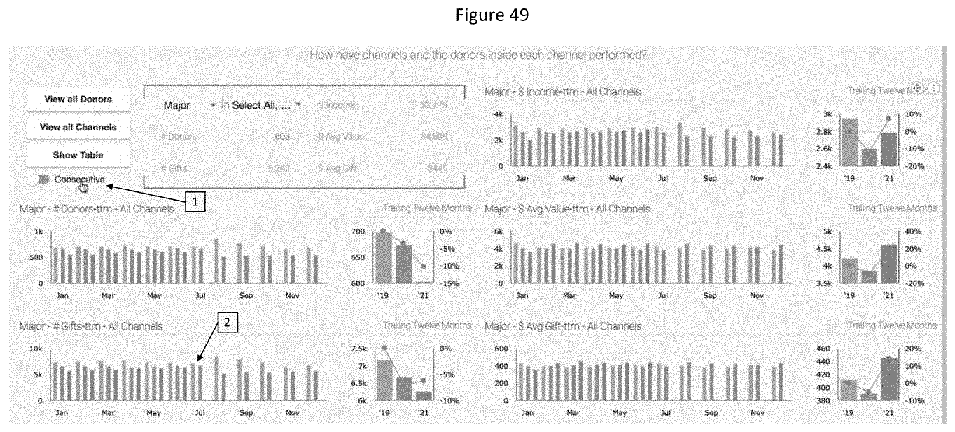

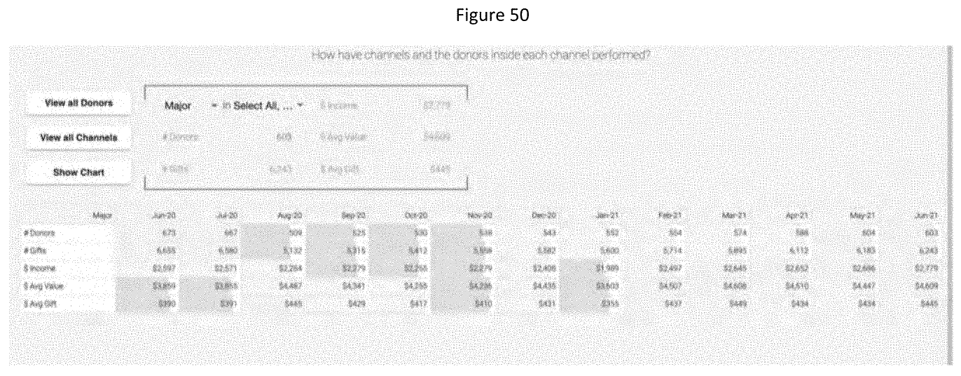

FIG. 46 shows the detail view that will appear when the user selects a donor hexagon from FIG. 44 or a channel hexagon from FIG. 42. The settings selected from the dropdown menu of the previous screen the user was on will carry over here. In this case the user selected the Major hexagon when all the channels were selected in the dropdown menu on the bottom half of the hexagon on FIG. 44. Now the 5 metrics with the latest period values from that hexagon appear here on the top left of the screen. Then, 5 charts show the historical performance of each of those 5 metrics for the combination of donor and channel types currently selected (In this example, Major donors in all Channels). FIG. 46 contains the following elements:
1) The user can select this to have the screen update to FIG. 44.
2) The user can select this to have screen update to FIG. 42.
3) The user can select this to show the 5 metrics in table form instead of chart form. Shown in FIG. 50.
4) The user can select this to have the charts group all the yearly values for each month together. Currently the charts are showing the data in a monthly consecutive or chronological order. The order with the months grouped together is shown on FIG. 49.
5) The user can select this text/toggle icon to make a dropdown menu appear where they can select the donor type that will be reported for on this view.
6) The user can select this text/toggle icon to make a dropdown menu appear where they can select the channel type or combination of channels that will be reported for on this view.
7) If the user hovers over this text, then the title of the metric and definition will appear in a popup.
8) These numbers are the latest period values for the metrics to the left of them and they are color conditional formatted. Red if the value went down from the prior period, yellow if the value stayed the same or slightly increase, and green if the value increased more than slightly.
9) This title states the combination of donor and channel types and the metric being reported on in the chart below it. If the user hovers over this text, then the title of the metric and definition will appear in a popup.
10) If the user hovers over any bar, then the name and value of the period will appear in a popup.
11) If the user hovers over any bar, then the name and value of the period will appear in a popup. This is showing the YTD value of the last three years.

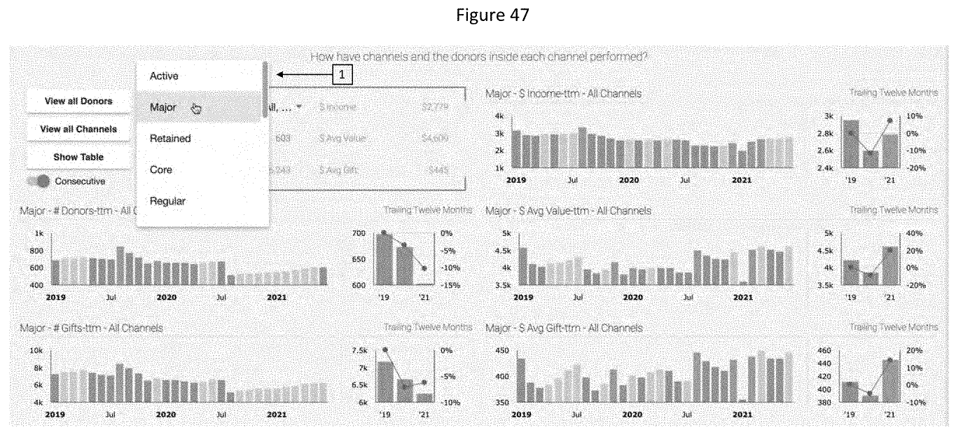

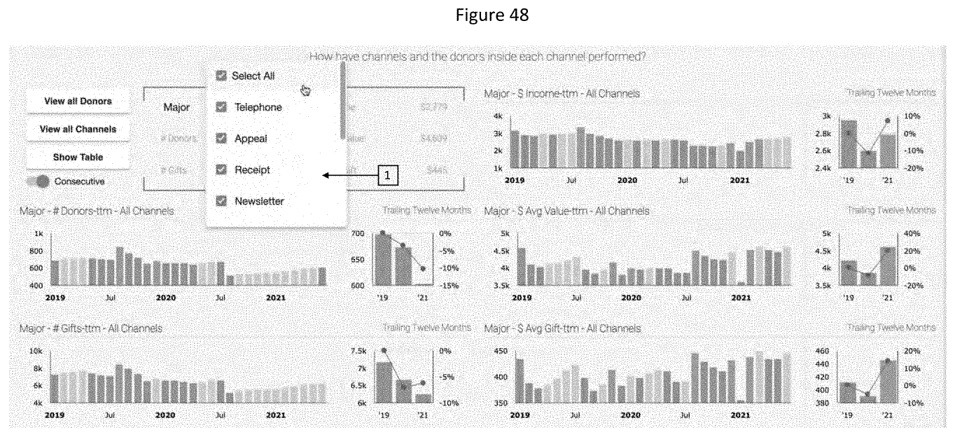

In FIG. 47, element 1) shows the dropdown that appears for the user when they select the area shown in FIG. 46 #5. FIG. 48 shows the dropdown that appears for the user when they select the area shown in FIG. 46 #6. The user can select any combination of channels. FIG. 49 has two elements:
1) This is how the charts update when the user deselects this toggle.
2) Now all years for each month is grouped together. Now above Jul the chart will show July 2019, July 2020, and July 2021 right next to each other. This enables the users to quickly compare how one month has performed over the years.

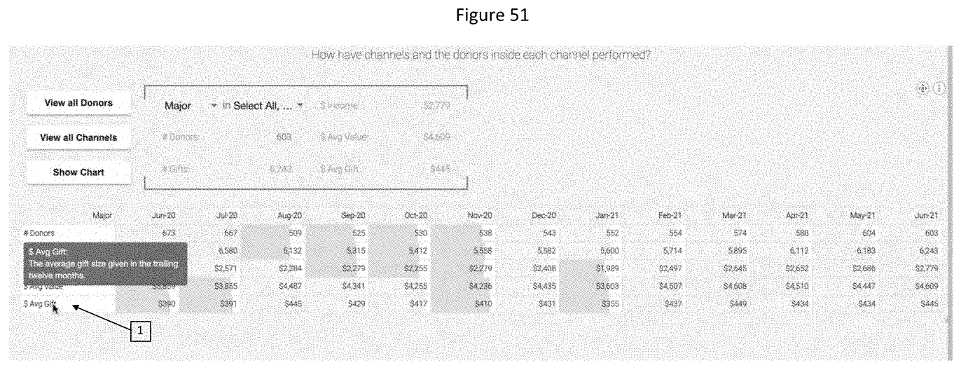

Element 1) of FIG. 50 shows how the view updates to show a table instead of the charts when the user selects the “show table” button on FIG. 46 #3. FIG. 51 shows that, if the user hovers over any metric name, then a popup will appear with the title and definition of the metric.

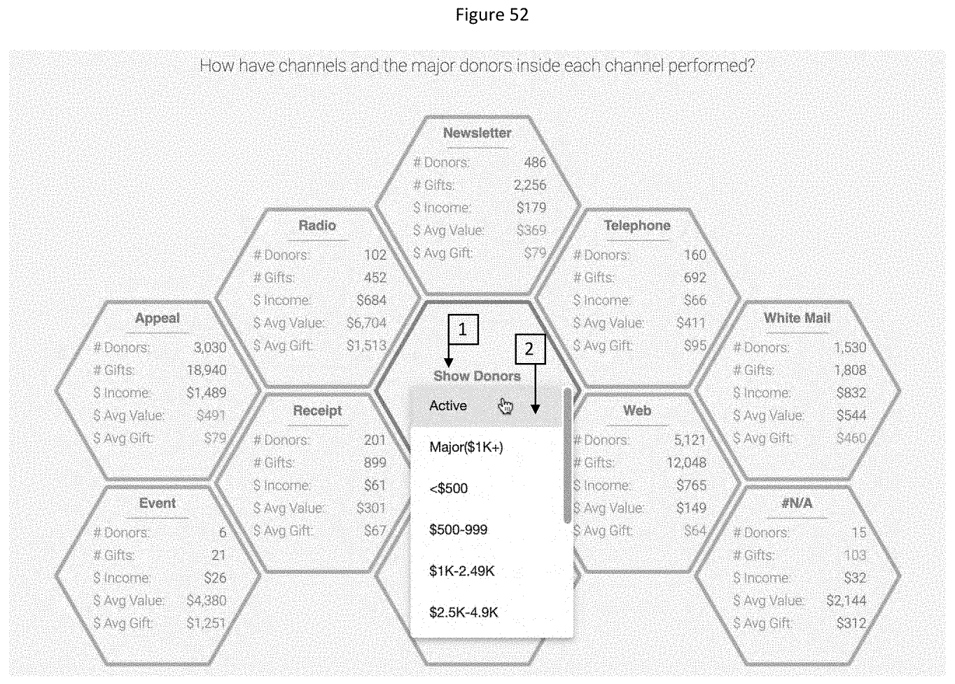

FIG. 52 shows that the Major Donor Channel Report works the same as the Channel Report. This is an alternative view that is focused on Major Donors and Donor Bands instead of all the Donor types within the Influx Active Outflux framework. FIG. 52 shows two elements:

1) If the user selects the top half of this hexagon (above the horizontal line where the text “show donors” is) then the page will update to a view where the data in each hexagon (other than the middle hexagon) is representative of a donor type. For this view the data in each hexagon is representative of channels.

2) Here is the dropdown that appears when the user selects the toggle in the bottom half of this middle hexagon. Here in the major donor channel report, there are different options shown than in the channel report.

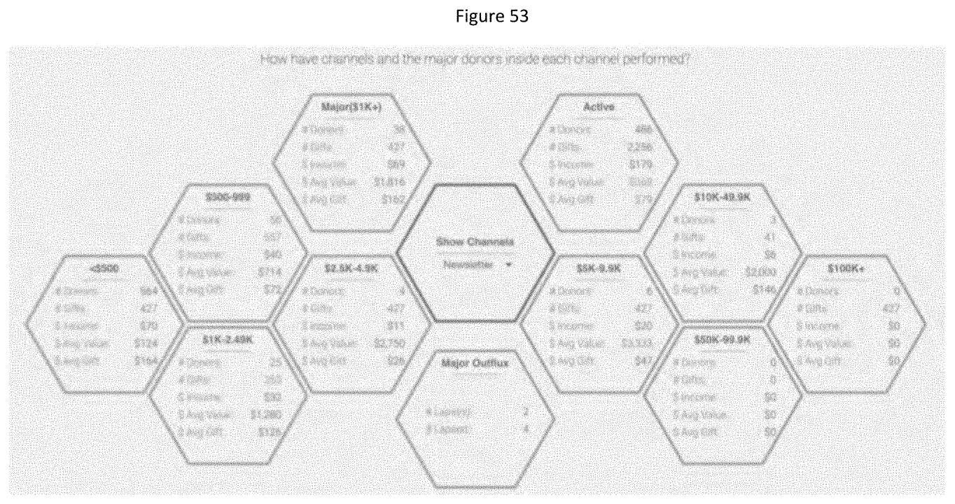

FIG. 53 shows the view that appears when the user selects the top half of the hexagon shown on FIG. 52 #1. These hexagons display data for whatever channel has been selected from the bottom half of the middle hexagon for the donor type or donor band that is written in the title.

### Artificial Intelligence—Focus on the Right Actions

### Problem

We live in the “Information Age” where human knowledge is estimated to double every thirteen months. Information needs in organizations have likewise increased as employees are asking more questions about their operations and are expecting answers in real-time. This explosion in knowledge is being exasperated by the fact that organizations have limited resources and are unable to pursue every possible action being unearthed by the data. Thus, the ability to properly consume, digest and interpret the data is pivotal.

Therefore, the question in the Information Age is not whether we have enough information to make intelligent decisions but whether or not we are able to filter out the noise and quickly identify the right issues to focus on in order to effectively mobilize limited organizational resources. In other words, having good intentions does not guarantee the organization is focused on the right things.

By not readily having the critical malfunctions at their fingertips, organizational resources are not currently able to quickly focus on actions that will improve financial and qualitative metrics, optimize operational effectiveness and mitigate risks.

In the current environment, organizational resources are plagued with the following challenges:
Computers have to calculate hundreds of metrics and run future simulations in order to determine the best course of action.
Arriving at wrong conclusions on which actions will produce the most favorable outcomes for the organization
Being forced to wear a Business Intelligence hat which most organizational staff are not trained in
Spending an inordinate amount of time to analyze disparate volumes of data
Not having enough bandwidth to be able to properly analyze all the metrics

Organizations have so many different things fighting for their attention. It is important to track many different metrics in different categories of data. This can lead to analysis paralysis, where they are stuck in a cycle of analyzing so many different things and do not have the mental capacity to focus on what to do about the findings. A major issue is also not knowing what to pay attention to. For instance, an organization can notice a metric is performing poorly and they devote a lot of time and resources to improving that metric. The metric is improved, but the organizations overall financial performance is not improved. This happened because the metric the organization chose to focus on did not have a clear correlation to financial performance.

### Solution

Our solution to this problem was to create a new user interface that utilizes an Artificial Intelligence to show the user the key areas they are performing the best in and the key areas they are performing the worst in. The model finds the KPIs that have the most impact on financial performance and only chooses from these for this view. The UI displays the KPIs that are positively and negatively affecting financial performance the most. The organization can quickly and clearly see exactly what they are doing that is improving performance by the greatest margin. This enables them to know exactly what they are doing that is working so they can keep doing it.

The organization also sees which KPIs negative performance are bringing down the financial performance the most. This enables them to focus on adjusting their strategy in relation to the these specific KPIs in order to bring up overall performance. Organizations have limited time and resources, so they are not able to effectively improve every KPI at all times. Through this UI they are able to pinpoint which KPIs that if they focus on improving will bring the financial performance up by the greatest margin.

Processes and methods in this application attempt to resolve the high friction between the plethora of operational data and the limited resource problem that plagues every organization. Instead of overwhelming executives with a ton of metrics or canned dashboard or table views, AI Imperatives does the heavy lifting by combing through hundreds of available metrics and Key Performance Indicators.

Clear the noise—Data Driven Decision Making is being increasingly exasperated by the sheer volume of operational data and metrics that are currently available. Because organizations have limited resources, they must focus on the select actions that will produce the most favorable outcomes for the organization. This can only be done by first having the knowledge of which strategies to continue (because they are improving performance the most) and which strategies to pivot (because they are negatively affecting performance the most).

Do what you do best—Employees no longer have to be trained in Business Intelligence and double up as business analysts in order to interpret the metrics. The invention spares users from time-consuming operations of having to digest and interpret all available data from disparate sources. With employees having the benefit of AI Imperatives, they can focus on operational tasks within their distinctive roles.

Look into the future—AI Imperatives is Prescriptive analytics that evaluates the past and looks into the future. By using Artificial Intelligence, it simulates the actions that could optimize operational performance the most. AI Imperatives provides value for anyone in the organization, whether it is a CEO looking at the entire organization, an operational new hire or anyone in between. The process sifts hundreds of quantitative and qualitative metrics and Key Performance Indicators from all available sources and based on current and predicted performance it determines what that particular department should do.

Focus on what matters—Using Artificial Intelligence, AI Imperatives provides a prescription of the top three critical malfunctions that are plaguing any part of the organization as well as the top three Critical Success Factors that are contributing to the biggest successes in the organization. By continuing to do what they are doing well (Critical Success Factors), and by hyper-focusing on the Critical Malfunctions, employees and executives are now able to maximize their impact by increasing their ROI, reducing operational costs and raising service quality.

Without this AI to lead the user, they can get lost trying to figure out what to focus on. This view prevents that scenario from happening by quickly teaching the user what is important to keep doing and what is important to fix. This way the user can spend the majority of their time on effective strategy because they know exactly what to keep doing and exactly what to adjust on.

### Artificial Intelligence—AI Imperatives

We have created an AI that tracks the performance of all of the KPIs that move the needle of organization performance the most and we show which three are performing the best in and which three are bringing down organization performance the most. Then if the organization can focus on maintaining the strategy for the best performing metrics and then experiment with new strategies for the worst performers then they can always focus on continual improvement. This shows the top three and bottom three performing metrics in order for the organization to know what to keep doing and what to adjust their strategy on.

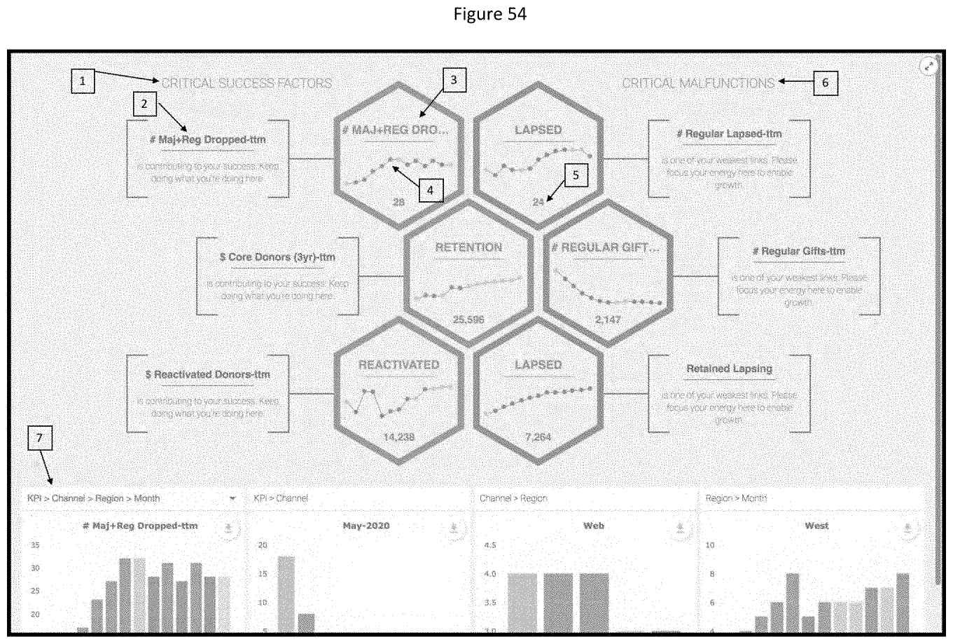

As can be seen in FIG. 54, there is a drill on the bottom of the screen. The user can choose any of the Hexagons on the page and the drill will update with that data. Then the user can click a specific bar in the first graph, and the rest of the drill will update accordingly for that data. These drill charts are meant to uncover more of the story for a metric. They segment the chosen metric into the different channels and regions associated with the organization, so if a metric is performing poorly the user can diagnose which channel or region is causing the decline.

The implementation uses advanced algorithms to easily navigate through the inundation of data (metrics and Key Performance Indicators). In order to prepare and process the data we remove unwanted values then scale and normalize the data. We utilize Deep Learning to predict the value for the next month and then minimize the mean square error in order to minimize the error between the predicted and actual values. We divide the dataset into training and testing datasets, then create a deep learning model, create multi-layered and back propagation models, and then fit and predict the data. We incorporate Seasonality, Auto-correlation and Partial Auto-correlation. We can either choose to use the actual or the predicted values to arrive at the top and bottom 3.

FIG. 54 contains the following elements:
1) This is the title of the section that displays the three best performing metrics.
2) This is the title of the metric displayed in the adjacent hexagon. The text below will give the definition and will have more information about why the metric is important.
3) This is the title of the metric shown in this hexagon.
4) There is a spark line showing the last thirteen values for the metrics on a trailing twelve-month value. This means that the Nov. 1, 2019 period is the cumulative value of that metric from Dec. 1, 2018-Nov. 1, 2019. The period name and value appear based on which specific period is being hovered over by a cursor from the computer device.
5) The value of the latest period is shown here.
6) This is the title of the section that displays the three worst performing metrics.
7) This is the drill that starts with whichever KPI is selected from any hexagon on the page. The user can click on any of the hexagons and the metric inside will appear in the drill down chart on the bottom. These style drill down charts appear in numerous pages throughout the dashboard. These are designed in a way to provide the user a way to quickly answer a large number of very important questions relating to specific metric performance. These drill down charts enable the user to find specific answers to their questions in a way not possible without this UI. The user is able to select which KPI will be drilled down by clicking the KPI title on any hexagon. Then that KPI's historical performance over a few years period is shown in the first chart. The user can then select any of the periods in the first chart and that period will be segmented into the different categories on the second chart. Then the user can select any of the bars from the second chart and that data is further segmented into the categories on the third chart.

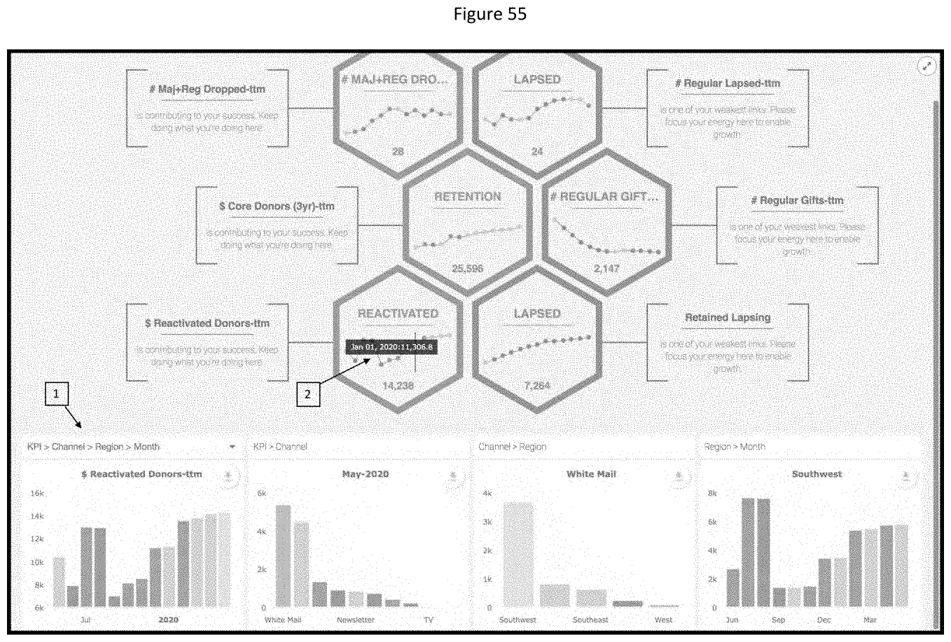

FIG. 55 shows at element 1) the title of the metric that is being drilled on is displayed here in the first drill chart. Any of the hexagons can be selected and the drill charts below will populate with the metric in that hexagon. At element 2), the period name and value appear based on which specific period is being hovered over by a cursor from the computer device.

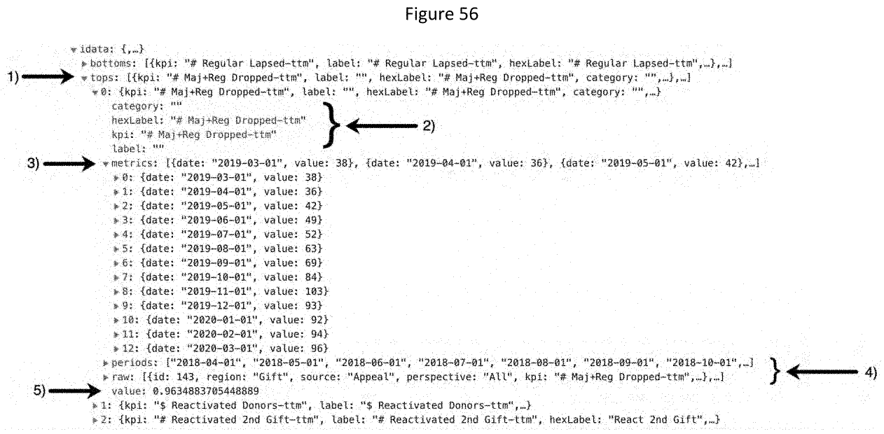

Improving the functioning on the computer (see FIG. 56)—The invention utilizes the following methods in order to rapidly accelerate the functioning of the computer:
Instead of importing hundreds of KPIs, we only import only six KPIs (Top 3 and Bottom 3) identified by CAGR value with all required data points (category, hexLabel, kpi, label, metrics, periods, raw, and value). We prepare data from PHP (Laravel) side (backend using API) by CAGR Value in order to derive metrics without taxing the frontend.
We are using static content to get the Hexagon description by category, hexLabel, KPI and label. Regarding hexagon title, description and category, we retrieve those when the website loads and store them as global variables.
Regarding metric values, we only prepare the last thirteen months of data instead of bringing in thousands of data sets. If we were to send all the data to the frontend, it would take a lot of time to compute on the browser requiring a lot of memory. This is why we prepare/compute in PHP (backend), so that we don't tax the frontend. On the frontend, we only need to compute color formatting by growth rate, which happens instantly for the six metrics.
We send the Periods/dates and raw data from the backend (API) to frontend as this data is required for the drill down charts. In order to ensure the data is lightweight and to get it quickly, we prepare and send the data without the keys (such as all available dates) in each data set. On the frontend, we prepare the data by array of periods/dates and compute color formatting for the drill down charts. Regarding drill down charts (FIG. 54 #7), we generate the output very quickly by using multiple processing threads to process the data.
We only display the latest hexagon value on the bottom of each hexagon. We prepare these values from PHP (backend), so we don't tax the frontend.

### Pulse Maps—Radio Station/Region Specific Channel and Donor Performance on a Map

### Problem

It is extremely beneficial for organizations with region specific marketing channels, such as radio stations, to be able to view those marketing channels performance data on a map. These marketing channels can represent a significant investment, and it is imperative to track the performance of each individual channel. Tracking performance of tens to hundreds of radio stations/channels across the country can be difficult. If the performance is not tracked, then organizations do not know how well their strategies are working. If they do not know that then they are operating in the dark and cannot be sure they are making any effective decisions.

Traditional Dashboards only show data on tables and charts, this is important but is leaving out more visual representations of the data on a map. Organizations can gain a limited understanding of performance from tables, but they lack a full understanding of performance that can be had from viewing data on a map. A map has the unique benefit of a visual display of where the marketing channels and donors are in addition to their performance.

### Solution

Our solution to this problem was to create new user interface that utilizes a map and smart tables which enable the vast amount of marketing channel and donor data to be displayed on the computer device in a way that the user can quickly and easily gain insights. We have incorporated three views that work together in unison to provide a complete understanding of station/channel performance that would be unable to achieve without this new UI.

The first view is a map that is filled with clusters of stations/region specific channels and donors for the organization. This enables the organization to spot performance trends by region that would be very difficult if the user was only viewing the data in a table format. The organization can now visually see how their stations/channels are performing: which are losing or gaining donors, improving gift sizes, and ultimately operating at a gain or loss. Because the organization can locate where all of their donors are, they can more effectively plan where new marketing activities should happen. For instance, organizations can pinpoint the best locations for a new radio station or where a major donor event should happen. This kind of planning is not possible without a map.

One of the key improvements of this UI is when the user hovers over a radio station icon a quick snapshot of performance is shown in a table form. This shows the values and variances over the past 4 periods for income, costs, net income, roi, # donors, # new donors, # reactivated donors, # lapsed donors, and influx to lapsed. This is a lot of information that is very important because it speaks to how well the stations are performing. This information is available for every station icon on the map. The user is able to hover from one station to the next and quickly diagnose how each station is doing. Without this UI the user would have to load multiple pages and move back and forth to get this same information.

The second view is the Station Summary view, which is accessible by clicking a table icon on the top left of the map screen. This view enables the user to see key information for every station on one page. Without this UI the user would have to load multiple pages and move back and forth to get this same information. Because all of the information is on one page the user can quickly compare the performance of the different stations to see which strategies are working and which need to be adjusted. The data is in a smart table where the period being viewed can be changed. The user has the option to view this period vs the last period or this period vs the same period a year prior.

The third view is the Station Detail view, which is accessible either from the detail button shown when hovering over a station on the map and also from clicking a specific station row from the station summary. This view reports in detail for the specific station chosen. It Is important to have the station summary so the user can quickly see the overview of performance for all stations on one page, and it is also important to have this detail view for when the user want to hone in on more detailed data for a specific station. This detail view incorporates UI improvements that allow the user to quickly see monthly, quarterly, and yearly performance. There is a toggle option to view periods that follow one another (June 2020, July 2020, August 2020) or one period compared to years prior (June 2018, June 2019, June 2020). This toggling feature enables a lot of data to be available on one page that would not be possible without this UI.

### Pulse Maps—Pulse Maps

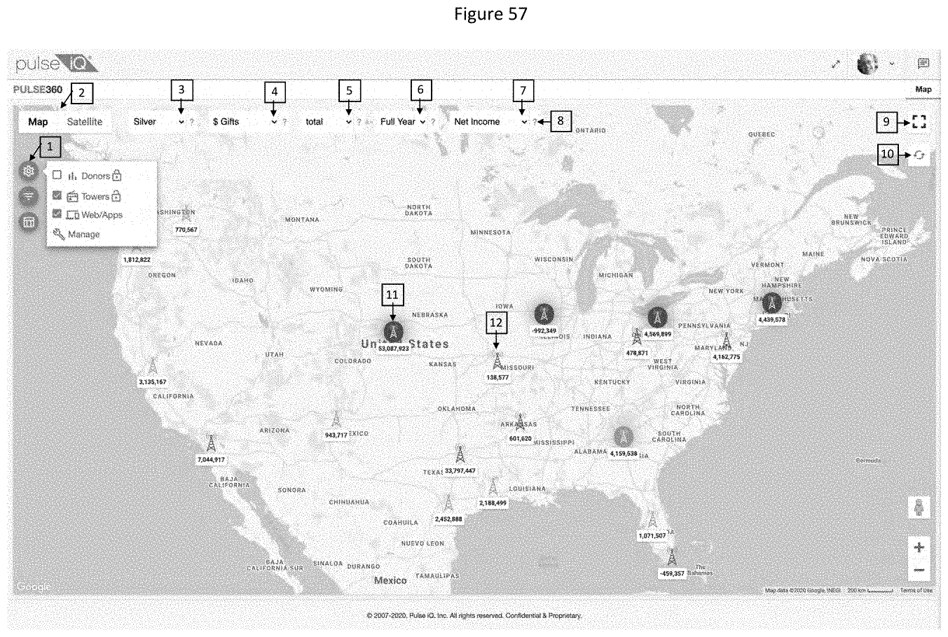

FIG. 57 shows the pulse map described above.

This Figure has the following elements:
1) When this icon is clicked the popup to the right appears. This enables the user to control what is shown on the map. Donors are represented by a bar chart icon and will show all of the organizations donors in clusters where they are located. The numbers below the bar charts are the value of the metric selected from the toggle on number 4. Towers shows either clusters or individual radio stations. A cluster is shown with a circle background, while an individual station is shown without a background. The user can zoom in using the controls on the bottom right corner in order to separate the cluster into the respective individual stations. Web/Apps are represented by a phone icon and shows the locations where specific web/app marketing channels have been accessed by donors. The number below each station or web/app icon on the chart is the value of the metric selected from the toggle on number 7. Clicking the lock will turn summary popups on the map on or off. Clicking on the Manage button will allow users to upload various data points directly to the map (or even download those), including costs, station logos, station geographical reach, etc.
2) This controls whether the background of the map is colored or a satellite image.
3) This controls the color of the map if Map is selected from number 2.
4) This controls what metric value is shown below the donor bar chart icons.
5) This controls the value type below the donor bar charts. Locations are the number of individual donors are combined into a single cluster. Total is the sum total of the visible years. Current is the most recent period. Prior is the prior period.
6) This controls whether the full year or year to date values are shown on the chart.
7) This controls which metrics are shown for the towers or web/apps.
8) Each toggle has a ? Icon which will give instruction on what the toggle is used for. The help box will show when the ? Is hovered over.
9) This icon brings the view to full screen.
10) This will refresh the values on the map when any of the toggle menus are changed.
11) This icon with the circle background represents a cluster of stations.
12) This icon with no background represents a single station.

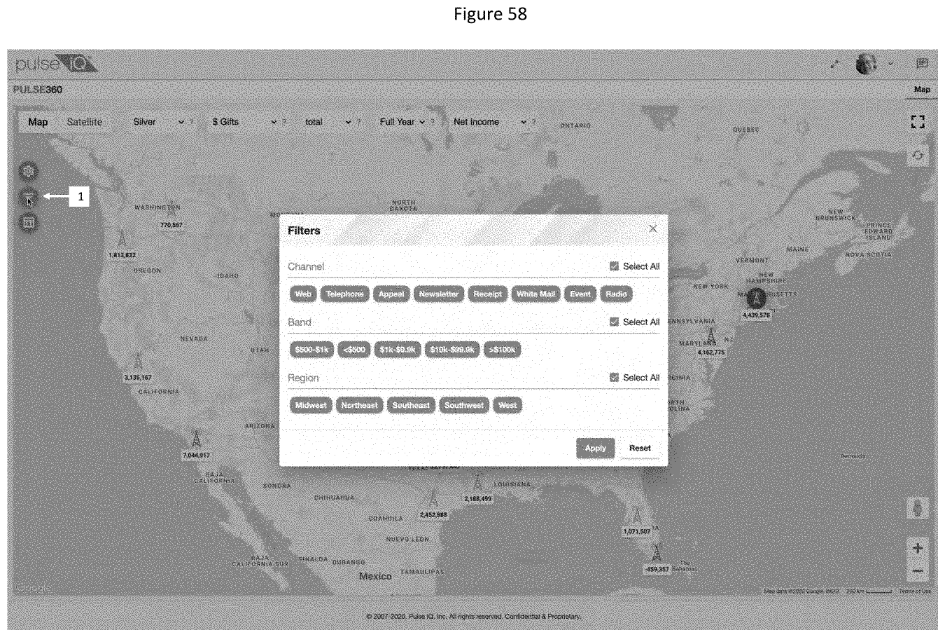

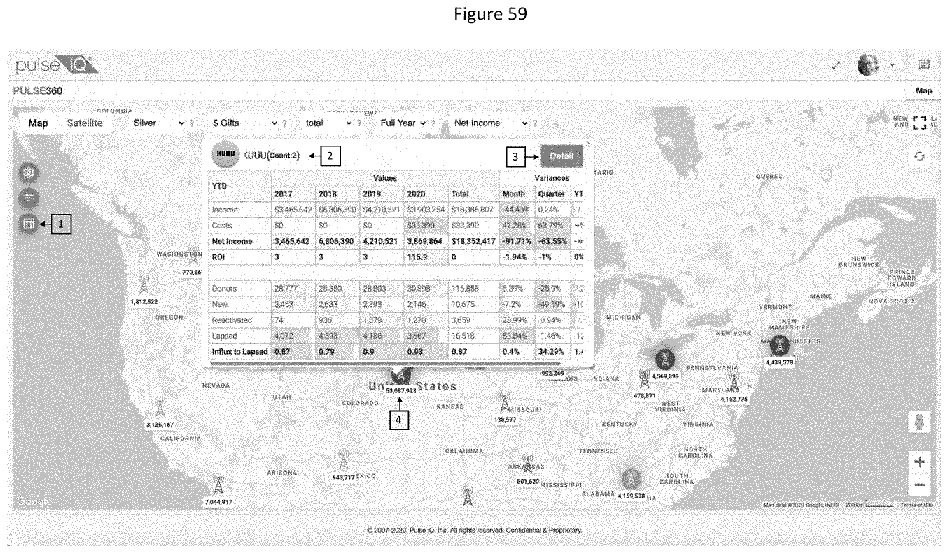

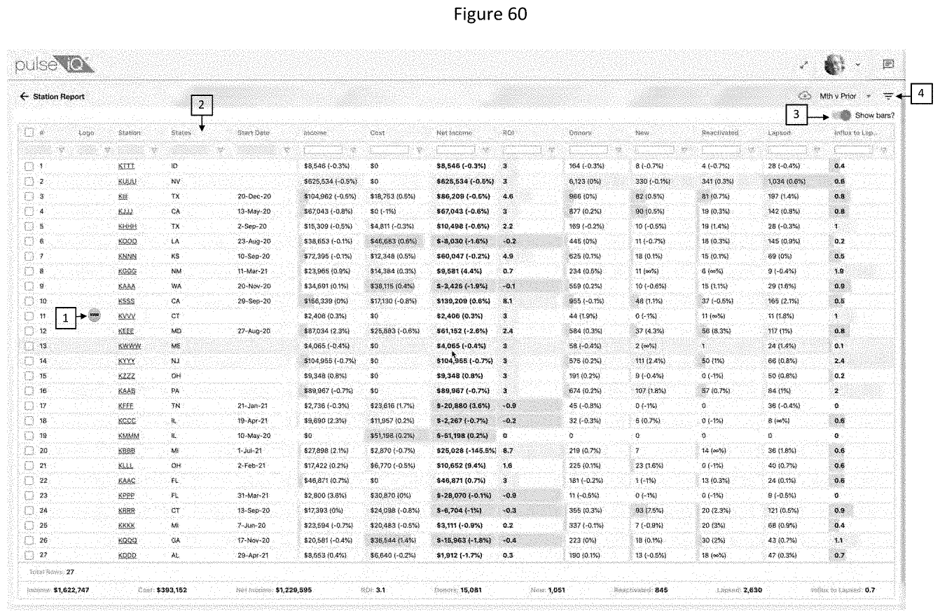

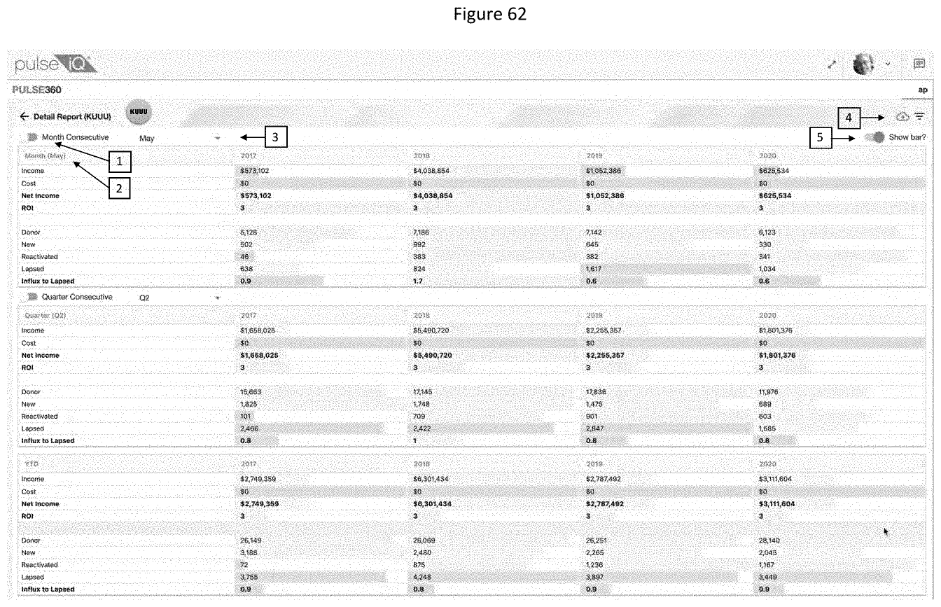

FIG. 58 has element 1), which triggers the filter menu that appears when the filter icon is selected here on the left. This menu enables the user to filter all the data shown on the screen by as many or as few of the options shown. FIG. 59 has the following elements:
1) This table icon will take the user to the Station Summary view shown on this FIG. 60.
2) This title says (count:2) because the data shown is pulled from a cluster of two stations. The user is also made aware of this because the icon that was hovered on for the popup to appear has a circle background denoting a cluster.
3) This detail button will take the user to the Station Detail view shown on FIG. 62 for the data displayed in this popup. Since this is for a cluster then the Station Detail data will have each station from the cluster combined into one value for each row of data.
4) This is the icon that was hovered over to bring the popup to the screen.

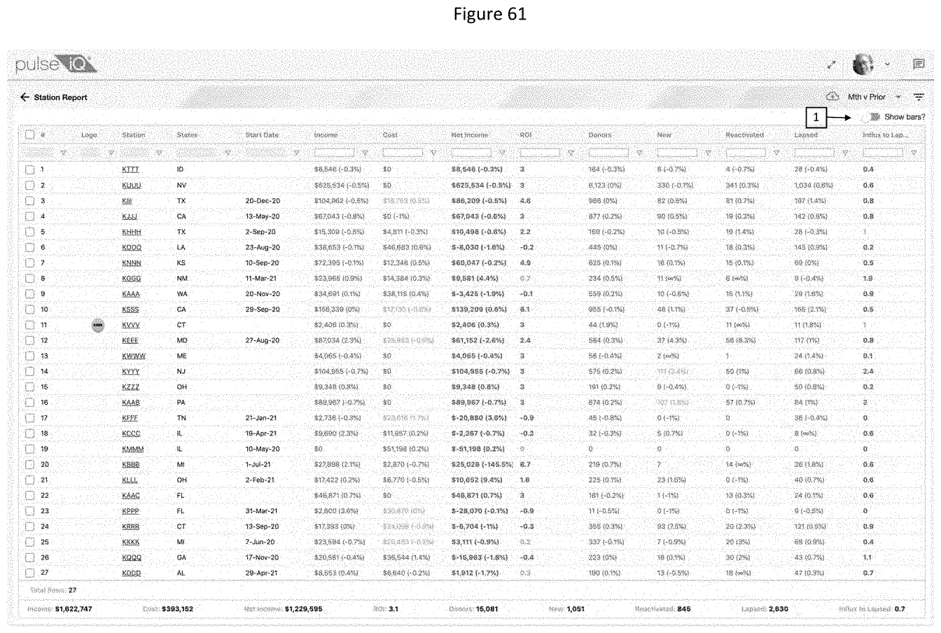

FIG. 60 is the station summary report. This Figure contains the following elements:
1) Any of these station names can be selected to bring the user to the Station Detail View for that specific station. This Station Detail view is shown on FIG. 62.
2) This is a smart table. Any column can be filtered for values, and the whole table can be sorted by clicking on any column.
3) This toggle controls the time period for the values shown in the table. There are options to view specific periods such as months or quarters compared the previous period, or to view a period compared to that same period from a year ago.
4) This filter icon controls what data is shown on the page. The same filter menu is shown on FIG. 58.
   In FIG. 61, at element 1), the bar toggle is unchecked so the numbers are conditional formatted red, yellow or green depending on performance.

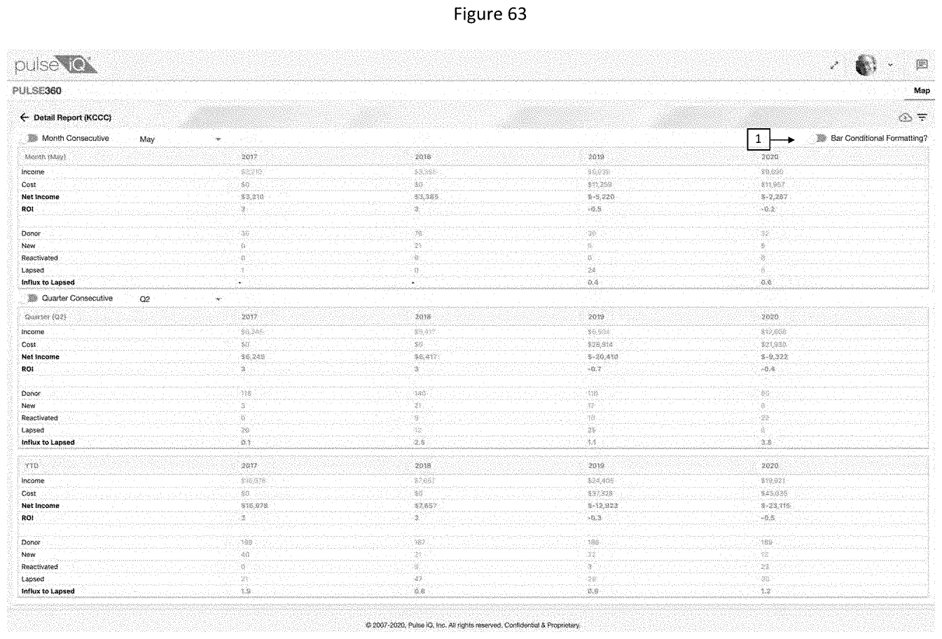

FIG. 62 is the Station Detail view, and it shows the following elements:
1) This toggle controls the time period shown in the table below. As it is now the table shows the June period from 2017, 2018, and 2019. If the toggle was selected the table would show the past 13 monthly periods in a row. The quarterly table work the same below, except if the quarter consecutive toggle is selected the table show the past 5 quarters.
2) This title shows which period has been selected to view.
3) This toggle controls which specific month has been selected for the table.
4) The filter icon brings up the filter menu to control any filters the data is put through. The menu is shown on FIG. 58. The cloud enables users to download the report as a csv.
5) This toggle controls whether or not to show the conditional formatting bars on the chart. FIG. 63 shows the page updated after the toggle is clicked.
   FIG. 63 contains element 1), which shows the Station Detail view with the Conditional Formatting Bars unchecked. The text color of the values are conditional formatted (Red, Yellow, Green) in this view instead.

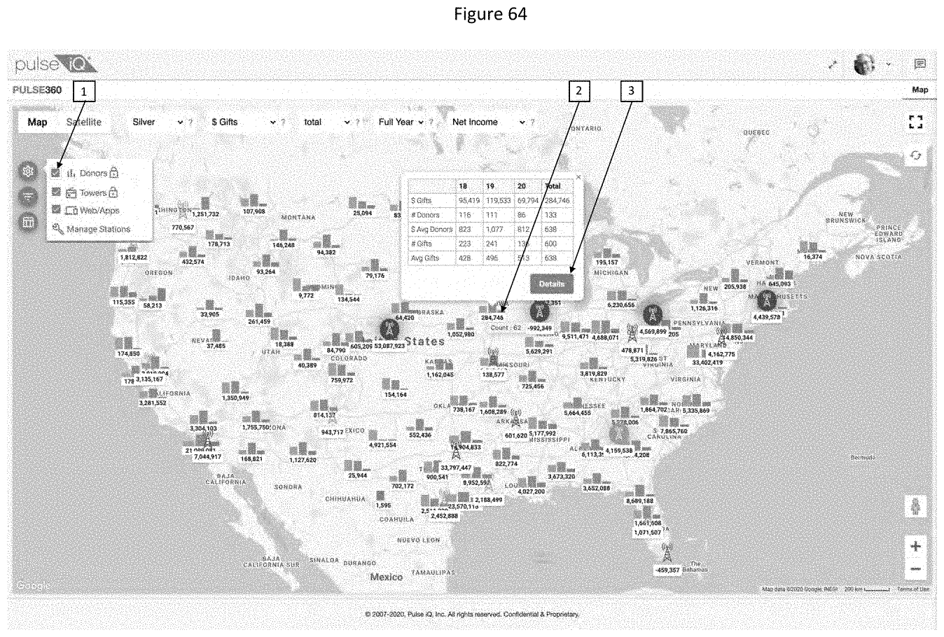

In FIG. 64, the view has the Donors enabled from the settings menu. Consequently, bar charts will appear on the map aggregating geographical clusters. This Figure contains these elements:
1) Users can enable viewing of constituents on the map by checking donors here.
2) The bar charts aggregate donor data in a given geographic cluster. Hovering over a certain cluster of donors will show a popup with certain metrics over a certain number of years. The total is also displayed for each of these metrics. Each bar in the chart represents a distinct year.
3) By clicking on the Details, users are able to view the individual constituents in that cluster.

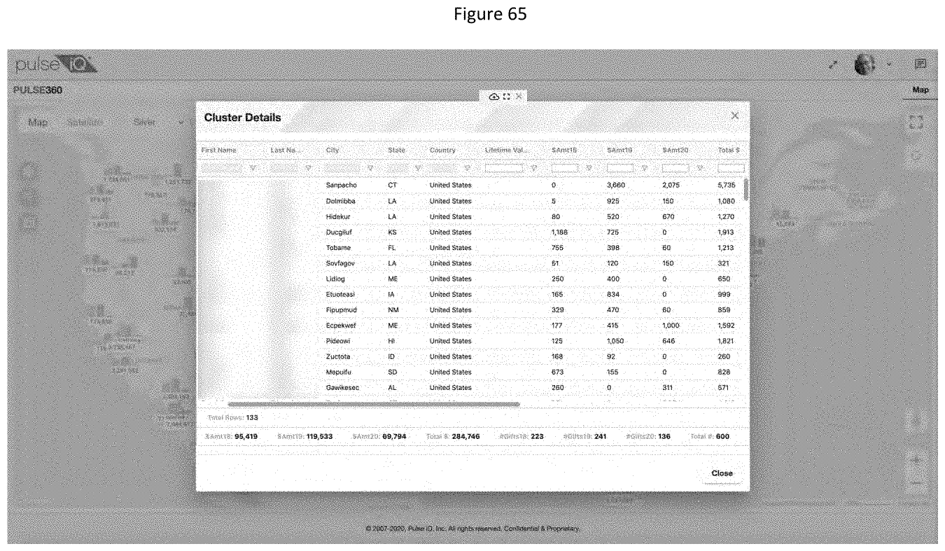

By clicking on the Details button in FIG. 64, users will be able to see the featured table in FIG. 65. This table presents detailed historical data regarding all constituents in a given cluster. This is a dynamic and responsive table featuring smart filters (greater than, less, than, search by name, etc.), sort capability, move columns around, delete columns, resize columns, or even download the table with filtered data or all data.

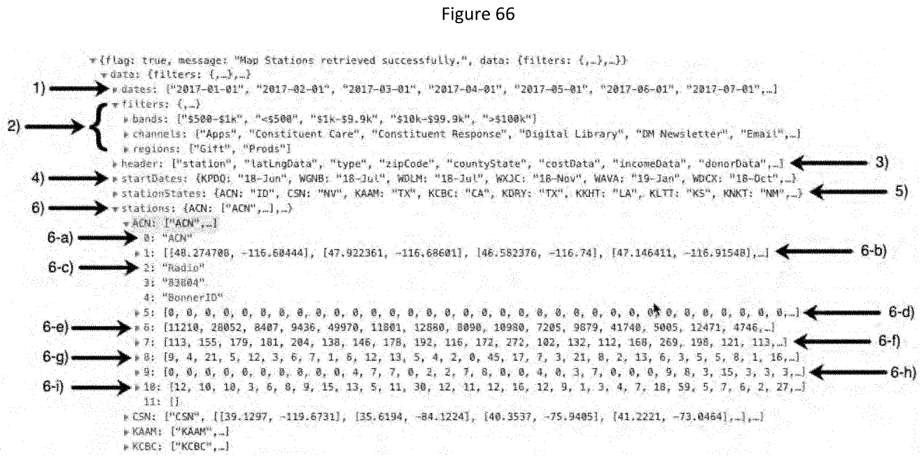

Google Map Station Data is retrieved via an API, as shown in FIG. 66. The invention removes keys from the datasets. After removing keys from station's data, we identify the data by user header values. Also, in order to reduce the API calls and to speed up the computer, we make a single API call to fetch all the data with filter options for Towers, Popover, Summary Table and Detail Table. This creative approach negates the need to make a call to the database for every task.

FIG. 66 shows the following elements:
1) Dates: The invention sends the dates from the Backend (API) to the Frontend as dates are required in order to display values in Tower/Stations as well as Popover Modal, Summary Table and Detail Table. We display the current month, prior year month's data for every Tower from the data array.
2) Filters: We then filter the values on the Frontend in the filter Modal (popups).
3) Header: While preparing the data on the Frontend, we identify need header for index (on frontend side we can identify values title (key)
4) startDates: are the dates when a station was initiated. This date gets displayed on the Summary Table.
5) stationStates: These are the States where stations are located. This data gets displayed on the Summary Table.
6) Stations: This is the combination of the data sets by station. We use these data sets to display Towers and associated the following values:
a. This is the Station's Name/Title. We display the Station name in Popover, Summary Table and in Detail Table.
b. These are the latitude and longitude data sets for a given station. We use the latitude and longitude to locate the center point of a polygon to position each Station Tower.
c. This is the type of data set. We are able to display several data types including ‘Radio’, ‘Web/Apps’ and individual “Customers/Donors”, etc.
d. This is the Costs data set being used in the Frontend. The invention removes the key values from the API response data in order to improve the computer response time. In order to prepare the data on the Frontend, we use dates array as a key value. We are then able to prepare Tower, Popover Modal, Summary Table and Detail table data from a single API call.
e. This is the Income data set being used in the Frontend. The invention removes the key values from the API response data in order to improve the computer response time. In order to prepare the data on the Frontend, we use dates array as a key value. We are then able to prepare Tower, Popover Modal, Summary Table and Detail table data from a single API call.
f. This is the Unique Donors data set being used in the Frontend. The invention removes the key values from the API response data in order to improve the computer response time. In order to prepare the data on the Frontend, we use dates array as a key value. We are then able to prepare Tower, Popover Modal, Summary Table and Detail table data from a single API call.
g. This is the New Donors data set being used in the Frontend. The invention removes the key values from the API response data in order to improve the computer response time. In order to prepare the data on the Frontend, we use dates array as a key value. We are then able to prepare Tower, Popover Modal, Summary Table and Detail table data from a single API call.
h. This is the Reactivated Donors data set being used in the Frontend. The invention removes the key values from the API response data in order to improve the computer response time. In order to prepare the data on the Frontend, we use dates array as a key value. We are then able to prepare Tower, Popover Modal, Summary Table and Detail table data from a single API call.
i. This is the Lapsed Donors data set being used in the Frontend. The invention removes the key values from the API response data in order to improve the computer response time. In order to prepare the data on the Frontend, we use dates array as a key value. We are then able to prepare Tower, Popover Modal, Summary Table and Detail table data from a single API call.
j. This invention sends the dates and raw data from the Backend (via API) to the Frontend, which are required for the Stations/Towers, Popover Modal, and Summary Table and Detail Table. In order to ensure the data is lightweight and to get it quickly, we prepare and send the data without the keys (such as all available dates) in each data set. On the frontend, we prepare the data by array of dates and compute color formatting for all Towers, Popover Modal, Summary Table and Detail Table. In order to generate the output quickly and efficiently without taxing the computer's resources, we use multiple processing threads in order to process Conditional Formatting (Red, Yellow, or Green) and Station/Tower data.

### Artificial Intelligence UI—Improved UI to Easily Increase Income and Achieve Strategic Objectives

### Problem:

Organizations who invest in marketing activities in order to increase sales or donations need to have an effective segmentation method to choose the right people/constituents to target. For most organizations, it would not make financial sense to market to every name in their database every time as that would be very costly and inefficient. For each marketing activity, organizations have to decide who they will spend money on marketing towards and who they will not. The issue lies in the segmentation model that most organizations use. This RFM segmentation model (based on recency, frequency, and monetary value of spending or giving) was created in the twentieth century has these flaws:
Loses customers/donors by targeting them too often.
Misses out on hidden gem donors because the segmentation only uses three variables and is not able to find donors with a high likelihood of giving. Also, RFM models do not evaluate the entire database while mailing but only cap the date to a certain number of months back (such as 24, 36, 48 months, etc.), therefore the model leaves out many high value clients or donors that have a high likelihood of responding.
Lowers ROI by targeting donors with an extremely low likelihood of responding or giving very much.
Reduces Net Income due to a combination of the above factors.

### Solution

We created an Artificial Intelligence model to choose the best donors to target in marketing campaigns. The AI model ranks all the donors by their predicted ROI and the list would be chosen manually from a spreadsheet based on an estimated breakeven cost. Since then, we have improved the model by incorporating the strategy lanes in order to create an improved User Interface which the user interacts with to create their marketing list from the model. The invention we are focusing on is the improvement in order to create a better UI. This new UI enables the user to harness the power of an AI model quicker, easier, and with more customization. The outcome of using this new UI is better marketing results (higher Net Income and greater donor file health) that are easier to come by than was ever possible by using an AI model without this UI.

Model—An Artificial Intelligence model that utilizes Statistics, Deep Learning, and Machine Learning through a holistic marketing framework that finds the best donors to optimizing marketing results. By focusing on five distinct strategies the model is able to improve long term donor file health as well as optimize net income. Optimizing donor health is a key differentiator as most other organizations prioritize short term income whether they are aware of that fact or not.

Strategy Lanes—It is short sighted for organizations to only go after the highest net income in marketing campaigns. Successful organizations focus on donor file optimization as well as maintaining high Net Income. In order to create long term donor file optimization an organization must nurture specific types of donors. We have narrowed all donors into these five groups in our strategy lanes. Here are the five groups:

Acquisition—how well are you doing acquiring donors? This lane targets non-donors, and then reports performance on those that become new donors by giving their first gift.

Reactivation—how well are you doing reactivating lapsed donors? This lane targets lapsed donors, and then reports performance on those that become reactivated donors by giving again.

Conversion—how well are you doing with getting the donors you bring in to give a second gift? This lane targets all the single gift donors who were initially brought into the active file either by becoming a new or reactivated donor, and then reports performance on those donors who were converted to give a second gift.

Retention—how well are you doing keeping your donors active? This lane targets lapsing donors (donors who last gave 7 to 12 months ago), and reports performance on how successful the organization is on preventing those donors from becoming lapsed (donors who last gave 13 to 24 months ago).

Cultivation—how well are you doing with key donor segments, major and regular? This lane targets active donors who last gave 0-6 months ago and were not included in the other lanes and reports on their performance.

Each lane has a specific goal, such as convince a non-donor to give for the first time or convince a new donor to give again. Each of these goals can be viewed as a stepping stone to eventually move that donor into the cultivation lane. The donors in the cultivation lane provide organizations with the majority of its income derived from marketing campaigns. Not every donor will move all the way into the cultivation lane and donors who have made it will not stay there forever. That is why it is so important to maintain a pipeline of donors moving through each group, and then nurture the donors who eventually make it. A lot of organizations focus heavily on the donors that are included in our cultivation lane (because they are currently providing most of the Income), but do not spend enough attention nurturing donors who could eventually become major and regular donors included in the cultivation lane. These organizations are unknowingly prioritizing short term net income over donor file optimization that will provide even greater net income in the long term. Because we break down the entire donor file into these five key groups, the organization can ensure they are performing well in each area which is the only path to marketing optimization.

UI—this is the embodiment of the model in which the user can utilize the model very quickly and easily to choose their marketing lists that will result in the most optimal outcome. This UI gives the user the ability to tap into the power of the AI in ways not possible before.

The initial invention did not include a UI. The model would run and then the list was chosen from a spreadsheet and then provided to the client. The client would have no visibility into how the list was created, they only received the final list. This new UI provides the user with the ability to create as many lists whenever they want, and it provides much more control to customize lists for specific objectives very rapidly.

The UI effectively illustrates that there are different types of donors and that it is important to keep track of all of them. The top of the screen shows the five groups and the donors whom are being measured in each. The Income Genome is below each strategy and it tracks the past 13 months of performance for the number of donors, avg frequency of gifts, and the avg gift amount for the donors included in each lane. This gives the user an immediate understanding of how well each lane is performing. The user then will know which areas their strategies are working and can stay the same and in which areas the strategies need to be pivoted.

The next row down shows the wizard, this is where the list of donors to target in the marketing campaign is chosen. The AI has already ranked the donors in each lane from best to worst and shows conditional formatting for how deep into the available donors to choose. The UI gives important information such as total number available, the amount chosen, and after the user inputs the marketing cost per person the UI displays total marketing cost for the amount chosen, as well as the estimated net income and ROI. There is a recommended amount to mail in each lane that is preselected, however the user has the ability to adjust each lane for a desired amount. The performance data shown above, the estimated cost, net income, and ROI all work together to provide the user with the ability to make well informed decisions.

This UI greatly improves the users experience by providing the ability to quickly and easily make the best possible list of donors to target. The UI would not have been possible without first coming up with a framework that groups the entire donor file into the five most important comprehensive groups. Because of the framework, the user is able to process more important information faster about their donor file.

### Benefits:

Lessen Donor Fatigue—The Pulse Predictive AI approach does not cause client/donor fatigue as it will only target customers/donors who are predicted to purchase or donate for a given campaign. In order to do so, the model utilizes seasonality to predict donor behavior.

Find hidden gems—Traditional segmentation approaches leave many high value and high probability donors out of the campaigns. This invention however uncovers hidden gems who are predicted being dropped by traditional segmentation modes but who are predicted to purchase or donate.

Increase ROI—This invention will optimize and fine-tune ROI by pursuing all constituents who are predicted to act and not pursuing those who are not predicted to act.

Increase Net Income—Employing the Artificial Intelligence in this invention will vastly increase Net Income due to savings from not going after the wrong constituents, while also targeting hidden gems who are typically ignored by Traditional segmentation models. This targeted approach will save clients tens to hundreds of thousands every year, while also increasing income from the hidden gems.

Upgrade the health of the constituent file by nurturing the right constituents. This invention will literally turn bleeding metrics green very quickly as it strategically targets constituents in each of the strategy lanes that have the highest likelihood of responding.

Improved process—Using an AI model though this new UI creates a more efficient process in which the user can create a customized and optimized list that will provide better results and is faster than using a model without this UI.

Plan your marketing activity—The AI model enables organizations to plan their mailings a year or so in advance for budgeting and planning purposes.

### Artificial Intelligence UI—Pulse Predictive UI—First Approach

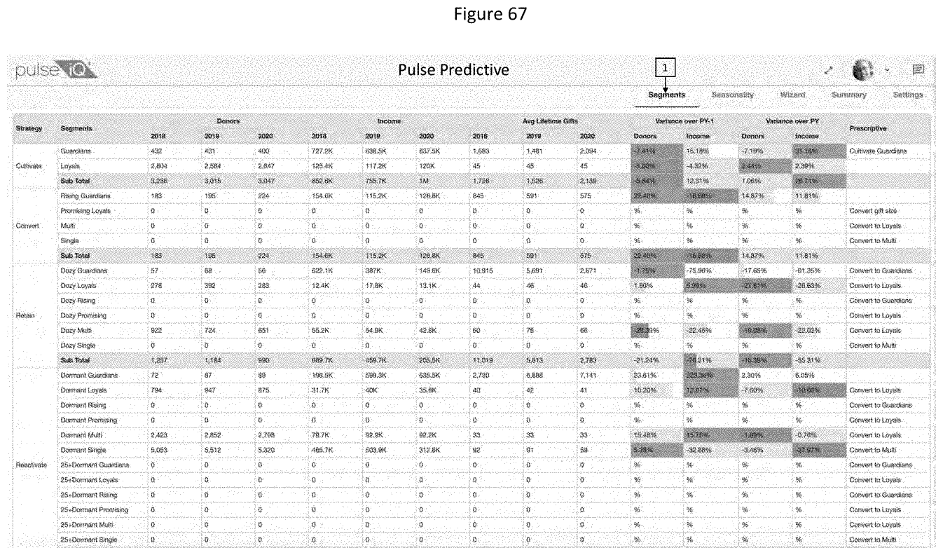

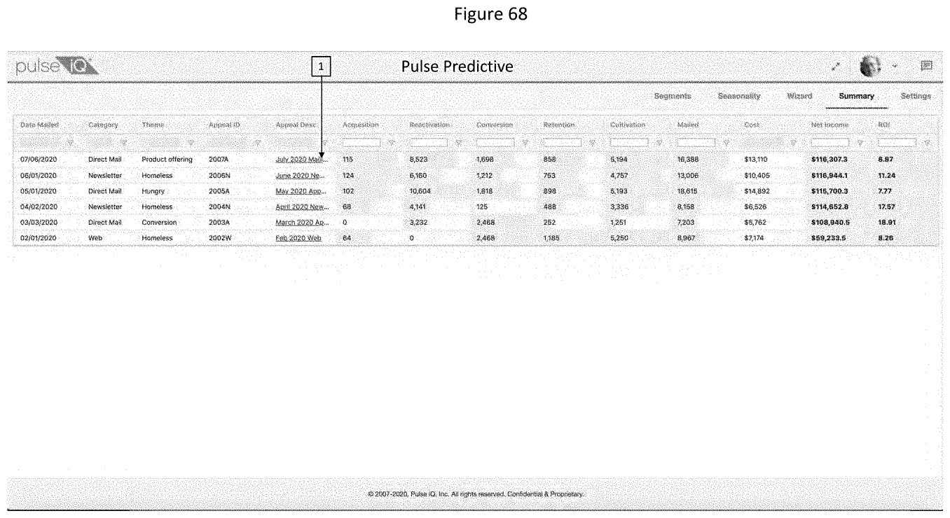

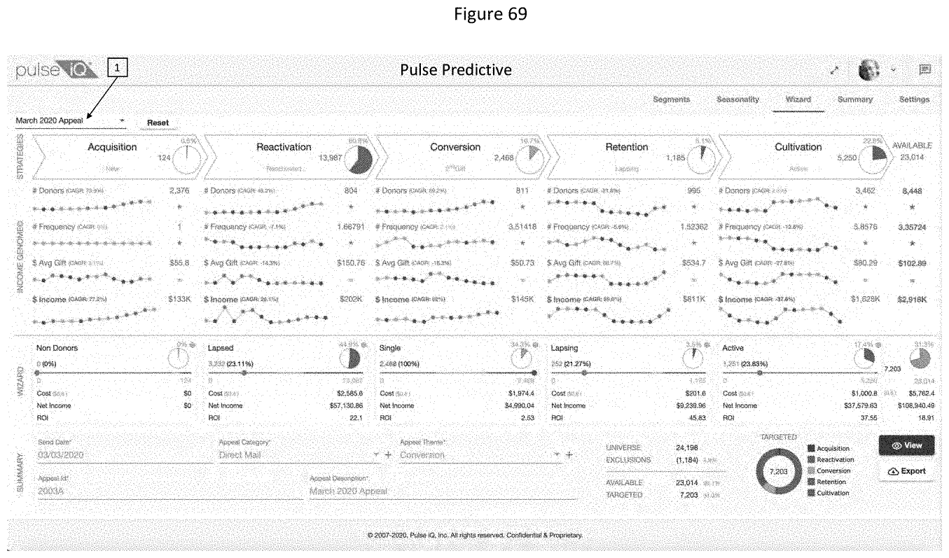

This discussion relates to FIGS. 67, 68, 69, and 70.

Only used Deep Learning and Statistical Algorithms—We initially only used Deep Learning and Statistical Algorithm models but did not use a Machine Learning model to evaluate constituents.

Lack of file optimization by strategy—We were previously selecting donors in order to optimize the file as a whole, but without any regard to optimizing the file by strategy.

Lack of visibility into strategic constituent cohorts—We had no visibility into strategic metrics or constituent cohorts such as Lapsed or Lapsing Core Constituents (Core constituents are ones who gave/purchased for the last two years in a row). As a result, we were unable to target and improve them.

Manual mail house processes—We had to manually prepare and export the required constituent fields for the mail house as we were preparing the file in Excel.

Manual data transformation for reporting—The selected campaign cohort had to be manually transformed and made ready for campaign reporting, and then manually uploaded for reporting.

Inability to improve Income Genome—We lacked both the visibility and ability to strategically improve income by targeting the weakest links in the Income Genome.

Process Inefficiencies—Client never had access to Predictive as were running Predictive for them. The client could not see or modify the process/software that Predictive ran on. The only access the client had was the final list that we prepared manually from a spreadsheet and then provided it to them.

Code errors and inefficiencies—Predictive code was not clean and used to produce errors and inconsistencies. The Predictive tool was not well structured. The codebase was very messy and difficult to understand, so it was very difficult to maintain it and add/update new features.

Time inefficiencies—It previously took all day to prepare the list since it was done manually.

### Artificial Intelligence UI—Pulse Predictive UI—Latest Approach

Added a Machine Learning model to the mix—Initially, we only used Deep Learning and Statistical Algorithm models, but we now added a Machine Learning model in order to find every additional edge we can while optimizing the results. Each of these models brings in a distinct strength to the mix—By leveraging each models strength, we are able to improve the constituent file fundamentals (improving reporting metrics) thereby creating future sustainability, while also bringing in the highest possible Net Income. This is a tight rope walk between the highest Net Income and the continuous investment in future high probability donors or customers. Both are important as one is needed for today's sustainability and the other for tomorrow's sustainability in order to ensure the file is building a pipeline of future donors or customers.

Ability to proactively and strategically optimize each strategy—We are now able to optimize each strategy independently. Predictive will now hone in on the weakest link in Income Genome and target it with laser precision in order to minimize the risk and optimize Return on Investment. Constituent selection is now done at the strategy level via a slider that clearly distinguishes the demarcation line between constituents who will provide a negative ROI (red), a yellow ROI (between negative and positive) and a positive ROI (green). Furthermore, users are able to see the estimated financial impact of adding more or less constituents per lane. Net Income and ROI will change in real time per strategy lane as the slider is moved to the left (positive section), or to the right (negative section). Therefore, the more the slider is pushed into the negative territory, the more the predicted net income and ROI will decrease. Thus, clients are able to invest in growing their file with both eyes opened regarding the financial impact in terms of Costs, Income, Net Income, and ROI.

Total visibility and proactive management of strategic constituent cohorts—Predictive is now directly linked with the Pulse Analytics (our reporting package) reports and is able to programmatically target strategic constituent cohorts who may be currently deteriorating or are projected to do so in the future. If certain metrics such as Lapsed or Lapsing Core Constituents (Core constituents are ones who gave/purchased for the last two years in a row) are dropping or are forecasted to do so, then Predictive will target and improve them. We created a direct and automated feedback loop from the reporting so that Predictive is not an island but is pro-actively focused on keeping all the metrics green in Pulse Analytics. Predictive will not only target donors who will bring in the highest return but will also optimize important donor metrics.

Fully automated and instant mail house data files—Once the Predictive file is prepared, the mail or action file is instantly available for download without the need for any manual intervention. By clicking on the Export button, users will have the file to send to the mail house or to the web marketing team. In addition, mail houses and web marketing teams are able to download the constituent file directly from Pulse Predictive. Consequently, human and server resources are freed to work on more important tasks.

Fully automated data transformation and seamless reporting integration—Pulse Predictive is now fully integrated with Pulse Analytics (reporting package). Therefore, marketing campaign files no longer require manual transformation and upload into Pulse. As a result, human and server resources are freed to work on more important tasks.

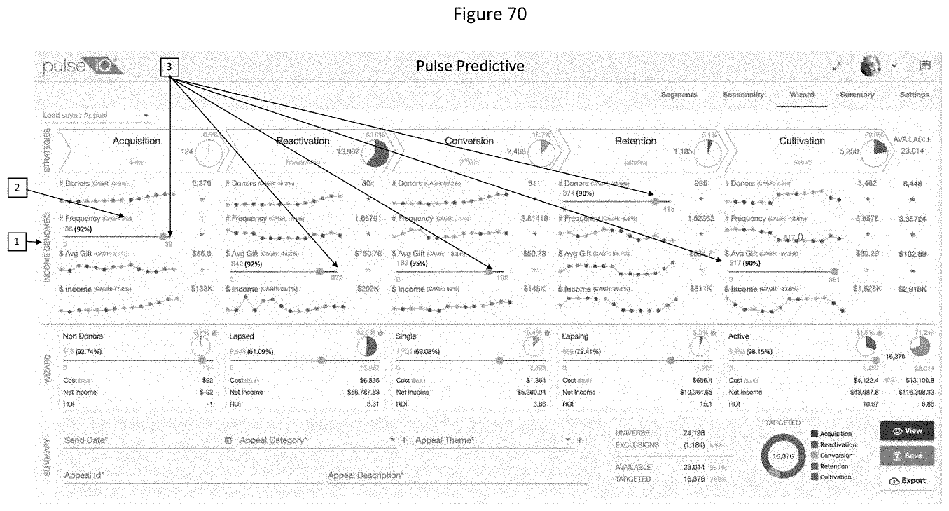

Remove the drag on performance—Income Genome® (see FIG. 70 #1) is our proprietary algorithm which identifies the levers of income. The algorithm is as follows:

# Constituents*# Frequency*$ Average Transaction=$ Income 7,131*3.50906*$58.62=$1,466,854

### Where:

# Constituents are unique constituents who gave or will give in a certain time period
# Frequency is how many times a constituent will give/purchase on average during a certain time period
$ Average Transaction is the $ average amount per transaction. The Income Genome part of the UI identifies exactly how income was derived. The reason this is important to know is that once we find what is the weakest link in the chain (the part that shows the slowest growth), then Predictive is able to strategically target cohorts that will remove the drag on performance. Each of the levers in Income Genome has an associated CAGR (Compounded Annual Growth Rate), and Predictive will find the weakest link in each lane and identify the donor cohort who have the most probability to removes that drag. By doing so, income in that strategy lane will naturally increase. Thus, predictive is scientifically—not passively or using a shotgun approach—improving income by programmatically discovering and optimizing the weakest link in each strategy lane. FIG. 70 #3 shows how Predictive will automatically replace the microcharts with sliders for the Income Genome lever which is showing the weakest link in each lane. The levers represent constituents who have the highest likelihood to increase that metric for that strategy. Predictive will choose the percentage to mail in that cohort. Constituents who are selected in that lever will be automatically added to the selected constituents in the Wizard section. Those constituents cannot be removed by moving the sliders in the Wizard section. By clicking on the CAGR (see FIG. 70 #2), users are able to revert to showing the microchart. Users are able to click on any CAGR for the other Income Genome levers in order to show the sliders. However, it is not recommended for them to change the other levers as that would impact the results of Predictive. In a marathon, it is not the last step that wins the race, but all the steps combined that led to the last step. Similarly, by optimizing every possible lever at its disposal, Predictive gains every possible edge to help optimize results.

Process efficiencies—Users are now able to run Predictive in a few seconds. In fact, the marketing segmentation file is already optimized by Predictive with an eye on current financial results and future growth and sustainability. However, users are able to make some decisions regarding whether to mail/reach deeper or less deep simply by moving the sliders in each strategy lane. Sliders are already defaulted by Predictive but users have the option to change them if they want to and they can see the estimated financial impact of their decisions on the spot. When ready they can simply save the file by clicking on the save button.

Time efficiencies—It used to take us a day to run Predictive for a client as we had to go through many steps manually in order to cover all the bases. However, the new UI automated all those manual functions. Clients are programmed to run on a job (timer), so the process is no longer kicked off manually. Furthermore, once a client is run, there is no need for any manual intervention in Excel spreadsheets. Clients are not required to make any changes, but they are certainly welcome to move the sliders if they wish in order to reach more or less constituents by lane. The time efficiencies gained for both Pulse IQ and the clients are tremendous as Predictive is instantly available for clients.

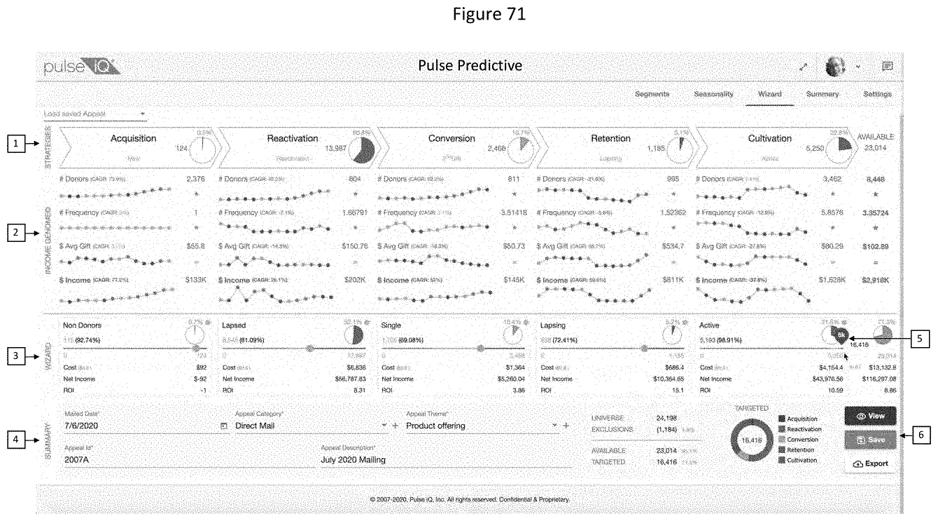

FIG. 71 shows an interface used with Predictive. This invention uses a combination of Machine Intelligence and the Strategy Lanes Framework to optimize results based on both financial and strategic results. FIG. 71 contains the following elements:
1) Strategies—This section deals with augmenting the Machine Learning with a marketing framework. This process provides transparency into the strategy lanes as well as actionable information to be able to tangibly achieve corporate strategic objectives such as improving donor conversion results. Therefore, instead of looking at the constituent file as a whole, the file is segmented into these five strategy lanes whereby the performance of each lane is fully transparent and ready for action. Each of the five lanes has a pie chart depicting the overall percentage of the entire marketable file. The overall number of constituents is summarized at the far right. Marketable constituents exclude constituents who cannot be targeted for various reasons including a request to do so from said constituents.
2) Income Genome®—This section shows the Income Genome components for each of the five Strategy Lanes. The Income Genome utilizes a blueprint of how income is derived, whereby Income=# Constituents*Frequency*$ Avg Transaction. This is a very helpful concept as it gives us visibility into the weakest link in this equation which might be causing a degradation in income. The machine will programmatically target the weakest links in order to improve income. The dots in the micro charts represent months. Each dot is color coded red, yellow or green based on its performance. The # Donors represents the universe by strategy.
3) Wizard—This is where the magic happens. Each lane has an associated KPI which will help improve the associated strategy. The green section on the slider represents constituents who are predicted to have a positive financial income. Yellow are those on the verge of doing so, and red represents donors who pose a risk of diminishing financial returns. The AI scores the constituents in each of these lanes in green, yellow and red based on the predicted Net Income and automatically identifies the constituents to target in each lane. Users also have the option to adjust the slider for each lane depending on their strategy. If the organization is bleeding in the Reactivation lane, they can choose to max out the associated slider. By changing the slider, the numbers in the section will automatically adjust to reflect the segmentation choice. The Cost listed in each lane is a marketing cost per piece. As the slider is moved to the right, costs will increase and ROI and Net Income will decrease due to the inclusion of constituents with a low statistical probability of response. The far-right section of the Wizard shows the combined results from the slider choices in all the lanes. By clicking on the cost (shown in a light grey font), users are able to quickly change the marketing cost per person for each lane in case the lanes require varying marketing packages with varying costs. Alternatively, users may click on the costs at the far right of this section (Shown in a light grey font) in order to include standard marketing costs for all lanes. Costs are important as they are used in order to calculate the Net Income and ROI per lane as well as for the combined marketing campaign.
4) Summary—This section includes four distinct components:
a. Detail inputs—users enter various details regarding the campaign and are able to save the campaign in the database so that Pulse Analytics® can begin to track its results.
b. Summary—There is also a section that summarizes the results. Mailable is the universe of constituents less exclusions (the number of constituents that may not be targeted due to opting out, not having a correct address on record, being out of the country, etc.) This section also shows the number of selected constituents along with the percentage of those constituents from the overall Mailable file.
c. Pie Chart—The pie chart corresponds with the selection made in the sliders located in the Wizard section. Users may hover over the pie chart in order to see the breakdown by lane.
d. [6] Action buttons—Action buttons shown here include the ability to View a table with the selected constituents, Save the campaign so that reporting can be done on the selections, and Export the segmentation by constituent in order to begin the campaign.
5) Slider bubble—Upon moving the slider, using will be able to the number of selected constituents inside the slider bubble.

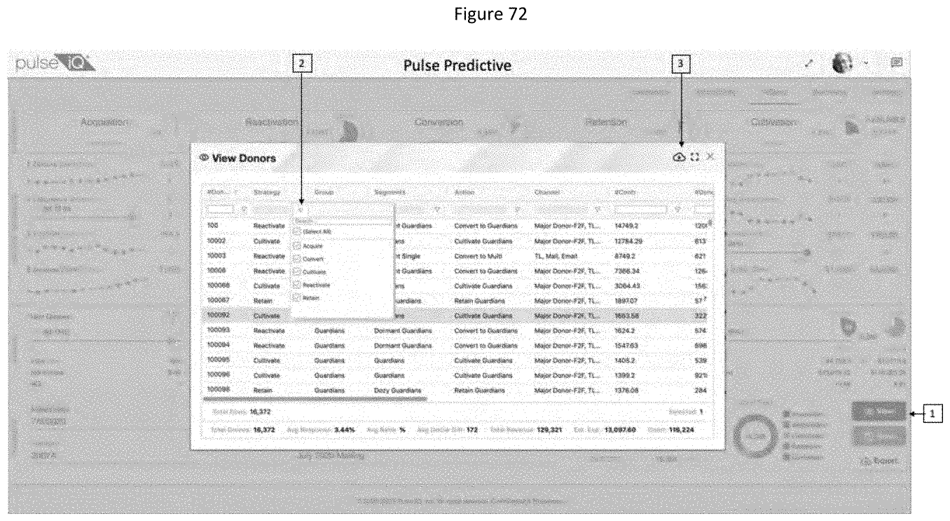

FIG. 72 shows these elements:
1) View—Upon clicking on the view button in the Summary section of Pulse Predictive, users are presented with a table that includes the constituents that have been selected in the Wizard section.
2) Dynamic tables—the tables used here are dynamic as they include many features such filtering, moving columns, etc.
3) Options—This section includes several features such as download, go full screen, or exit.

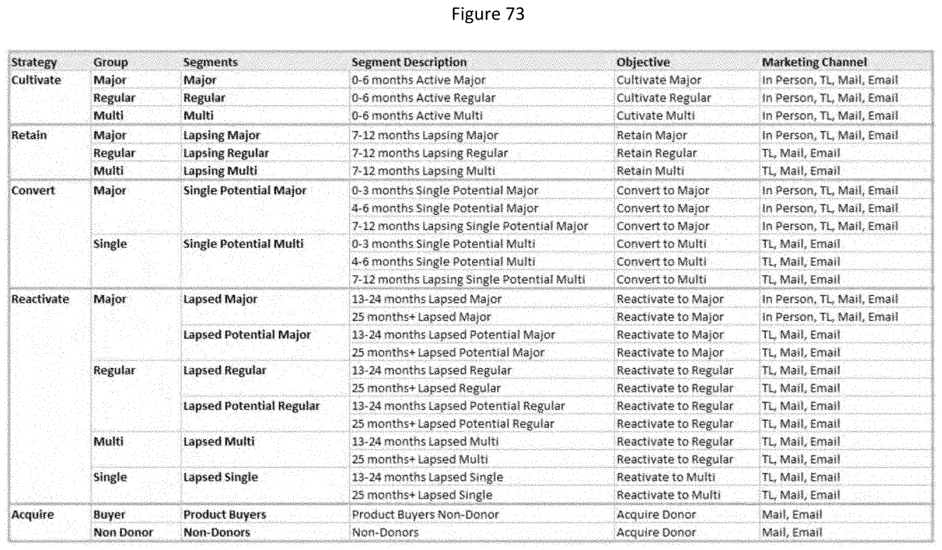

FIG. 73 is relevant here. By segmenting the constituents into meaningful cohorts, individual strategies can be formed and executed in order to produce the highest possible impact by cohort. For instance, constituents who were customers or donors two years ago, should be targeted differently than current constituents as they may be offered various incentives in order to return. The precise targeting of the various cohorts necessitates a segmentation that provides insights into each cohort. Consequently, in order to increase the level of transparency and to improve results, the invention groups constituents into the following layers:

Strategy: These are the Strategy lanes reflected in FIG. 71. By looking at the segmentation through the prism of the Strategy Lanes, users are able to optimize financial results while also furthering strategic objectives.

Groups: Constituents are segmented into the following:
Major: These are constituents who make the largest orders or gifts
Regular: These are constituents who make the most frequent orders or gifts
Multi: These are constituents who made more than a single order or purchase but who have not risen to the level of Regular
Single: These are constituents who made a single order or gift
Buyers: These are constituents who made a purchase but have never donated
Non Donors: These are constituents who have never made a purchase or donation

Segments: Groups are further segmented into another layer to identify whether they are:
Current/Active: These are constituents who contributed via orders or gifts in the prior six months (The period of six months may be adjusted)
Lapsing: These are constituents who are at the risk of becoming lapsed customers or donors.
Potential: These are constituents who are at the most likely to climb the next rung of the Group ladder (e.g. Single to Multi, Multi to Regular, Regular to Guardians)
Lapsed: These are constituents who have lapsed as they have not made any orders or gifts in a specified time period. They went from being Current at one point, to Lapsing, and they are now Lapsed.
Product Buyers: These are constituents who made a purchase but have never donated (this is specific to nonprofit clients as for them there is a difference between a donation and a purchase. When the tool is being used by a For Profit, the product buyers are segmented into the Major, Regular, Lapsing, etc in groups and segments based on their behavior, and this product buyer group/segment is eliminated).
Non-Donors: These are contacts on record who have never made an order or any financial contributions

Actions: This field represents the marketing objective for the constituent cohort in question.

Segment Descriptions: These are the segment descriptions. The time periods may vary depending on the industry.

Marketing Channels: This is how the model recommends that the organization touches those constituents.

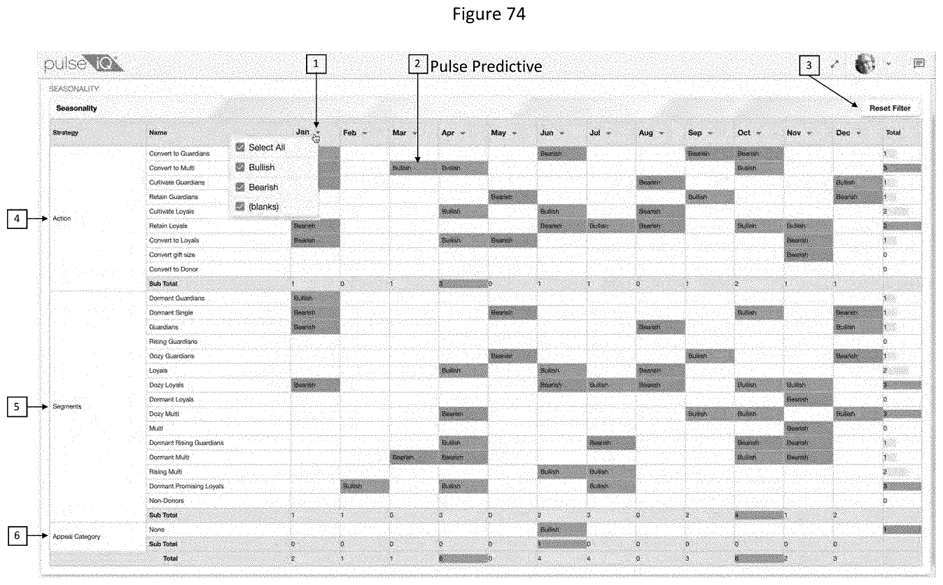

FIG. 74 shows that Pulse Predictive uses Seasonality analysis as one of the many variables in the AI model in order to mitigate risks by limiting Bearish actions and taking full advantage of Bullish actions. FIG. 74 contains these elements:
1) Filter: By clicking on the filter next to each month, uses are able select which items to show on the screen. If they are in the process of creating a segmentation for April, they can only select Bullish, and this will show where the windows of opportunities are so that marketing activities can be tailored accordingly. The AI model already takes the Bears and Bulls into account when scoring the constituents.
2) Bears and Bulls: This shows that converting to Multi is a great strategy to pursue during this month according to the AI model.
3) Reset Filter: Users are able to clear all filters they have set in #1 above.
4) Action: This section in the Seasonality analysis shows the date periods when pursuing various actions will produce the best and worst impact
5) Segments: This section in the Seasonality analysis shows the date periods when pursuing various Segments will produce the best and worst impact
6) Appeal Category: This section in the Seasonality analysis shows the date periods when pursuing various Segments will produce the best and worst impact

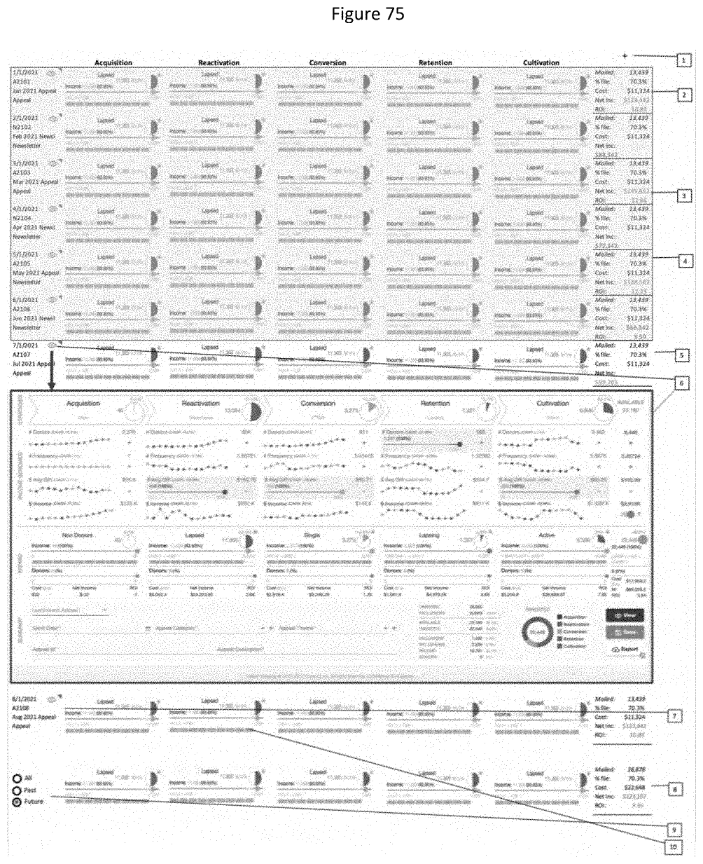

In FIG. 75, The ability to plan future campaigns is invaluable when creating a budget. Predictive provides users with associated costs and Net Income that can be gained from future campaigns. Pulse Predictive enables users to quickly review all the decisions that were made in their historical campaigns as well as to plan future campaigns. It is useful to gauge past campaigns in one view as the knowledge from successes and failures is used to plan future campaigns. The tool allows users to visually see any donor blocks within each strategy that are not being mailed and mail those so that all past donors are being touched at least once throughout the year. Once all future months are added, the AI will provide an estimated summary for Number Mailed, Costs, Net Income, and ROI so that organizations are able to smartly plan their marketing and budgeting activities.

FIG. 75 contains these elements:
1) Ability to add a campaign at the bottom for planning purposes
2) Cost, Net Inc and ROI are filled in here from previous campaigns
3) Conditional formatting (red, yellow or green based on performance) is used for Net Income and ROI
4) This section is greyed out because these are previous campaigns that cannot be changed. However, user can click to see detail.
5) This is a future campaign so it's not greyed out
6) This button opens this detail view below the summary for this appeal
7) User can add future campaigns here for planning purposes.
This is done by clicking on the + sign in #1 above.
8) This is a summary of campaigns.
9) User may view a summary for All campaigns, Past Campaigns, or Future Campaigns.
10) User will be able to quickly scan to ensure that a donor block is being mailed at least once per year.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. An improved method for constructing an improved user interface as shown and described in the Figures comprising key performance indicators and the use of artificial intelligence.
